(19) United States
(12) Patent Application Publication
(10) Pub. No.: US 2022/0032295 A1
(43) Pub. Date: Feb. 3, 2022

(54) DEVICES AND METHODS FOR SAMPLE PREPARATION

(71) Applicant: LUMINOSTICS, INC., Milpitas, CA (US)

(72) Inventors: Alexander Kirkpatrick, San Jose, CA (US); Balakrishnan Raja, San Jose, CA (US); Andrew Paterson, Fremont, CA (US)

(21) Appl. No.: 17/246,562

(22) Filed: Apr. 30, 2021

Related U.S. Application Data
(60) Provisional application No. 63/019,091, filed on May 1, 2020.

(51) Int. Cl. B01L 3/00

(52) U.S. Cl. CPC B01L 3/502715; B01L 2200/16; B01L 2200/0689; B01L 2400/0481; B01L 2300/044; B01L 2200/0684; B01L 2400/0487; B01L 2300/042

(57) ABSTRACT

Methods, apparatuses, and computer program products for preparation of samples for use with in vitro diagnostic tests or analytical assays for detecting one or more analytes. For example, certain embodiments may relate to diagnostic tests performed on human subjects for a variety of applications related to health, medical, and wellness testing. Other embodiments may relate to testing in various applications. Further embodiments may relate to processing environmental samples for detection of various analytes of biological or non-biological origin. Additional embodiments may relate to various applications that require mixing an arbitrary sample with a precise amount of one or more reagents.

### CROSS-REFERENCE TO RELATED APPLICATIONS

This application claims priority from U.S. provisional patent application No. 63/019,091 filed on May 1, 2020. The contents of this earlier filed application are hereby incorporated by reference in their entirety.

### STATEMENT REGARDING FEDERALLY SPONSORED RESEARCH

This invention was made with government support in part by grants 1R43AI118180-01A1, 2R44AI118180-02, and 5R44AI118180-03 awarded by the National Institutes of Health (NIH). The government has certain rights in the invention.

### FIELD

Some example embodiments may generally relate to diagnostic testing, analysis, and monitoring. For example, certain embodiments may relate to diagnostic tests performed on human subjects for a variety of applications related to health, medical, and wellness testing. Other embodiments may relate to testing in various applications. Further embodiments may relate to processing environmental samples for detection of various analytes of biological or non-biological origin. Additional embodiments may relate to various applications that require mixing an arbitrary sample with a precise amount of one or more reagents.

### BACKGROUND

Conventional lab-based in vitro diagnostics (IVDs) are tests that are designed to be carried out in a laboratory that contains the essential equipment and supplies needed for sample preparation, running the test or assay, and analyzing the results. For lab-based tests, the sample may be collected from the patient offsite and sent to the lab for analysis. The slow turnaround time to results for lab-based tests has inspired the development of point-of-care (POC) testing technologies that allow testing near the patient for more immediately actionable results.

The field of IVDs enable sensitive and specific detection of a variety of analytes in POC, low-resource, and at-home settings without reliance on sophisticated instrumentation or medical laboratories. Test formats such as the lateral flow assay (LFA) may be used in POC testing and have been adapted for various use applications.

POC tests that have workflows that may be reasonably straightforward for a trained medical practitioner are often too complex for lay users, and, thus, are not feasible for general consumer at-home self-testing, due to the potential for inaccurate results from user error and variability. Inter-operator variability is an even greater concern for lay users, where it is highly likely that an appreciable percentage of the users may perform the sample preparation step incorrectly. This inter-operator variability is a major concern for developers and manufacturers of medical devices, and for products that are subject to IVD regulations this inter-operator variability and related issues encountered when people use the product must be evaluated and analyzed in well-defined human factors studies.

Thus it may be desirable to provide an IVD device that has high confidence that the human factors studies and verification and validation studies will be successfully completed, that can accommodate multiple reagents in specified amounts, that reduces risk to the user, and is simple to use. Additionally, as the trend of personalized medicine and at-home diagnostics gains traction and interest by the general public and the healthcare and medical industry, there is a need for sample preparation methods and devices that are affordable and can be easily used by a lay person in his or her home, yet still deliver laboratory quality.

### SUMMARY

Certain embodiments may be directed to a sample extraction device for extracting a biological analyte from a biological sampling device, such as a swab. The sample extraction device may include a sample chamber configured to accept the biological sampling device. The sample extraction device may also include a reagent storage vessel, optionally wherein the reagent storage vessel is mounted onto the sample chamber. The sample extraction device may further include a mechanism configured to apply compressive mechanical and/or piercing force on the reagent storage vessel to release a reagent contained in the reagent storage vessel into the sample chamber, such as by bursting or piercing a reagent storage vessel or sub-compartment therein.

In some embodiments, the sample extraction device may further include a lance, or two or three or more different lances. The lance(s) may be mounted inside a lance cavity of the sample extraction device. In some embodiments, each lance is mounted inside a different lance cavity. In some embodiments, two or at least two lances are mounted inside the same lance cavity, and optionally one or more additional lances are mounted inside one or more additional lance cavities.

The sample extraction device may further include a mechanism configured to apply compressive or piercing mechanical force on the reagent storage vessel, the lance or the lance cavity, and thereby push the reagent storage vessel against the lance. Further, the sample extraction device may include a housing component enclosing the sample chamber, the reagent storage vessel, the mechanism, and the lance. The sample extraction device may also include a cap covering at least a portion of an opening of the sample chamber, the cap being configured to provide controlled/metered release of a liquid sample from the sample chamber.

In certain embodiments, the cap may include one or more partition walls configured to partition between an amount of the liquid sample that will be dispensed from the cap, and an amount of the liquid sample that will remain within an annular space inside the cap, as described and illustrated in more detail herein. In other embodiments, the cap may be configured to be adjustable to alter a volume of liquid in the cap depending on a desired liquid sample volume to be dispensed. In some embodiments, the sample chamber may include a frangible seal configured to cover a liquid stored therein.

In other embodiments, the biological sampling device may be a swab, scoop, spoon, spatula, probe, stick, or rod. In some embodiments, the biological sampling device may be a swab. In some embodiments, the sampling device (e.g., swab) may include a breakpoint configured to break when mechanical force is applied to the breakpoint, and the sample chamber may include a notch configured to hold the sampling device (e.g., swab) and aid in breaking the sampling device (e.g., swab) at the breakpoint. According to certain embodiments, the breakpoint may be a point of a stem of the sampling device that is aligned with the notch, e.g., when the sampling device has been sufficiently inserted into the extraction device.

In certain embodiments, the sample extraction device may include a cap, preferably wherein the cap comprises threading configured to connect the sample extraction device to a sample port of an analysis device, which comprises complementary threading to the threading of the cap. In some embodiments, the sample extraction device may include a cap (such as a threaded cap), wherein the cap may include a frangible film covering an opening of the cap. In certain embodiments, the frangible film may be configured to hold the liquid sample inside the cap, and wherein the frangible film is configured to release the amount of liquid sample that is to be dispensed from the cap when punctured while preventing the amount of liquid sample that is to remain inside the cap from being dispensed. In some embodiments, the threading of a threaded cap may be located on an external surface of the cap. In some embodiments, the analysis device may be a lateral flow assay cartridge. In some embodiments, the lateral flow assay cartridge may be configured to be inserted into a cartridge port of an adaptor connected to a processing device. According to some embodiments, the sample port may include a puncture mechanism configured to puncture the frangible film of the cap, and the sample port may include a channel configured to receive the reagent dispensed from the sample extraction device.

In certain embodiments, the puncture mechanism may include one or a plurality of prongs. In some embodiments, the plurality of prongs may be a series of serrated prongs, preferably wherein the series of serrated prongs may include a gap separating one end of the series of serrated prongs from another end of the series of serrated prongs. In some embodiments, the analysis device (e.g., lateral flow assay cartridge) may include a feedback indicator configured to provide an indication that the cap of the sample extraction device is fully attached to the analysis device (e.g., lateral flow assay cartridge).

According to certain embodiments, the indication may include an audible sound (e.g., an audible click) and/or tactile feedback (e.g., a tactile click or stop observable by a user). According to some embodiments, the sample extraction device may include a cap, and wherein the cap includes a film covering an opening of the cap. According to some embodiments, the sample extraction device may include a cap, and the cap may include a spigot, which defines an opening of the cap, and a vent tube disposed within the opening. According to some embodiments, the sample extraction device may include a cap, and the cap may include a tab extending from an exterior surface of the cap, a flexible neck attached to the exterior surface of the cap, and an anchor knob fixed to an end of the flexible neck.

In certain embodiments, the sample extraction device may include a cap, wherein the cap is a flexible dropper cap. In some embodiments, the sample extraction device may include a cap, and the cap may include a plurality of slots configured to accommodate one or more O-rings. In further embodiments, the sample extraction device may include a cap, and the cap may include a pressure-release snorkel. In some embodiments, the pressure-release snorkel may define an outlet hole configured to release air pressure within the sample chamber. In other embodiments, the pressure-release mechanism may include a snorkel that is configured to release excess air pressure built up in the sample chamber enclosed with the cap to equalize an internal pressure of the sample chamber with an external ambient air pressure.

In some embodiments, the sample extraction device may include a cap, wherein the cap comprises a metering structure configured to ensure a controlled or metered volume (e.g., 0.25 to 0.5 mL) of reagent is delivered to an analysis device. In some embodiments, the metering cap is configured to divert excess volume of reagent from delivery to an analysis device. In some embodiments, a metering structure is incorporated into an analysis device. For example, a metering structure as described herein can be adapted and configured to a sample port of an analysis device described herein such as a lateral flow assay cartridge. The metering sample port can be configured to ensure a controlled or metered volume (e.g., 0.25 to 0.5 mL) of reagent is delivered to an assay, such as a lateral flow assay.

In some embodiments, the mechanism may include a button or a dial. In certain embodiments, the mechanism may include a button. In further embodiments, the mechanism may include a dial. In some embodiments, the button may include a hinge region allowing the button to rotate, and a latch configured to attach the button to the sample chamber.

According to certain embodiments, the sample extraction device may include one or more lance(s) and lance cavit(y/ies) as defined above. According to some embodiments, a reagent storage vessel may be mounted over one or more lance cavity creating a sealed enclosure, and a lance may be in communication with a frangible surface of a reagent storage vessel. According to further embodiments, a reagent storage vessel may include a sealing agent that mounts the reagent storage vessel onto the exterior of the sample chamber. According to certain embodiments, the sealing agent may include an adhesive film or an adhesive tape. According to further embodiments, the sealing agent may include an adhesive film. According to other embodiments, the sealing agent may include an adhesive tape.

In some embodiments, the sample extraction device may include one or more lance(s) and lance cavit(y/ies) as defined above, and a lance cavity may be fluidly connected to the sample chamber. In certain embodiments, the sample extraction device may include a lance cavity as defined above, and further include a sample channel fluidly connected to the lance cavity and the sample chamber. In some embodiments, the sample chamber may include a pressure release mechanism configured to release excess internal air pressure in the sample chamber. In some embodiments, the pressure release mechanism may include a hydrophobic porous membrane or an oleophobic porous membrane. In some embodiments, the pressure release mechanism may include a hydrophobic porous membrane.

According to certain embodiments, the pressure release mechanism may include an oleophobic porous membrane. According to other embodiments, the hydrophobic porous membrane may include a polytetrafluoroethylene membrane. According to further embodiments, the oleophobic porous membrane may include an acrylic copolymer membrane. In some embodiments, the sample chamber may include a chamber volume of 0.5 mL to 5 mL. In some embodiments, the sample chamber may include a diameter such that an annular distance between a tip of the biological sampling device and a sample chamber wall is at most 10 mm.

In some embodiments, the reagent storage vessel may include one reagent storage compartment or sub-compartment (e.g., blister) with the reagent stored therein. According to certain embodiments, the reagent storage vessel may include a plurality of reagent storage sub-compartments (e.g., blisters) with the same or different reagent(s) stored in each of the plurality of sub-compartments (e.g., blisters), or a plurality of sub-compartments (e.g., blisters) wherein the plurality of sub-compartments (e.g., blisters) stores at least two different reagents, or at least three different reagents, or at least four different reagents. According to some embodiments, the reagent storage vessel may include at least three reagent storage sub-compartments (e.g., blisters), wherein three of the at least three sub-compartments each comprise a different reagent.

In certain embodiments, subsequent to at least partially turning a first dial or pressing a first button, the device may be configured to release a first buffer reagent from a first blister or reagent storage sub-compartment, preferably wherein the first buffer reagent may be a lysis buffer. In some embodiments, the lysis buffer comprises a pH of greater than about 10 and/or a surfactant. In some embodiments, the surfactant is a denaturing, non-denaturing, ionic, non-ionic, or zwitterionic surfactant. In some embodiments, the lysis buffer comprises a combination of surfactants, wherein each surfactant is independently selected from a denaturing, non-denaturing, ionic, non-ionic, and zwitterionic surfactant.

In some embodiments, the device may be configured to release a second buffer reagent from a second blister or second reagent storage sub-compartment and optionally a third buffer reagent from a third blister or third reagent storage sub-compartment after the release of the first buffer reagent. In certain embodiments, the device may be configured to release the second and/or third buffer reagent after at least a further turn of the first dial or additional pressing of the first button, or wherein the device is configured to release the second and/or third buffer reagent after at least partially turning a second dial or pressing a second button. In some embodiments, the device comprises first second and third blisters or reagent storage sub-compartments, comprising respectively a first second and third buffer reagent, wherein the first buffer reagent is a lysis buffer and the second and third buffer reagents combine to form a neutralization buffer, e.g., sufficient to bring the pH of a mixture of lysis and second and third buffers in the sample chamber to a pH of from about 4 to about 8.5, preferably from about 5 to about 8.5, more preferably from about 6 to about 8.5, yet more preferably from about 6.5 to about 8, yet even more preferably from about 7 to about 8. According to certain embodiments, the reagent storage vessel may include a foil material or a polymer-based material.

According to some embodiments, the sample extraction device may have a width of 2 to 5 inches.

Certain embodiments may be directed to a method for extracting a biological analyte, such as with a sample extraction device as described herein. The method may include collecting a sample on a biological sampling device. The method may also include inserting the biological sampling device into a sample chamber of the sample extraction device. The method may further include sealing an opening of the sample chamber with a cap. In some cases, the sample chamber with the cap is sealed before inserting the biological sampling device. In some embodiments, the method may include puncturing or bursting a reagent storage vessel, wherein the reagent storage vessel is optionally mounted onto an exterior of the sample chamber, to release a reagent into the sample chamber. The method may include dispensing the reagent and extracting a sample from the biological sampling device. The method may include dispensing the reagent, or a portion thereof, into an analysis device, wherein the reagent includes a sample extracted from the biological sampling device. In some cases, the dispensing comprises dispensing into an analysis device. In certain embodiments, the analysis device may be an assay or an analyte detection device, such as a lateral flow assay cartridge.

According to certain embodiments, the method may also include pre-loading the sample chamber with a reagent. The method may also include breaking off a tip of a swab or other sampling device at a breakpoint on the biological sampling device. In certain embodiments, puncturing the reagent storage vessel may include pressing a button or turning a dial to apply compressive mechanical force on the reagent storage vessel, e.g., against a lance. In some embodiments, the dispensing may include attaching the sample extraction device to the analysis device, and puncturing a film material on the cap to release the reagent and the sample collected in the reagent, optionally wherein the puncturing releases the reagent into the analysis device.

In certain embodiments, the method may further include controlling a volume of the dispensed reagent and sample collected in the reagent with a coefficient of variation of 5 to 10%, e.g., with a metering cap or other metering structure. In some cases, the metering structure is within a metering cap of the extraction device. In some cases, the metering structure is within a sample port of an analysis device.

In some embodiments the volume of the dispensed reagent may be controlled by squeezing the cap to release the reagent and the sample collected in the reagent. In some embodiments, the method may also include receiving feedback indicating that all or a portion of, or a sufficient portion of, the reagent has been released, e.g., from one or more reagent storage sub-compartments (e.g., blisters), or from the extraction device to an analysis device. In some embodiments, the feedback may include an audible click. According to certain embodiments, the method may further include releasing internal air pressure in the sample chamber via an air pressure release mechanism. According to further embodiments, the cap may be attached by snapping a tab on the cap, and anchoring the cap with an anchor knob attached to the cap.

Certain embodiments may be directed to a sample analysis kit for analyzing an extracted biological analyte. The sample analysis kit may include a sample extraction device as described herein. The sample analysis kit may also include a biological sampling device, such as a swab. In addition, the biological sampling device may be adapted and configured to provide a biological analyte into the sample extraction device. According to certain embodiments, the sample analysis kit may also include an adapter configured to connect a lateral flow cartridge to a biological extraction device as described herein. According to certain embodiments, the sample analysis kit may also include an adapter configured to connect a lateral flow cartridge to a processing device.

In certain embodiments, the processing device may be an imaging device or a smartphone. In some embodiments, the processing device may be an imaging device. In further embodiments, the processing device may be a smartphone.

Certain embodiments may be directed to a method for analyzing a biological analyte from a biological sampling device described herein. The method may include extracting a biological analyte by a method described above. The method may also include dispensing the biological analyte to an analysis device, connecting the analysis device to a processing device before or after the dispensing. and with the processing device, performing signal acquisition and readout of the biological analyte. In some embodiments, the signal acquisition includes time-gated imaging.

Certain embodiments may be directed to a biological sampling device configured to provide a biological sample to a biological extraction device as described above. The biological sampling device may include a main stem, a breakpoint attached to the main stem, a sampling stem attached to the breakpoint, and a tip attached to the sampling stem. According to certain embodiments, the breakpoint of the sampling device (e.g., swab) may be narrower than the main stem, and is configured to break when mechanical force, notch, or cutting tool is applied to the breakpoint.

According to some embodiments, the biological sampling device is a swab, scoop, spoon, spatula, probe, stick, or rod. According to certain embodiments, the tip of the biological sampling device may correspond to a flocked swab, polyurethane swab, Rayon swab, foam swab, cotton swab, cellulose fiber swab, blended material swab, polymer-based swab, polyester swab, nylon swab, or alginate polymer swab.

According to some embodiments, the biological sampling device may include a flocked fiber microstructure, wound microstructure, knitted microstructure, reticulated microstructure, or sprayed microstructure. In certain embodiments, the biological sampling device may include a round shape, narrow shape, oval shape, arrow shape, pointed shape, beveled shape, tapered shape, or cylindrical shape. According to certain embodiments, a diameter of the tip may be equal to a diameter of the sample chamber. According to other embodiments, the diameter of the tip is larger than the diameter of the sample chamber. According to other embodiments, the diameter of the tip is smaller than the diameter of the sample chamber. In some embodiments, the diameter of the tip is, or is at least, 0.5 mm smaller than the sample chamber. In some embodiments, the diameter of the tip is from about 1.5 mm to about 0.25 mm, preferably 1 mm to about 0.5 mm smaller than the sample chamber.

Certain embodiments may be directed to an analysis device configured to link with a sample extraction device as described above. The analysis device may include a sample port configured to receive the sample extraction device, and a result window. According to certain embodiments, the analysis device may be a lateral flow assay cartridge. According to other embodiments, the lateral flow assay cartridge may be configured to be inserted into a cartridge port of an adaptor connected to a processing device. In some embodiments, the sample port may include a puncture mechanism configured to puncture the frangible film of the cap. In some embodiments, the sample port may include a channel configured to receive the reagent dispensed from the sample extraction device. In certain embodiments, the puncture mechanism may include one or a plurality of prongs.

According to certain embodiments, the plurality of prongs may be a series of serrated prongs, preferably the series of serrated prongs may include a gap separating one end of the series of serrated prongs from another end of the series of serrated prongs. According to some embodiments, the analysis device may include a plurality of internal (e.g., upper and/or lower) rib structures for suspending a lateral flow membrane and/or applying pressure on the lateral flow membrane. In certain embodiments, the sample port may include threading configured to attach the analysis device to the sample extraction device.

Certain embodiments may be directed to an interface element configured to attach a sample extraction device described above to a lateral flow cartridge or an analysis device described above. The interface element may include threading configured to mate with complementary threading of a cap of the sample extraction device, and optionally a mechanism configured to puncture the cap to release a liquid stored within the sample extraction device into the analysis device. According to certain embodiments, the interface element may be or comprise a sample well or sample port.

According to some embodiments, the interface element may further include a feedback indicator configured to provide an indication of successful attachment of a sample extraction device. In certain embodiments, the indication may be an audible, and/or a tactile, indication. In some embodiments, the sample port may include a channel configured to transfer the liquid dispensed from the sample extraction device into the analysis device or lateral flow cartridge. According to certain embodiments, the mechanism may include one or a plurality of prongs. In other embodiments, the plurality of prongs may be a series of serrated prongs, and optionally the series of serrated prongs may include a gap separating one end of the series of serrated prongs from another end of the series of serrated prongs. According to other embodiments, the interface element may be configured to slideably attach onto a lateral flow cartridge.

### BRIEF DESCRIPTION OF THE DRAWINGS

For proper understanding of example embodiments, reference should be made to the accompanying drawings, wherein:

FIG. 1 illustrates an exploded view of a prep pod device, according to certain embodiments.

FIG. 2 illustrates an example of using the prep pod device, according to certain embodiments.

FIG. 3 illustrates an exploded view of an alternate embodiment of the prep pod device in FIGS. 1 and 2, according to certain embodiments.

FIG. 4(A) illustrates attachment of the pre pod device of FIG. 3 into an assay device, according to certain embodiments.

FIG. 4(B) illustrates the prep pod device of FIG. 3 attached to the assay device, according to certain embodiments.

FIG. 5 illustrates the prep pod device inserted into a lateral flow assay cartridge, which is inserted into a cartridge port of an adapter connected to a smartphone, according to certain embodiments.

FIG. 6(A) illustrates a side view of a swab chamber module, according to certain embodiments.

FIG. 6(B) illustrates a cross-sectional view of the swab chamber module along line A-A of FIG. 6(A), according to certain embodiments.

FIG. 6(C) illustrates another side view of the swab chamber module, according to certain embodiments.

FIG. 6(D) illustrates a cross-sectional view of the swab chamber module along line B-B of FIG. 6(C), according to certain embodiments.

FIG. 7(A) illustrates an isometric view of the swab chamber module, according to certain embodiments.

FIG. 7(B) illustrates a cross-sectional view of the swab chamber module of FIG. 7(A), according to certain embodiments.

FIG. 8(A) illustrates an isometric view of a swab and the swab chamber module, according to certain embodiments.

FIG. 8(B) illustrates the swab chamber module after the swab has been fully inserted, according to certain embodiments.

FIG. 8(C) illustrates a main stem of the swab broken off and detached, according to certain embodiments.

FIG. 9 illustrates an isometric view of a blister packet of FIG. 1, according to certain embodiments.

FIG. 10(A) illustrates a front view of a single blister, according to certain embodiments.

FIG. 10(B) illustrates an isometric view of the single blister, according to certain embodiments.

FIG. 10(C) illustrates a side view of the single blister, according to certain embodiments.

FIG. 10(D) illustrates a cross-sectional view of the single blister and a zoomed in portion of the cross-section, according to certain embodiments.

FIG. 11(A) illustrates an isometric view of a lance of the prep pod device, according to certain embodiments.

FIG. 11(B) illustrates a front view of the lance of the prep pod device, according to certain embodiments.

FIG. 11(C) illustrates a side view of the lance of the prep pod device, according to certain embodiments.

FIG. 12 illustrates an isometric angle with a cross-sectional view of an assembly of the swab chamber module with a blister packet and a button, according to certain embodiments.

FIG. 13(A) illustrates an isometric view of a partial assembly of the prep pod device, revealing the opening of the swab chamber module into which a the swab is inserted, according to certain embodiments.

FIG. 13(B) illustrates a side view of a partial assembly of the prep pod device, according to certain embodiments.

FIG. 13(C) illustrates a cross-sectional view of a partial assembly of the prep pod device of FIG. 13(B), according to certain embodiments.

FIG. 14(A) illustrates a cross-sectional view of the swab chamber module before the button is pressed to release reagent from the blister into the swab chamber module, according to certain embodiments.

FIG. 14(B) illustrates a cross-sectional view of the swab chamber module after the button is pressed to release reagent from the blister into the swab chamber module, according to certain embodiments.

FIG. 15 illustrates an isometric view with a partial cutaway of the prep pod device, according to certain embodiments.

FIG. 16(A) illustrates the prep pod device before a dial has been fully turned, according to certain embodiments.

FIG. 16(B) illustrates the prep pod device after the dial has been fully turned, according to certain embodiments.

FIG. 16(C) illustrates another view of the prep pod device of FIG. 16(A) before the dial has been fully turned, according to certain embodiments.

FIG. 16(D) illustrates another view of the prep pod device of FIG. 16(B) after the dial has been fully turned, according to certain embodiments.

FIG. 17(A) illustrates a side view of a cutaway of the dial and prep pod housing, according to certain embodiments.

FIG. 17(B) illustrates an isometric view of the cutaway of the dial and prep pod housing, according to certain embodiments.

FIG. 18(A) illustrates an isometric view of a cap of the prep pod device, according to certain embodiments.

FIG. 18(B) illustrates a side view of the cap of the prep pod device, according to certain embodiments.

FIG. 18(C) illustrates a cross-sectional view of the cap of the prep pod device along line A-A of FIG. 18(B), according to certain embodiments.

FIG. 19 illustrates a cap design for the prep pod device, according to certain embodiments.

FIG. 20(A) illustrates an isometric view of the prep pod device, according to certain embodiments.

FIG. 20(B) illustrates a top view of the prep pod device of FIG. 20(A), according to certain embodiments.

FIG. 20(C) illustrates a side view of the prep pod device of FIG. 20(A), according to certain embodiments.

FIG. 20(D) illustrates another side view of the prep pod device of FIG. 20(A), according to certain embodiments.

FIG. 21(A) illustrates an isometric view of a lateral flow assay cartridge, according to certain embodiments.

FIG. 21(B) illustrates a front view of the lateral flow assay cartridge, according to certain embodiments.

FIG. 21(C) illustrates a cross-sectional view of the lateral flow assay cartridge along line A-A of FIG. 21(B), according to certain embodiments.

FIG. 22(A) illustrates a side of the prep pod mated with the lateral flow assay cartridge, according to certain embodiments.

FIG. 22(B) illustrates a front view of the prep pod mated with the lateral flow assay cartridge, according to certain embodiments.

FIG. 22(C) illustrates a cross-sectional view of the prep pod mated with the lateral flow assay cartridge along line A-A of FIG. 22(B), according to certain embodiments.

FIG. 23(A) illustrates an isometric view of a metering cap, according to certain example embodiments.

FIG. 23(B) illustrates a cutout of the metering cap of FIG. 23(A), according to certain embodiments.

FIG. 23(C) illustrates a side view of the metering cap of FIG. 23(A), according to certain embodiments.

FIG. 23(D) illustrates a cross-sectional view of the metering cap along line A-A of FIG. 23(C), according to certain embodiments.

FIG. 24(A) illustrates another cutout of the metering cap, according to certain embodiments.

FIG. 24(B) illustrates an inverted metering cap from a cross-section side view, according to certain embodiments.

FIG. 24(C) illustrates the metering cap with an O-ring inserted, and the swab chamber module screwed into the metering cap, according to certain embodiments.

FIG. 25(A) illustrates an isometric view of the swab chamber module, according to certain embodiments.

FIG. 25(B) illustrates a front view of the swab chamber module, according to certain embodiments.

FIG. 25(C) illustrates a side view of the swab chamber module, according to certain embodiments.

FIG. 25(D) illustrates a cross-sectional view of the swab chamber module along line A-A of FIG. 25(C).

FIG. 26(A) illustrates the metering cap with a pressure relief snorkel or tube, according to certain embodiments.

FIG. 26(B) illustrates a side view of the metering cap with the pressure relief snorkel or tube, according to certain embodiments.

FIG. 26(C) illustrates a cross-sectional view of the metering cap with the pressure relief snorkel or tube, according to certain embodiments.

FIG. 27(A) illustrates a side view with a cutaway of the swab chamber module, according to certain embodiments.

FIG. 27(B) illustrates an isometric view with a cutaway of the swab chamber module, according to certain embodiments.

FIG. 28(A) illustrates an isometric view of a lateral flow test cartridge, according to certain embodiments.

FIG. 28(B) illustrates a zoomed in partial op view of a modified serrated sample release prong, according to certain embodiments.

FIG. 29 illustrates a box-plot of analyte detection results using a sample prep pod device described herein compared to analyte detection using a standard pipette-based extraction method. The y-axis represents the signal produced at the test line from a lateral flow cartridge configured to accept a sample from the prep pod device, according to some embodiments, and containing a lateral flow membrane for detection of a biological analyte extracted from a swab by the sample prep pod device.

### DETAILED DESCRIPTION

Introduction:

POC tests may range in complexity and ease of use with some tests requiring access to certain kinds of equipment found in a conventional medical lab, while other POC tests are capable of being administered by a healthcare professional in low-resource or field-use settings. A subset of POC tests are sufficiently simple such that they can be carried out by a layperson for convenient-at-home self-testing. The field of IVDs has seen a wide number of innovations in assay formats and detection methods that enable sensitive and specific detection of a variety of analytes in POC, low-resource, and at-home settings without reliance on sophisticated instrumentation or medical laboratories.

The purpose of the sample preparation step may vary depending on the nature of the test, but generally may be used to convert the sample into a form that is more compatible with the format or chemistry of the assay or to make the analyte more available for detection. Sample preparation may involve chemical or physical breakdown, removal, separation, or processing of the sample material into components that are more easily detected by the assay, and may introduce chemical species that enhance sensitivity or specificity, reduce interference, reduce the coefficient of variation, enhance quantitation, or generally improve the assay accuracy, precision, or performance. In some applications it may be essential to dilute the original sample into a buffer or reagent solution, at a controlled volume and dilution factor, to improve assay consistency and performance by decreasing the concentration of interfering components in the sample. In some applications, sample preparation steps require access to equipment used in medical laboratories, such as pipettes to measure out quantities of various chemical reagents, vortexers, vortex mixers, agitators, or shakers to mix the sample and reagents, sonication equipment or sonicators to aid in extraction of the analyte or for lysis, centrifuges or other tools for separation of plasma or cells from biological fluids such as blood, and a variety of other tools for mixing, reagent dispensing, separation, heating or other chemical, mechanical, or physical processes.

For tests that use swab samples, the sample preparation step may be used to extract material off the swab into a liquid phase that can then be further processed or directly run in an assay. Sample preparation with swab samples may be done by immersing the tip of the swab into one or more liquid reagents and mixing to facilitate extraction of the analyte from the swab. Alternatively, the swab tip may be placed into a container without liquid, such as an empty test tube or centrifuge tube, and then one or more liquid reagents may be directly added to the tube via a pipette, dropper, or other volume-dispensing mechanisms. A variety of swab samples may include sample preparation including oral, buccal, nasal, mid-turbinate, perianal, pharyngeal, nasopharyngeal, lesional, genital, vaginal, urethral, meatal, penile, penile-meatal, throat, conjunctival, ocular, dermal, fecal, cutaneous, mucocutaneous, endocervical, anal, rectal, ear, or swabs of other biological or nonbiological surfaces. In addition to extracting material off the swab into a liquid, and similar to sample preparation of non-swab-based samples, sample preparation for swab samples may involve a variety of mechanisms to improve assay performance such as chemical or physical breakdown of material on the swab, dilution of the swab extract, filtration or physical separation of material from the extract, adjustment of pH or ionic strength, introduction of chemical species that enhance assay performance, mixing to homogenize the liquid extract, heating, lysis, and other chemical or physical processes.

With regard to the design of sample preparation devices and methods, an often-overlooked area of importance is hedonomics, which examines the pleasure or satisfaction the user experiences while engaging with the device. Thus, even if the basic ergonomic considerations are properly accounted for, and a functional sample preparation process and accompanying assay can be run properly by an untrained lay user, there remains the possibility that the device and sample preparation process or other steps needed to run the test are so complex that many users would be unsatisfied with the experience and would not want to use the device in the future.

As the trend of personalized medicine and at-home diagnostics gains traction and interest by the general public and the healthcare and medical industry, there is a need for sample preparation methods and devices that are affordable and can be easily used by a lay person in his or her home, yet still deliver laboratory quality performance. Faced with the challenge of sample preparation in low-resource or OTC settings, the available options are either cheap, but inaccurate, highly variable, and potentially hazardous to lay users, or precise and safe but complex and prohibitively expensive. The methods and devices of certain embodiments described herein address the unmet need of sample preparation tools that greatly simplify the workflow of sample preparation, such that both a lay user and trained professional using the same devices and methods would be able to achieve comparable performance and consistency of sample preparation of a variety of sample types for analysis in assays or analytical procedures. The methods and devices of certain embodiments described herein may be particularly advantageous for swab samples, but may also be applied with great success in processing or preparation of non-swab-based samples such as saliva, blood, urine, feces, sputum, and others. Further, the methods and devices of certain embodiments described herein may have broad applications outside of human medical testing and diagnostics, such as veterinary testing, environmental monitoring, contamination detection, or preparing any arbitrary sample type for analysis by an analytical technique. In addition, the methods and devices of certain embodiments described herein may also create new opportunities in mail-order or mail-in diagnostics, wherein a user collects and processes a sample at home, and an enclosed device containing the sample is sent or transported to a laboratory for analysis.

It will be readily understood that the components of certain example embodiments, as generally described and illustrated in the figures herein, may be arranged and designed in a wide variety of different configurations. The following is a detailed description of some example embodiments of methods and apparatuses for sample preparation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily all refer to the same group of embodiments, and the described features, structures, or characteristics may be combined in any suitable manner in one or more example embodiments. In addition, as discussed herein, a sample preparation device may be referred to as the sample prep device, the preparation pod, the prep pod, the sample preparation pod, the sample prep pod, or simply the device.

Where a numerical value is specified herein as qualified by the term “about”, it is understood that the disclosed value is intended to include without limitation both the specific value specified and a range of values of ±10%.

One having ordinary skill in the art will readily understand that the invention as discussed above may be practiced with steps in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments.

Further, it is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” may encompass both elements or components comprising one unit and elements or components that comprise more than one unit unless specifically stated otherwise. Moreover, parameters disclosed herein (e.g., volume, temperature, time, concentrations, length, etc.) may be approximate.

Devices and Methods:

As described herein, certain embodiments enable simple extraction of analytes from swab samples using one or more reagents stored in the device, although the devices and methods described herein may be used for sample preparation of non-swab-based samples. The device may include a swab chamber or sample chamber, into which a swab or other sampling device is inserted for extraction and processing of material from the sample for analyte detection in an assay. A skilled artisan will appreciate that, wherein “swab chamber” is used herein to refer to a chamber where a swab can be inserted for extraction in a sample extraction device as described herein, a sample chamber configured to accept a different sampling device such as a spoon, scoop, spoon, spatula, probe, stick, or rod, can be substituted. The device may also include at least one, preferably two, more preferably three reagent storage chamber(s) that release(s) reagent(s) into a swab chamber or sample chamber when engaged by the user. In certain embodiments, the device may also contain a mechanism to enable dispensing of an extracted liquid sample onto a secondary device such as an assay or analyte detection device. In some embodiments, the sample preparation device may have features that enable it to mate with a lateral flow test cartridge or cassette. In other embodiments, the device may be used for on-site sample preparation and analysis. In other embodiments the device may be used for preparation of a sample such that the analytes of interest are stabilized, and the entire sample preparation device, part of the sample preparation device, or a secondary device that interacts with the sample preparation device may be shipped or transported to a laboratory or remote location for testing and analysis.

All publications including patents and patent publications, journal articles, manuscripts, theses, GenBank accession numbers, manuals, on-line resources, and other references cited herein are hereby incorporated by reference in the entirety and for all purposes to the same extent as if each reference was individually incorporated by reference. Where a conflict exists between the instant application and a reference provided herein, the instant application shall dominate.

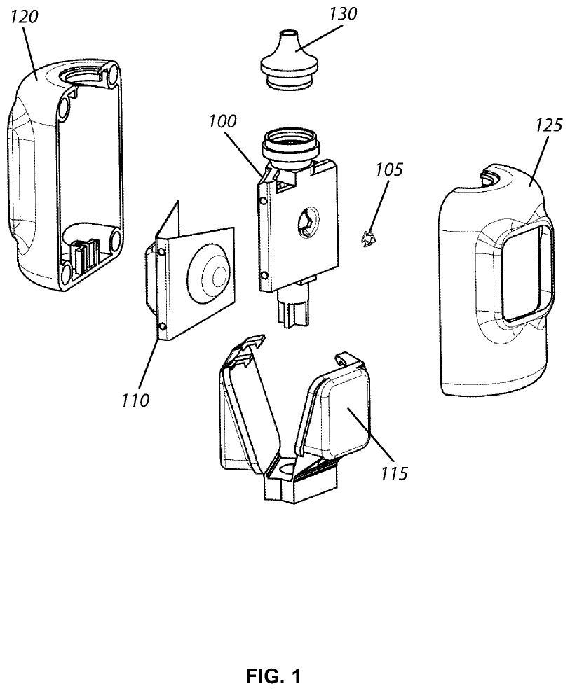

FIG. 1 illustrates an exploded view of a prep pod device, according to certain embodiments. The prep pod device in FIG. 1 includes a main swab chamber module or swab chamber 100, which may include two exterior flat faces for mounting reagent blisters (i.e. “mounting faces”). The swab chamber module 100 may also include an internal cavity or swab chamber into which a wide variety of swab types may be inserted for extraction of biological material using liquids dispensed into the chamber. The prep pod device may also include a lance 105, which may be used for puncturing blisters 110 to release reagent into the swab chamber 100. Although only one lance is shown in FIG. 1, according to other embodiments, each blister 110 may have its own lance for puncturing. Thus, if the prep pod device is configured to have three reagent blisters, it may also have three lances.

According to certain embodiments, each lance 105 may sit in a pocket or “lance cavity” located on an exterior of the swab chamber module 100. According to certain embodiments, a packet of reagent blisters 100 may be folded such that the packet can be mounted onto the exterior of the swab chamber module 100. For instance, in certain embodiments, the blisters 110 may be mounted by using an adhesive film or tape, or a liquid or gel adhesive that cures to form a strong bond. In certain embodiments, the adhesive may be chemically resistant to the reagents in the blisters 110, and may form a tight leak-resistant seal such that when the blisters 110 are punctured by the lances 2, the liquid flows from the lance cavity into the swab chamber 100 rather than leaking out of the sides of the interface region where the blisters 110 are mounted onto the flat exterior faces of the swab chamber module.

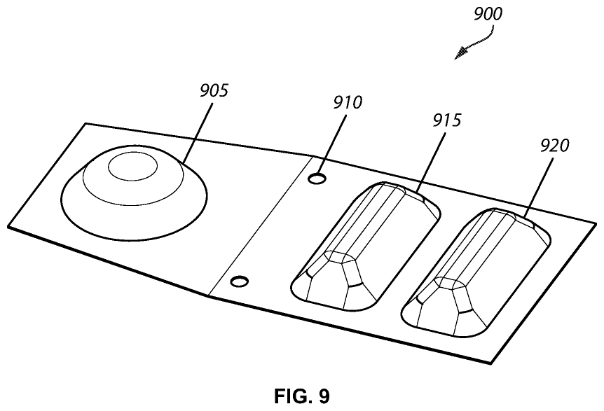

Although the isometric view of the blister packet 110 in FIG. 1 only shows two blisters, according to other embodiments, the blister packet 110 may have a total of three blisters. For instance, in certain embodiments, two blisters may be located on the left side of the packet, and one on the right side (see FIG. 9). FIG. 1 further illustrates buttons 115, which when pressed by a user rotate about a live hinge region that flexes near the bottom of the button module 115, applying a compressive mechanical force on the blisters 100 which may then punctured by the lances 2 allowing liquid reagent to flow out of the blisters 110 into the swab chamber 100. The blisters are designed to withstand a minimum force of at least 10 pound-force (lbf) when squeezed until the point of rupture, in the absence of a puncturing lancet, as measured with a force measurement device comprising a Loadstar Sensors iLoad Mini and a mechanical press.

According to certain embodiments, the blisters can withstand compressive forces between 10 to 20 lbf before rupturing in the force measurement device. Generally, when a blister is squeezed until the point of rupture, the tear occurs in the seal area or the interface between the lidding side and cavity side of the blister. In certain embodiments, the quality of the seal and material used to make the blister can affect the force at which the blister ruptures, and in some embodiments the blister may not rupture until experiencing forces in excess of 30 lbf, 40 lbf, or 50 lbf. While a blister should generally be able to withstand 10 lbf of compressive force without undesirable rupturing, the prep pod may be designed such that a mechanical force smaller than the minimum rupture force would be sufficient to cause the lance to puncture the lidding side of the blister for release of the reagents. The exact force at which intentional puncturing via the lance occurs depends on several parameters including the distance between the tips of the lance and the lidding side of the blister, the exact composition of the blister material and particularly the thickness of the laminate or film used to make the blister, the geometry and material of construction of the lance, and other factors related to the design of the device. The average force at which the lance punctures the blister can be fine-tuned in approximately 1 lbf increments from 1 lbf up to the minimum rupture force. From a usability perspective, it is may be more desirable for the lance to puncture the blister after application of a small amount of force in the 2-8 lbf range. However, from a quality perspective, it may be better to set the threshold for lance puncturing higher such that unintentional puncturing and release of the blister reagents does not occur.

In some embodiments where two blisters are punctured simultaneously by using a button mechanism as illustrated in FIG. 1, the user may need to squeeze with both thumbs to generate a force up to 20 lbf to cause the lance to puncture the blisters. In other embodiments, a force of 10-15 lbf may be needed to cause the lance to puncture the blister. According to certain embodiments, when the buttons 115 are fully engaged or pressed, the latches or hooks on the top of the button module 115 may snap in place onto ridge features on the swab chamber module 100, and the liquid is squeezed out of the punctured blisters 110 into the swab chamber 100 through a small hole that connects the lance cavity to the swab chamber.

In certain embodiments, the lance 2 may not be necessary. For example, the blisters 110 may have a frangible seal that allows them to release reagent without the use of a lance. According to certain embodiments, the prep pod module may also include housing components 5, 6 that enclose the assembly of the swab chamber module 100, the lances 2, the blister packet 110, and the button module 115. The prep pod module may further include a cap 130, which may be used for dispensing liquid out of the swab chamber 100 into an arbitrary assay device. For instance, in certain embodiments, the liquid may be dispensed by inverting the entire prep pod device. According to certain embodiments, the prep pod device may enable a user to insert a swab into the swab chamber 100, dispense reagents onto the tip of the swab for analyte extraction by pressing the buttons 115, and transfer the extracted liquid sample out of the swab chamber 100 for analysis by pouring the extract through the cap 130.

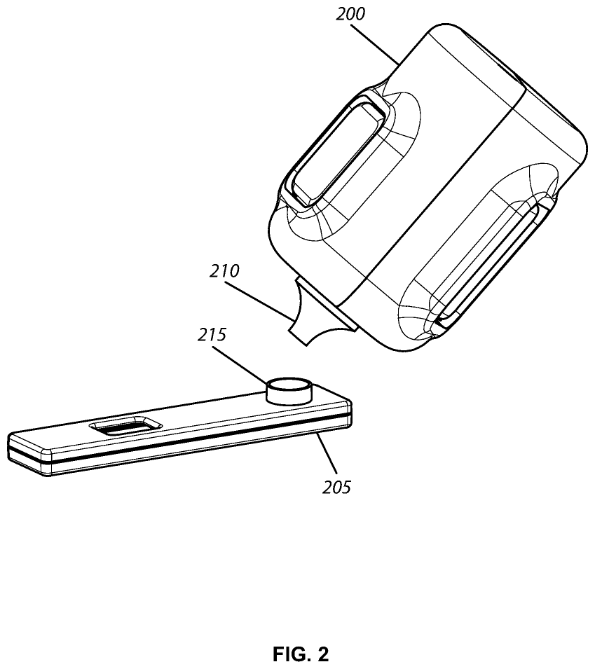

FIG. 2 illustrates an example of using the prep pod device, according to certain embodiments. In particular, FIG. 2 illustrates an example of how the prep pod device 200 from FIG. 1 may be used to dispense liquid. For instance, FIG. 2 illustrates a sample well 215 of an analysis device. In certain embodiments, the analysis device may include, but not limited to, a lateral flow assay cartridge 205. According to certain embodiments, when the prep pod device 200 is inverted or tilted at an angle, liquid may flow out of the cap 210 into the sample well 215 of the lateral flow assay cartridge 205. Thus, the prep pod device 200 makes it easy for a user to extract material from a swab into a liquid solution, and dispense that liquid into any arbitrary assay device. In certain embodiments, an assay device may be any kind of cartridge, cassette, tube, strip, plate, channel, membrane, container, instrument or other device used to run an assay, a test, or an analytical procedure to detect the presence or quantity of one or more analytes in the sample.

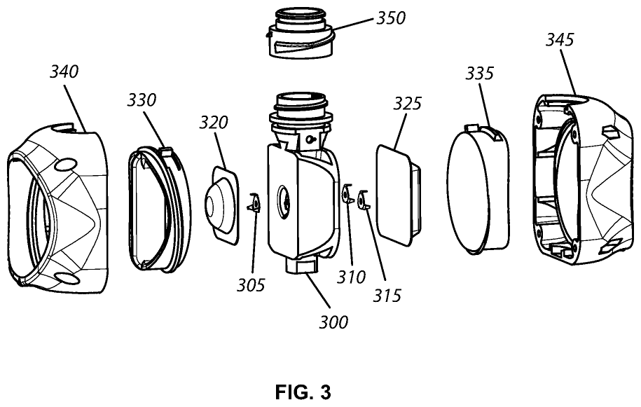

FIG. 3 illustrates an exploded view of an alternate embodiment of the prep pod device in FIGS. 1 and 2, according to certain embodiments. As illustrated in FIG. 3, the prep pod device may include a swab chamber module 300 and lances 305, 310, 315 for puncturing the blisters 320, 325. According to certain embodiments, instead of one single blister packet as in the device of FIG. 1, the blisters 320, 325 in FIG. 3 may be separated into two different packets. Further, in other embodiments, the packet labeled as 325 may include two different blisters, and therefore may require two lances (310, 325) for puncturing.

According to certain embodiments, the prep pod device in FIG. 3 may have a different mechanism for compressing the blisters for puncturing and reagent release. For example, according to certain embodiments, instead of buttons that rotate about a hinge when pressed by a user as in the device in FIG. 1, this device may use dials 330, 335 that when rotated clockwise or counterclockwise, depending on the design of the threading, move in towards the swab chamber 300. This movement may apply a compressive or squeezing force on the blisters 320, 325, causing the lances 305, 310, 315 to puncture the blisters 320, 325, and release reagent. In certain embodiments, the threading on the dials fits into complementary threading in the housing components 340, 345. For instance, according to certain embodiments, the dimensions of the threading may be designed such that a half-turn of the dials (i.e. 180°) or a full-turn (i.e. 360°) is sufficient to compress the blisters 320, 325 such that the lances 305, 310, 315 puncture the blisters 320, 325, releasing reagent from the blisters 320, 325 into the swab chamber 300.

However, in other embodiments, it may be possible to design the threading such that any arbitrary degree of rotation of the dials in a clockwise or counterclockwise direction can result in puncturing of the blisters 320, 325. As illustrated in FIG. 3, a “metering cap” 350 may be provided and designed for controlled or metered release of liquid from the swab chamber 300 onto or into an assay device. As such, the volume dispensed from the prep pod into the assay device may be precisely controlled with a relatively low coefficient of variation (e.g., preferably 5-10% or less, or up to 20-30%). According to certain embodiments, the cap 350 may have internal threading such that the cap 350 screws onto the top of the swab chamber 300, and external threading on the cap 350 that enables the entire prep pod assembly to be screwed onto an assay device for controlled metering of the volume of liquid dispensed into the assay device from the swab chamber 300.

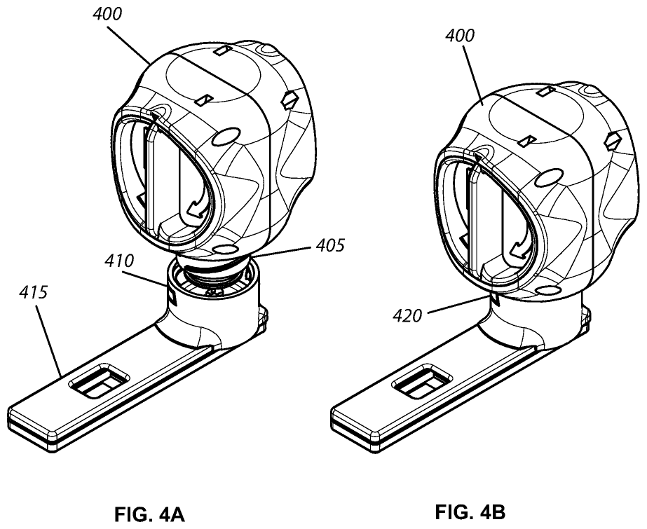

FIG. 4(A) illustrates attachment of the pre pod device of FIG. 3 into an assay device, according to certain embodiments. In addition, FIG. 4(B) illustrates the pre pod device of FIG. 3 attached to the assay device, according to certain embodiments. As illustrated in FIGS. 4(A) and 4(B), the entire assembled prep pod device 400 has been inverted such that the cap 405 is pointing down. The external threading on the cap fits into complimentary threading in a sample port 410 of a lateral flow assay cartridge 415. According to certain embodiments, the cap 405 of the prep pod 400 may have a film or frangible material (not shown) that prevents liquid from flowing out of the prep pod device 400 when it is inverted and until the frangible material is intentionally punctured for controlled volume-metered release of the liquid sample. When the user aligns the prep pod device 400 with the lateral flow test cartridge 415, the user can rotate the prep pod device 400 clockwise or counterclockwise, depending on the design of the threading, but preferably clockwise in certain embodiments, until the prep pod 400 snaps in place or the device cannot be further rotated or turned.

In certain embodiments, the sample port 410 of the cartridge 415 may be configured with a prong or puncturing device that breaks the film or frangible seal on the cap 405 of the prep pod device 400 when the user screws the prep pod device 400 into the assay cartridge 415. Puncturing of this seal releases a controlled or metered volume of the liquid sample from the swab chamber in the prep pod device 400 into the assay cartridge 415. In some embodiments the device 400 may provide “feedback” to the user indicating that they have correctly inserted the prep pod device 400 into the assay cartridge. This feedback may be in the form of an audible click sound, or in other embodiments, the user may feel the devices click or snap in place when the prep pod device 400 is fully inserted. As illustrated in FIG. 4(B), the assay cartridge 415 may include a small feature 420 that “snaps” or “clicks” when the user has correctly and fully inserted the prep pod device 400 into the assay cartridge 415. The small feature that provides feedback may be based on devices and methods for “snap fits” used to mate two parts together. In a snap fit, one of the parts, which may be referred to as the “male” part, may be a small protrusion such as a hook, wedge, bead, stud or similar feature on a cantilever, tapered beam, or another deflectable plastic part that allows some flexibility of the small protrusion. The “female” part of the snap fit may be a depression, hole, or ridge that catches the small protrusion of the male part when the two parts are forced together. Snap joints or snap fits may be of a variety of shapes include simple cantilever beams, tapered cantilever beams, U-shaped cantilevers, L-shaped cantilevers, latches, hooks, or flanges. In other embodiments the snap feature may be based on an annular snap joint or a torsion snap joint.

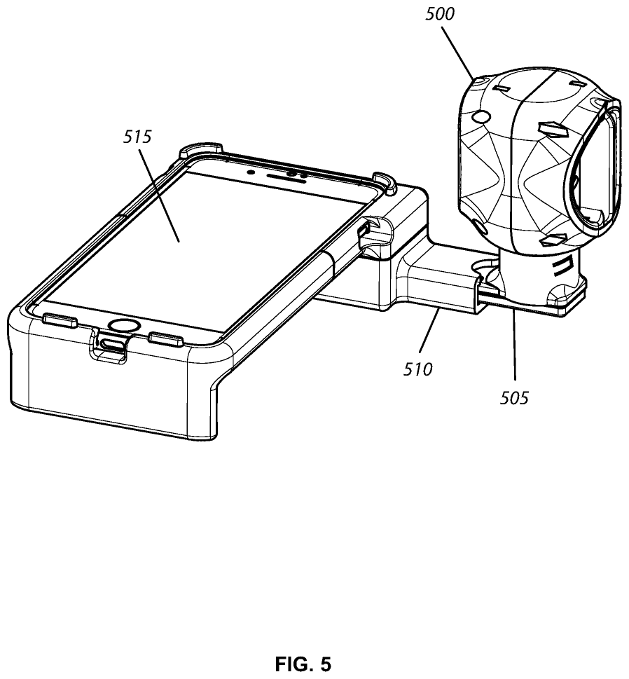

FIG. 5 illustrates the prep pod device inserted into a lateral flow assay cartridge, which is inserted into a cartridge port of an adapter connected to a processing device or imaging device including, for example, a mobile computer or a smartphone, according to certain embodiments. In particular, a volume-metering prep pod device 500 may be fully inserted into a lateral flow assay cartridge 505, which has been inserted into the cartridge port 510 of an adapter connected to a smartphone 515. In certain embodiments, the smartphone 515 may be used for signal acquisition and readout or analysis of the test results from the lateral flow assay 505. According to certain embodiments, the rear camera on the smartphone 515 may be used to capture images of the result window of the lateral flow assay cartridge 505 to analyze the signal by image processing and image analysis. In some embodiments, a software application or app on the smartphone 515 may continuously capture video or images of the lateral flow assay cartridge result window or analyte detection zone to determine if a liquid sample has been added to the cartridge 505 for automated timing of the assay duration and automated timing of when to initiate signal acquisition. Although FIG. 5 illustrates the assay readout device is a smartphone connected to an adapter, according to other embodiments, a variety of other readout devices may be used, such as lateral flow test readers.

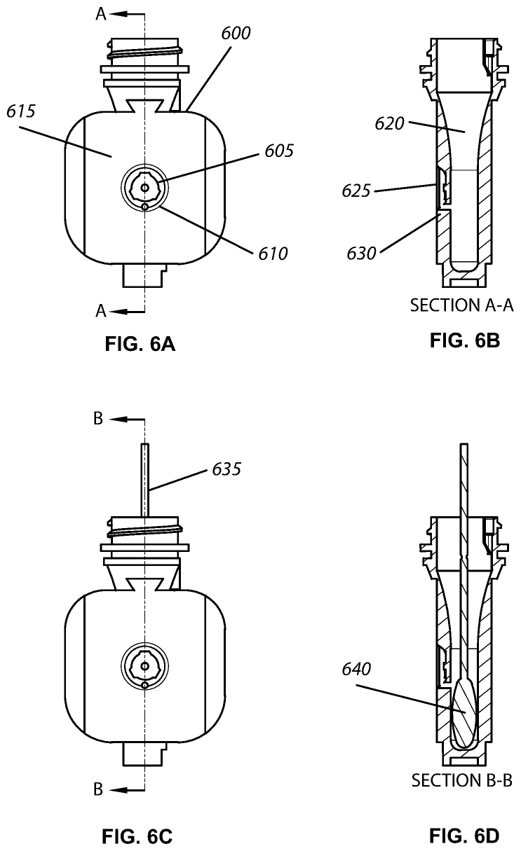

FIG. 6(A) illustrates a front view of a swab chamber module, according to certain embodiments. In particular, FIG. 6(A) illustrates a front view of the swab chamber module 600 without a swab inserted. The swab chamber module 600 may include a lance 605 for puncturing the blister. In certain embodiments, the lance 605 may sit in a small pocket or lance cavity in the exterior of the swab chamber module 600. As illustrated in FIG. 6(A), the swab chamber module 600 may also include a flat mounting face 615 on the exterior of the swab chamber module 600 onto which the blister would be mounted during assembly of a complete prep pod device. In certain embodiments, the lance cavity may be designed such that when the blister is mounted onto the mounting face 615, the prongs of the lance 605 may optimally be positioned relative to the blister such that the blister may be punctured when it is mechanically compressed with a sufficient force by a button or dial. According to certain embodiments, the cavity for the lance 605 may have a small hole 610, which connects the lance cavity to the inner swab chamber.

According to certain embodiments, when a blister is assembled onto the mounting face 615, the blister and cavity may create a sealed enclosure such that when the blister is compressed and the lance 605 punctures the blister, the only direction for liquid to flow is out of the blister into the lance cavity, and from the lance cavity through the hole 610 into the swab chamber. According to other embodiments, the blister may be assembled onto the mounting face 615 using an adhesive or other mechanism that ensures strong chemical-resistant and leak-proof bonding between the blister and the mounting face. This strong bond or seal ensures that the only direction for reagent to flow when the blister is compressed and punctured is through the lance cavity hole into the swab chamber.

FIG. 6(B) illustrates a cross-sectional view of the swab chamber module along line A-A of FIG. 6(A), according to certain embodiments In particular, section A-A shows a cross-section of the swab chamber module, which includes the inner swab chamber 620, cavity 625 for the lance 605, and hole 630 for release of liquid from the blister into the swab chamber 620. Further, FIG. 6(C) illustrates another side view of the swab chamber module, according to certain embodiments. In particular, FIG. 6(C) illustrates the swab chamber 620 after insertion of a swab, with the swab stem 635 extending out of the swab chamber module 600. In addition, FIG. 6(D) illustrates a cross-sectional view of the swab chamber module 600 along line B-B of FIG. 6(C), according to certain embodiments. In particular, section B-B shows a cross-section of the swab chamber module 600 with the swab fully inserted such that the tip of the swab 640 is positioned at the bottom of the swab chamber 620. In some embodiments it may be advantageous to position the lance cavity hole 630 near the top of where the swab tip would be located after full insertion of the swab into the chamber 620, such that when liquid flows through the hole 630 after being released from the blister, the liquid flows downward, completely covering the swab tip 640 from top-to-bottom.

According to other embodiments, it may be advantageous to position the hole 630 closer to the middle or the bottom of the swab tip 640. In some embodiments the diameter of the lance cavity hole 625 may be optimized such that the pressure applied to the blister by pressing the button or turning the dial results in a relatively high velocity of liquid “jetting” out of the hole 630 to aid in physically extracting material from the swab by fluidic forces or shear forces and dispersing it in the resulting liquid extract or sample. In other embodiments this “jetting effect” may be undesirable, and the diameter of the lance cavity hole 630 can be increased to create a lower fluid velocity.

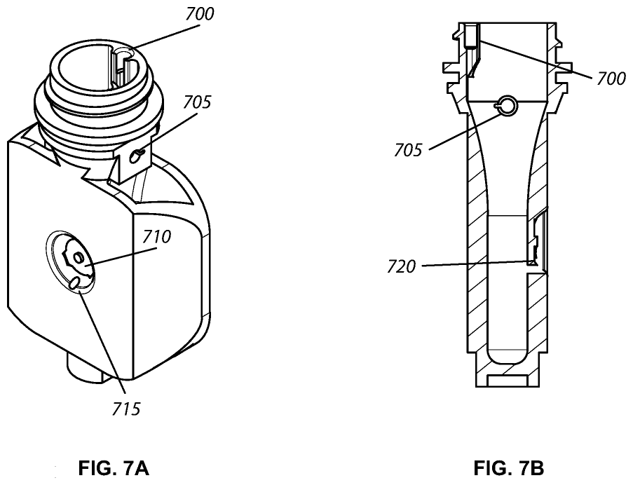

FIG. 7(A) illustrates an isometric view of the swab chamber module, according to certain embodiments. In addition, FIG. 7(B) illustrates a cross-sectional view of the swab chamber module of FIG. 7(A), according to certain embodiments. As illustrated in FIGS. 7(A) and 7(B), the chamber module may include features that grip the stem of the swab to hold it in a fixed position and, if necessary, to aid in breaking off the stem of the swab. According to certain embodiments, a cap may be incorporated with the prep pod device. For instance, the cap may connect to the top of the swab chamber after the swab is inserted, thereby enclosing the swab inside the chamber. However, certain swabs may have a long stem to aid in sample collection, and this stem may be significantly longer than the height of the swab chamber. If the swab is excessively long, it may be necessary to break off part of the swab stem such that the swab tip or sample collection end of the swab can be enclosed in the swab chamber with a cap.

In some embodiments the swab chamber may be designed to have a notch feature 700 that aids or assists in breaking the swab. For example, in certain embodiments, the notch feature 700 may aid in breaking the swab in the stem region after fully inserting the swab into the swab chamber. Once the user breaks off the stem of the swab, the cap may be connected to the top of the swab chamber. When the swab chamber is sealed with the cap, pressing the buttons or turning the dials to release liquid from the blisters into the swab chamber may increase the pressure within the chamber due to the volume in the chamber displaced by the liquid. In other words, the air that is initially inside the swab chamber may be forced into a smaller volume by the liquid dispensed by the blisters, resulting in an increase in pressure. Thus, some embodiments may include features that enable the relief of internal air pressure that may build up within an enclosed swab chamber.

According to certain embodiments, relief of the internal air pressure may be by way of a hole 705 located on the side of the swab chamber's neck. In some embodiments this hole may be filled with a flexible rubber valve that allows air, but not liquid, to flow out of the chamber in order to equilibrate the internal pressure in the swab chamber with the external ambient air pressure without loss of liquid sample. In other embodiments this pressure relief hole may be filled with a membrane or filter, typically composed of a hydrophobic material, that allows air to pass through, but not liquid, for pressure relief and equalization with the external ambient air pressure. As illustrated in FIG. 7(A), the lance 710 may be provided in the lance cavity from an isometric view. In addition, FIGS. 7(A) and 7(B) illustrated that the lance cavity may include a hole 715 and 720 that allows liquid released from the punctured blister to flow into the swab chamber.

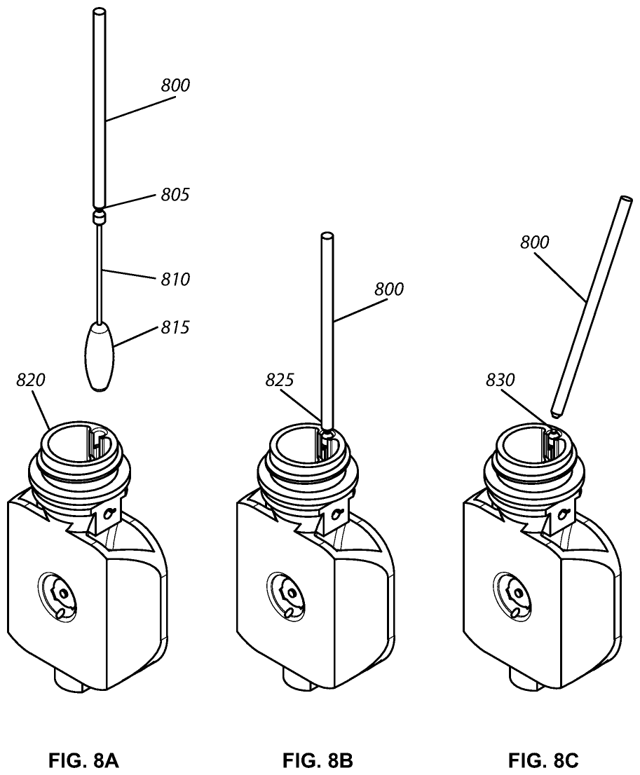

FIGS. 8(A)-8(C) illustrate how the notch feature in the swab chamber may be used to break off the stem of the swab. For example, FIG. 8(A) illustrates an isometric view of a swab and the swab chamber module, according to certain embodiments. As illustrated in FIG. 8(A), the swab chamber may include a mouth or opening 820 into which the swab may be inserted. In some embodiments the swab may be configured to have a main stem 800, breakpoint 805, sampling stem 810, and swab tip 815. According to certain embodiments, the main stem 800 of the swab may be relatively thick and stiff. In addition, the breakpoint 805 of the swab may be narrower than the main stem 800 of the swab, or it may be mechanically weakened such that when the swab is deliberately bent by the user, the swab will break at the breakpoint 805. Further, in certain embodiments, the sampling stem 810 of the swab may be narrower than the main stem 800 of the swab, and the swab tip 815 may be used for sample collection.

For example, in some embodiments, a PURITAN FLOCK SWAB can be used with a prep pod. An exemplary PURITAN FLOCK SWAB is Reference Number 25-3806-U BT, and has a thickness of 2.6 mm along the main stem of the swab, which is about 87 mm long, excluding a plug-style cap, and the sample collection end of the swab has a narrower stem that is approximately 1.7 mm in diameter and is about 50 mm long including the tip for sample collection. The tip of the 25-3806-U BT PURITAN FLOCK SWAB is approximately 5-5.5 mm in diameter and the total length of the tip that is coated with the flocked fiber materials for sample collection is about 17 mm long. The main stem of the swab may also be called the “handle”, and it may have a tapered diameter that ranges from about 2.6 mm down to 1.7 mm in some embodiments. In other embodiments, the swab may have a constant diameter along the main stem of the swab or the handle of about 2.5 mm, while the tip of the swab may be between 3-5 mm with a constant diameter. In some embodiments, the tip of the swab may have a tapered diameter that ranges from about 7 mm down to about 2.5 mm. The overall length of the swab is typically about 150-160 mm. As will be appreciated, other sampling devices, including but not limited to other swab sampling devices, having the foregoing dimensions within a range of about 10% can also be used in a sample prep pod device of the same configuration. Similarly, the sampling device dimensions can be adapted to sample prep pod devices having larger or smaller dimensions than one configured to accept a 25-3806-U BT PURITAN FLOCK SWAB.

According to certain embodiments, the swab tip is where the analyte, if present, is typically located in greatest abundance on the swab after the tip is contacted with an arbitrary surface, fluid, or material for sample collection. In some embodiments it may useful to make the sampling stem 810 of the swab narrower than the main stem 800, which may allow the sample collection end 810 of the swab to flex, thereby allowing for more efficient sample collection, which can be particularly useful in some applications such as vaginal swabs used for the detection of bacterial or viral pathogens.

FIG. 8(B) illustrates the swab chamber module after the swab has been fully inserted, according to certain embodiments. In particular, FIG. 8(B) illustrates the swab chamber after the swab has been fully inserted, with the breakpoint 810 of the swab aligned with the notch 825 in the swab chamber. Further, FIG. 8(C) illustrates a main stem of the swab broken off and detached, according to certain embodiments. In particular, FIG. 8(C) illustrates the main stem 800 broken off and detached 830 from the sampling end 810 of the swab. According to certain embodiments, the notch feature 825 may maintain a strong grip on the swab near the breakpoint 810, which assists the user in breaking off the main stem 800 of the swab at the breakpoint 810 by simply bending the stem. In some embodiments the notch feature 825 may maintain a sufficiently firm grip on the sampling end 810 of the swab such that the swab tip 815 remains fixed in its optimal position near the bottom of the swab chamber, even if the user inverts the prep pod device. Once the main stem of the swab has been broken, a cap may be placed over the swab chamber, sealing the sample collection end of the swab inside the chamber, thereby allowing safe, efficient, and effective extraction of material from the swab tip using reagents stored in the blisters.

According to certain embodiments, the final liquid extract or sample, which may include a mixture of the reagents from the blisters and material extracted from the swab, may be removed from the swab chamber by various mechanisms for analysis in an assay, test, or analytical procedure. In certain embodiments, it may not be essential that the swab has a breakpoint feature for the notch to serve its intended function, and in some embodiments a swab that is lacking a breakpoint may be broken using the notch feature on the swab chamber. According to other embodiments, it may not be essential that the swab has variations in the thickness of its stem along the length of the swab as illustrated in FIG. 8(A). Instead, in certain embodiments, the essential features of the swab may be that it has a tip for sample collection and a stem for handling the swab. In other embodiments the user may break off the swab stem with cutting tools such as scissors, or manually with their hands. Moreover, in further embodiments, the notch feature may not be essential in all embodiments. However, the notch feature may significantly aid in consistently breaking off the sampling end of the swab with relative ease, and help ensure that the tip is fully inserted into the swab chamber in its optimal position for effective analyte extraction.

FIG. 9 illustrates an isometric view of a blister packet 900 of FIG. 1, according to certain embodiments. In FIG. 1, the blister packet has been folded along the crease line that separates the single circular-shaped blister (on the left in FIG. 9) from the two elongated blisters (on the right in FIG. 9), so that the blister packet can be mounted onto the wedge-shaped swab chamber module. In certain embodiments, the blister packet 900 may have three individual blisters 905, 915, and 920. The blister packet 900 may also include a hole 910 to aid in assembly of the prep pod device and for properly aligning the blister packet 900 onto the external mounting surfaces of the swab chamber module. In certain embodiments, the blister 905 may have a different shape from the other two blisters 915 and 920. In some embodiments the volumes of reagent contained in the different blisters may be different depending on the requirements for the assay or analyte extraction conditions, and therefore it may be essential to use different blister shapes and sizes.

According to certain embodiments, when this blister pack 900 is mounted onto a prep pod device as in FIG. 1, reagents from the two blisters 915 and 920 in FIG. 9 may be released simultaneously into the swab chamber by the actuation of a single button. In certain embodiments, pressing a single button or turning a single dial on the prep pod device may not necessarily release only one type of reagent solution into the swab chamber, as it may be possible to configure a button or dial to release multiple reagents simultaneously into the swab chamber by puncturing multiple blisters. According to certain embodiments, releasing multiple reagents at a time from the single push of a button or turn of a dial may be necessary when the reagents are not stable when mixed and stored over long periods of time and must therefore be stored separately. For instance, a variety of additives in the blister reagent solutions, such as mucolytic agents, may be used to reduce assay interference or improve assay consistency. Such reagents may be compatible when mixed together for extraction of analytes from a swab over short timescales (e.g., a few minutes to several hours), but may degrade when mixed as a single reagent solution and stored on a shelf for several months to years.

In some embodiments reagents may be dispensed sequentially. In such cases, the prep pod device and blisters may be designed such that each blister has its own button. For example, to extract antigens from bacteria or viruses collected on a swab, a two-step lysis and neutralization procedure may be performed, wherein the swab may first be exposed to a lysis buffer at extreme pH (i.e. highly acidic or basic conditions), and then a neutralization buffer may be added to adjust the pH, ionic strength, or other parameters to a range that results in better assay sensitivity, specificity, or performance. As described herein, the terminology used defines a blister packet or blister pack as a single discrete entity or part comprising one or more blisters where each blister is sealed with a reagent. A blister, on the other hand, may be a single sealed enclosed space or vessel containing a specific volume of a reagent. Thus, according to certain embodiments, a blister packet or blister pack may be a single part that has multiple blisters, but a “blister” refers to a single vessel that contains a specific volume of a reagent in an isolated enclosed space. For example, the drawing in FIG. 9 illustrates a single blister pack, wherein the blister pack includes three blisters.

In certain embodiments, at least a major portion of one or more of the walls (and in some embodiments essentially all the walls) of a pierceable reagent reservoir (e.g., blister or blister pack) are favorably made of a flexible material. Moreover at least a major portion of the one or more of, or all of, the walls is favorably made of a material that is flexible, such that when the reservoir contains the liquid to be released the at least major portion of the walls is in an extended or expanded state and when the reservoir is empty or the liquid has been dispensed the at least major portion of the walls is in a collapsed state. For example, the collapsible reservoir (e.g., blister or blister pack) may be configured as a flexible pouch or ampoule. The walls of an, e.g., collapsible or flexible, reservoir may be made of a polymeric containing film having either a monolayer or a multi-layer (e.g., laminate) structure. The polymeric materials may be selected from the group consisting of polyester, polypropylene, cyclic-olefin polymer, cyclic olefin copolymer, polychlorotrifluoroethylene, ethylene vinyl alcohol copolymer and combinations thereof. Examples of suitable commercially available materials include ZEONEX™ COP 5000 monolayer; TEKNIFLEX™ CPTA (COC/LDPC/PCTFE laminate); TEKNI-PLEX™ PTA260 (PE/PCTFE laminate); TEKNI-PLEX™ PTA360 (PE/PCTFE laminate); TEKNI-PLEX™ PTA2200 (PE/PCTFE laminate); TEKNI-PLEX™ PTA6200, TEKNI-PLEX™ PTOA2200 (PE/E V OH/PCTFE laminate); HUHTAMAKI™ 602204276 (PET/A1/PP laminate); HUHTAMAKI™ 10224247983 (PET-AlOx/PET/PP laminate); SPAETER™ films made of a PET-SiOx film layer laminated with either a BAREX™ or TPE film layer.

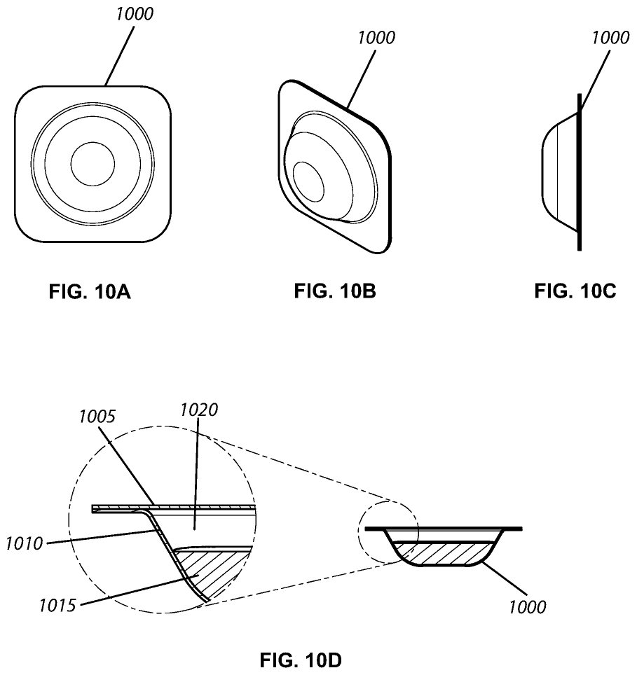

FIGS. 10(A)-10(D) illustrate multiple views of a single blister 1000, according to certain embodiments. For instance, FIG. 10(A) illustrates a front view of a single blister, FIG. 10(B) illustrates an isometric view of the single blister 1000, FIG. 10(C) illustrates a side view of the single blister 1000, and FIG. 10(D) illustrates a cross-sectional view and a zoomed in portion of the cross-section of the single blister 1000, according to certain embodiments. As illustrated in FIGS. 10(A)-10(D), the blister 1000 may include two materials, a blister cavity side 1010 and a lidding material or lidding side 1005. According to certain embodiments, the blister cavity side 1010 may be created by taking a flat sheet or film of deformable material and using a manufacturing technique such as vacuum forming (also called vacuuforming), thermoforming, or cold forming to create blisters, cavities, pockets, wells, indentations, depressions, or impressions in the film. In certain embodiments, this film may then oriented with the blister cavities facing concave-up such that the blister cavities may be filled with liquid reagent. The blister may then be sealed by placing a flat sheet or film on top of the reagent-filled blister to serve as the lidding material and sealing the two films to form a leak-proof, air-tight hermetic seal.

According to certain embodiments, sealing may be achieved by a variety of methods, including for example, thermally or ultrasonically. In some embodiments, the blister materials used for both the lidding and cavity side may be multilayer materials that have a barrier layer, such as foil or polymer with a low moisture vapor transmission rate (MVTR), and a seal layer which may be a polymer or adhesive. In other embodiments the blister materials may be a single homogeneous layer of a one type of material that has both a low MVTR and can be sealed. The internal enclosed volume of the sealed blister may include both liquid reagent 1015 and some air 1020. According to certain embodiments, residual air may be present because overfilling the blister with liquid may cause leaking of the reagent by capillary action when the lidding layer is placed on top of the blister cavity layer for sealing, which can result in an ineffective low-quality seal. In certain embodiments, the blister may be assembled with the lidding side 1005 in contact with the mounting face of the swab chamber module and the blister cavity side 1010 in contact with the button or dial. Thus, the lance may be designed to puncture the lidding side 1005 of the blister for release of reagent. It may be important in certain embodiments that the blister is assembled effectively onto the mounting face of the swab chamber such that when the lidding layer of the blister is punctured, the liquid cannot escape through the interface between the lidding layer and the mounting face, and instead is forced through the lance cavity hole into the swab chamber.

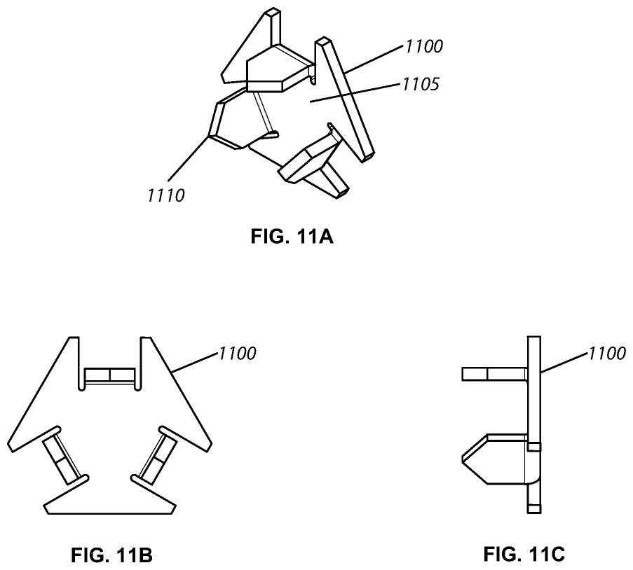

FIGS. 11(A)-11(C) illustrate multiple views of a lance 1100 used in the prep pod device for puncturing the blister to release reagent from the blister. In particular, FIG. 11(A) illustrates an isometric view of a lance 1100 of the prep pod device, FIG. 11(B) illustrates a front view of the lance 1100 of the prep pod device, and FIG. 11(C) illustrates a side view of the lance 1100 of the prep pod device. As illustrated in FIG. 11(A), the lance 1100 may include a main flat body 1105 that mounts onto the swab chamber module in the lance cavity region, and a prong 1110 for puncturing the blister. According to certain embodiments, the lance 1100 may be made of metal, including, for example, stainless steel. However, in other embodiments the lance may be composed of plastic, and may be directly molded into the swab chamber module inside the lance cavity region to simplify manufacturing. In certain embodiments, when the lance and the swab chamber module are designed as separate parts, the lance may be assembled onto the swab chamber module using adhesives, heat staking, co-molding, or other techniques. In the embodiment illustrated in FIGS. 11(A)-11(C), the lance 1100 may have three identical prongs 1110 for puncturing the blister. However, in other embodiments the lance 1100 may use a single prong, two prongs, multiple prongs, or an array of prongs to puncture the blister. In the embodiment illustrated in FIGS. 11(A)-11(C), the prongs 1110 may be symmetric, but in other embodiments the prongs 1110 may be asymmetric and have a slanted blade to enable easier puncturing of the blister.

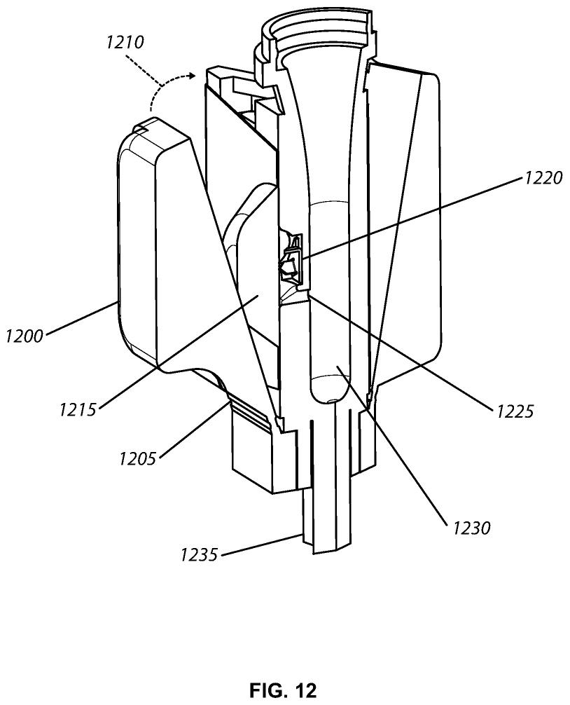

FIG. 12 illustrates an isometric angle with a cross-sectional view of an assembly of the swab chamber module with a blister packet and a button, according to certain embodiments. The assembly in FIG. 12 may be based on the same design for the prep pod device as illustrated in FIG. 1, wherein the blister is punctured by pressing a button on the device. In FIG. 12, the prep pod device may include a button 1200 with a size approximately large enough that a user can comfortably press the button 1200 with his or her thumb. The button 1200 may have a hinge region 1205, which allows the button 1200 to rotate towards the blister 1215, as shown by arrow 1210. As the button 1200 squeezes the blister 1215, the compressive forces on the blister 1215 cause it to swell or deform like a balloon resulting in the lidding side of the blister 1215 expanding into the lance cavity towards the prongs of the lance 1220.

According to certain embodiments, the lance prongs may puncture the lidding side of the blister 1215, and reagent is squeezed out of the blister 1215 through the hole 1225 that connects the lance cavity to the swab chamber 1230. Although not shown in this figure, the button 1200 may have a latch or hook feature such that when the button 1200 is completely pressed or fully engaged by the user, the latch snaps the button in place, completely compressing the blister and preventing the button 1200 from moving backwards and returning to its initial position. In certain embodiments, the button 1200 may be held in place after it is fully engaged to prevent reagent from being sucked back into the blister 1215. Additionally, the latch may make an audible sound or snap that may be heard or felt by the user when the latch and button 1200 have snapped in place, informing the user that the button 1200 has been correctly pressed to its maximum extent. According to certain embodiments, the swab chamber may include a bottom support staff 1235. In certain embodiments, the prep pod device may have two buttons on opposite sides of the swab chamber, but the buttons may be fabricated as a single part or module. This design of the button module and the support staff of the swab chamber module may allow the buttons to be assembled onto the swab chamber with great ease, low cost, and high consistency during manufacturing. The support staff of the swab chamber may also allow the housing parts of the prep pod device, as illustrated in FIG. 1, to be assembled around the swab chamber and button assembly.

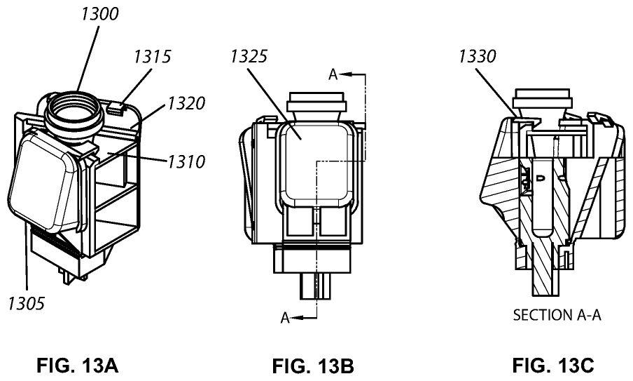

FIGS. 13(A)-13(C) illustrate different views of the swab chamber and button assembly for the prep pod device, according to certain embodiments. In particular, FIG. 13(A) illustrates an isometric view of a partial assembly of the prep pod device, revealing the opening of the swab chamber module into which a the swab is inserted, FIG. 13(B) illustrates a side view of a partial assembly of the prep pod device, and FIG. 13(C) illustrates a cross-sectional view of a partial assembly of the prep pod device of FIG. 13(B), according to certain embodiments. As illustrated in FIG. 13(A), the swab chamber may include a top opening 1300 into which the swab is inserted. The swab chamber may also include a button 1305 that has been fully engaged or pressed to its maximum extent such that the latch 1310 has snapped in place onto an external ridge of the swab chamber module. The button on the opposite side of the device has not been engaged, and the latch 1315 on this button is free from the ridge 1320 onto which the latch 1315 connects or snaps in place.

FIG. 13(B) illustrates a side view of the prep pod device, where the button 1325 is fully engaged. Further, FIG. 13(C) illustrates a cross-section of FIG. 13(B), revealing the internal components of the swab chamber and a cross-section view of the latching mechanism. In particular, FIG. 13(C) illustrates the latch 1330 from FIG. 13(A) that has been fully engaged. According to certain embodiments, on the button that is fully engaged, the mounting face of the swab chamber module may be flush with the back side of the button (i.e., the face of the button that sits in contact with the blister).

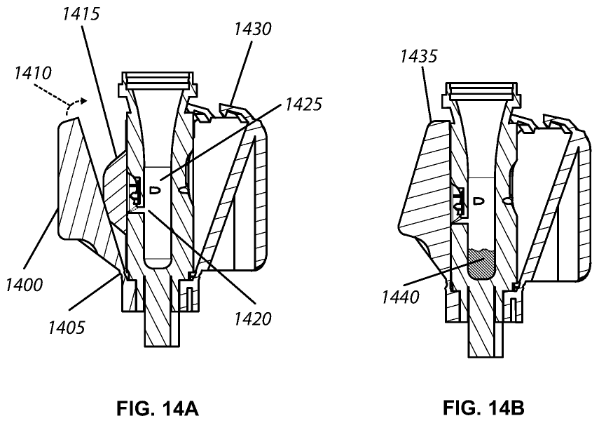

FIGS. 14(A) and 14(B) illustrate a cross-sectional view of an assembly of a swab chamber, blister, and a button, with the same design as illustrated in FIGS. 1 and 13(A)-13(C), according to certain embodiments. In particular, FIG. 14(A) illustrates a cross-sectional view of the swab chamber module before the button is pressed to release reagent from the blister into the swab chamber module, according to certain embodiments. In addition, FIG. 14(B) illustrates a cross-sectional view of the swab chamber module after the button is pressed to release reagent from the blister into the swab chamber module, according to certain embodiments. As illustrated in FIG. 14(A), the swab chamber module may include a button 1400 and hinge region 1405. In certain embodiments, the hinge region 1405 allows the button 1400 to rotate towards the swab chamber as indicated by arrow 1410. The back side of the button 1400 may squeeze the blister 1415. When the user presses the button 1400, the button 1400 compresses the blister 1415 causing the lidding side of the blister to swell or expand into the lance cavity, and the prongs of the lance puncture the lidding material, releasing reagent from the blister through the hole 1420 that connects the lance cavity to the main swab chamber 1425.

According to certain embodiments, the button 1400 may not show a latch in this drawing due to the cross-section view, but in other embodiments, the buttons used for blister puncturing in a prep pod device may have at least one latch like the latch 1430 on the button on the right side of the swab chamber. As illustrated in FIG. 14(B), the button 1435 may be fully closed, such that some or nearly all of the reagent previously stored in the blister has been released from the blister and into the swab chamber 1440. In certain embodiments, the device may be designed to release reagent from the blister by compressing the blister between the button and the mounting face of the swab chamber module when the button is pressed. In such embodiments, the blister may be composed of a deformable material such as a flexible plastic, polymer-based film, or aluminum foil laminate. In certain embodiments, the deformable material can be or contain a polymeric containing film having either a monolayer or a multi-layer (e.g. laminate) structure. The polymeric materials may be selected from the group consisting of polyester, polypropylene, cyclic-olefin polymer, cyclic olefin copolymer, polychlorotrifluoroethylene, ethylene vinyl alcohol copolymer and combinations thereof. Examples of suitable commercially available materials include ZEONEX™ COP 5000 monolayer; TEKNIFLEX™ CPTA (COC/LDPC/PCTFE laminate); TEKNI-PLEX™ PTA260 (PE/PCTFE laminate); TEKNI-PLEX™ PTA360 (PE/PCTFE laminate); TEKNI-PLEX™ PTA2200 (PE/PCTFE laminate); TEKNI-PLEX™ PTOA2200 (PE/E V OH/PCTFE laminate); HUHTAMAKI™ 602204276 (PET/A1/PP laminate); HUHTAMAKI™ 10224247983 (PET-AlOx/PET/PP laminate); SPAETER™ films made of a PET-SiOx film layer laminated with either a BAREX™ or TPE film layer. A highly stiff or rigid blister material may present significant mechanical resistance to the user when pressing the button and may not deform in a way that results in complete and consistent dispensing of reagent from the blister into the swab chamber.

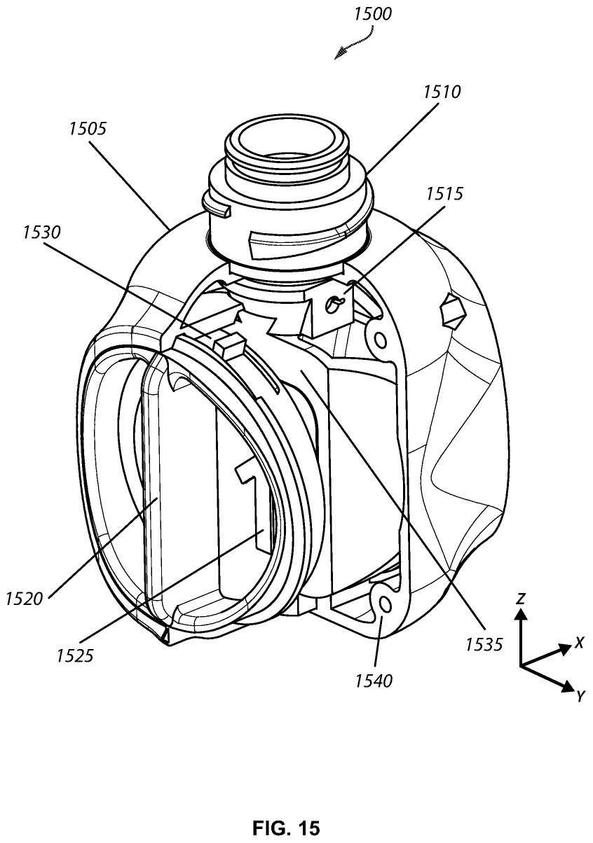

FIG. 15 illustrates an isometric view with a partial cutaway of the prep pod device 1500, according to certain embodiments. As illustrated in FIG. 15, the prep pod device 1500 may include an exterior housing 1505. The prep pod device 1500 may also include a cap 1510 that mounts onto the swab chamber, by, for example, a threaded screw mechanism. In addition, the prep pod device 1500 may include a pressure relief hole 1515 on the main swab chamber that allows air to flow out of the chamber to relieve excess air pressure that may build up inside the chamber when the blister reagents are released into the chamber. A difference between the device in FIG. 15 and the device in FIG. 1 is that instead of using buttons, the device in FIG. 15 uses dials that rotate either clockwise or counterclockwise about the x-axis (i.e. in the zy-plane) to squeeze or compress the blister until puncturing for reagent release. According to certain embodiments, the dial may have a ridge 1520 that enables the user to turn the dial with his or her fingers. In certain embodiments, the dial and the housing 1505 of the prep pod device 1500 may have complementary threading such that when the dial rotates (clockwise or counterclockwise in the zy-plane), it moves along the x-axis, applying a mechanical force on the blister. As with the button design, compressing the blister may cause the lidding side of the blister to swell enough such that the lance punctures the blister, allowing reagent to flow out of the blister. As the dial is turned or rotated to its maximum extent, the reagent stored in the blister is squeezed into the swab chamber 1535.

In some embodiments the dial may have a feature such as a knob 1530 or latch that engages with a feature on the prep pod housing to prevent excess turning of the dial, and to provide feedback informing the user that the dial has been correctly and completely turned and the reagent has been properly released. This feedback may be in the form of an audible “click” sound or the user may feel the dial “snap” in place. According to certain embodiments, the prep pod device 1500 may include a hole 1540 into which screws may be inserted to screw the two housing pieces of the prep pod device together. In other embodiments the housing 1505 may be held together without alternate methods, mechanisms, or devices such as a press fit, snap fit, thermal staking, heat staking, ultrasonic welding, adhesive, or other mechanisms.

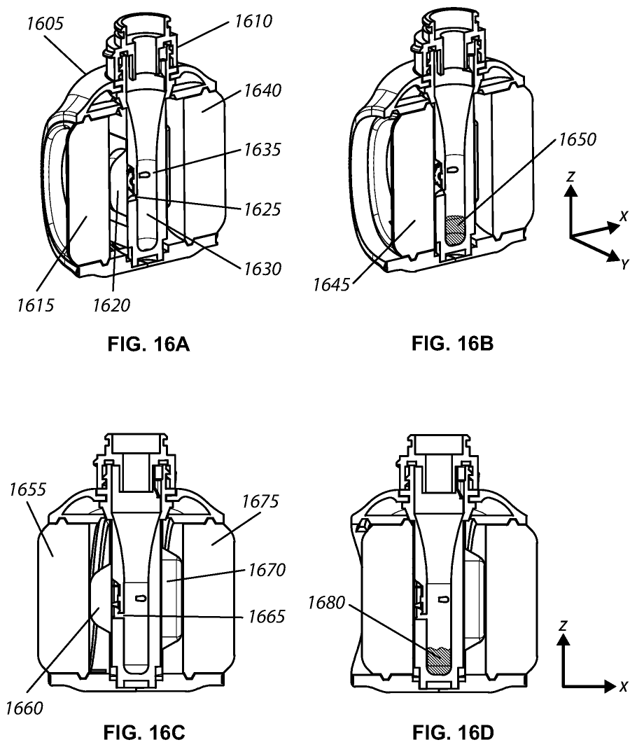

FIGS. 16(A)-16(D) illustrate four different views of a prep pod device with similar design as illustrated in FIGS. 3 and 15. In particular, FIG. 16(A) illustrates the prep pod device before a dial has been fully turned, FIG. 16(B) illustrates the prep pod device after the dial has been fully turned, FIG. 16(C) illustrates other view of the prep pod device of FIG. 16(A) before the dial has been fully turned, and FIG. 16(D) illustrates another view of the prep pod device of FIG. 16(B) after the dial has been fully turned, according to certain embodiments. FIGS. 16(A)-16(D) illustrate the mechanism by which the dial causes the blister to puncture and release reagent from the blister into the swab chamber. For instance, FIGS. 16(A) and 16(B) illustrate the prep pod device with a cutaway as viewed from an isometric angle, while FIGS. 16(C) and 16(D) illustrate the same device from a side view of the cutaway. The prep pod device may include a housing 1605, and a metering cap 1610 that has been screwed onto the swab chamber. The prep pod device may also include a dial 1615 and 1655 on the left-hand side of the swab chamber that can be rotated clockwise or counterclockwise about the x-axis (i.e. in the zy-plane) by the user. As the dial turns it may move along the x-axis and squeezes the blister 1620 and 1660, such that the mechanical forces on the blister cause it to flex, swell, or deform in such a way that the lances puncture the blister, and the reagent from the blister flows through the exit hole 1625 and 1665 that connects the lance cavity to the swab chamber 1630.

According to certain embodiments, there may be a dial 1640 and 1675 on the right-hand side of the swab chamber with its own blister 1670. Further, an exit hole 1635 may be provided to enable the reagent to flow from the right-hand blister into the swab chamber. In certain embodiments, the lance cavity for the right-hand blister is not shown in this figure due to the angle and position of the cutaway. However, FIG. 16(B) illustrates the same device as FIG. 16(A), but after the dial has been fully turned to its maximum allowed degree of rotation 1645, completely compacting or compressing the blister and releasing reagent from the blister into the swab chamber 1650.

FIG. 16(C) illustrates the same device as FIG. 16(A) before the left-hand dial has been fully turned, but with a direct side view of the cross-section to better reveal the internal components and mechanisms of the device. As illustrated in FIG. 16(C), the prep pod device may include a left-hand dial 1655, a reagent blister 1660, and the hole 1665 that connects the lance cavity to the swab chamber. In certain embodiments, the blister on the left-hand side 1660 and right-hand side 1670 of the swab chamber may have different shapes and sizes. In some other embodiments, it may be advantageous for the blisters to have different shapes and sizes, particularly if the blisters contain different volumes of reagents. As previously noted the prep pod device may include dial 1675 for the blister on the right-hand side of the swab chamber.

According to certain embodiments, the internal threading in the housing may allow the dial to move along the x-axis as the user turns the dial, causing the blister to compress under the mechanical forces or load. FIG. 16(D) illustrates the device after the dial on the left-hand side has been fully turned or engaged to release liquid from the blister into the swab chamber 1680, while the dial on the right-hand side has not yet been turned and the right-hand blister remains intact. According to certain embodiments, the z-position of the exit holes connecting the lance cavities to the swab chamber may be different for the left-hand and right-hand blisters. In some embodiments it may be advantageous to position these holes at different z-positions to improve the consistency of the volume of liquid reagent released from each blister, or to improve the mixing efficiency of the two different blister reagents in the swab chamber. In certain embodiments, if a prep pod device has multiple dials or buttons and a specific sequence that the reagents must be released into the swab chamber, the z-position of the exit hole connecting the lance cavity to the swab chamber may be higher for reagents dispensed last or later during the sample extraction process, than reagents dispensed first. This configuration may ensure that the exit hole from the lance cavity is not submerged below the liquid-air interface, and reagent from the blister can flow unobstructed into the swab chamber during puncturing.

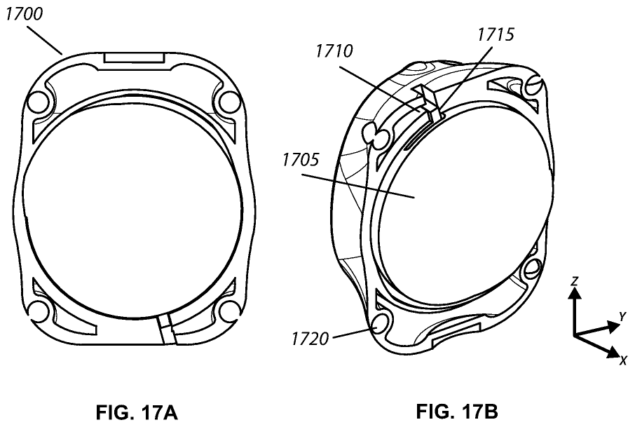

FIG. 17(A) illustrates a side view of a cutaway of the dial and prep pod housing, and FIG. 17(B) illustrates an isometric view of the cutaway of the dial and prep pod housing, according to certain embodiments. In particular, FIG. 17(A) illustrates an external housing 1700, and FIG. 17(B) illustrates a flat face 1705 of the dial that sits in contact with the blister. As the user turns the dial, the dial may move along the x-axis (in the isometric drawing), compressing the blister. FIG. 17(B) further illustrates features 1705 and 17010 that may be used to provide feedback to the user that the device has been fully turned to its maximum allowed degree of rotation. According to certain embodiments, a knob 1715 or ridge may be provided on the dial, and when the dial has been turned its full intended degree of rotation, the knob 1715 may engage with a feature on the housing 1710 that prevents the dial from being turned further, and provides feedback to the user that the dial has been fully turned. In certain embodiments, this feedback may be an audible click or snap sound, or the user may feel that the dial has snapped into place and cannot be turned further. Further, FIG. 17(B) illustrates a hole 1720 on the housing such that the housing parts may be screwed together to enclose the prep pod device's internal components (i.e. the swab chamber, blisters, etc.). In certain embodiments, the housing that encloses the prep pod device's internal components may be held together by various mechanisms other than screws.

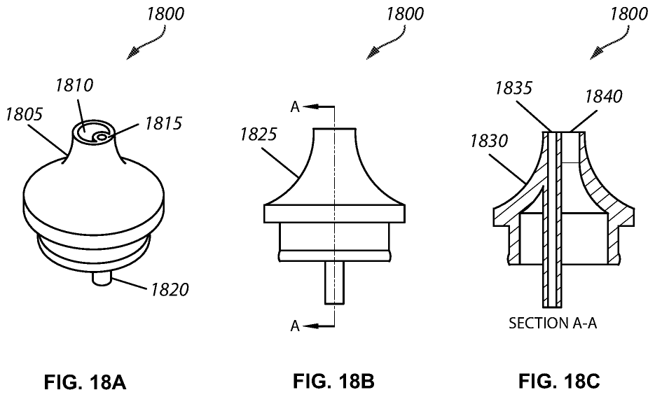

FIGS. 18(A)-18(C) illustrate different views of a “spigot cap” or “dropper cap” 1800 for the prep pod device based on features illustrated in FIGS. 1 and 2. In particular, FIG. 18(A) illustrates an isometric view of a cap of the prep pod device, FIG. 18(B) illustrates a side view of the cap of the prep pod device, and FIG. 18(C) illustrates a cross-sectional view of the cap of the prep pod device along line A-A of FIG. 18(B), according to certain embodiments. In certain embodiments, the cap may connect to the top of the swab chamber and allow the user to pour the liquid extract out of the swab chamber into an assay device. The cap may include a spigot 1805 with a wide opening 1810 or hole that the liquid is poured out of. The spigot 1805 may include a hollow stem or “vent tube” 1815 at the opening of the spigot 1805 for improved flow consistency of liquid through the cap. FIG. 18(B) illustrates a side view of the cap 1825, and FIG. 18(C) illustrates a cross-section of the side view of the cap 1830, which includes the wall of the spigot cap, wide opening 1840 for liquid sample to be poured out of the device through the cap, and a stem feature 1835 incorporated to improve the release and flow consistency of liquid out of the cap.

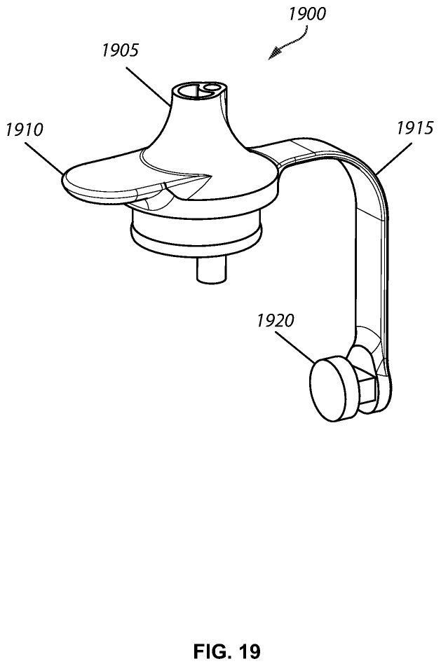

FIG. 19 illustrates a cap design for the prep pod device, according to certain embodiments. In particular, the cap 1900 may include a main body 1905, which may snap onto the swab chamber, and may have holes for dispensing liquid from the swab chamber through the cap. The cap 1905 may also include a tab 1910 that makes it easier for the user to snap the cap onto the swab chamber or pop the cap off the swab chamber. In addition, the cap may include a flexible neck 1915, lanyard, tether, or strap, and an anchor knob 1920 that keeps the cap anchored onto the prep pod device, even if the cap is not snapped onto the top of the swab chamber. According to certain embodiments, cap 1905 may enable the user to use the tab 1910 to pop the cap off the swab chamber, then insert the swab into the chamber, and close the cap back onto the swab chamber for analyte extraction with the reagent blisters. The neck 1915 and anchor 1920 may eliminate the possibility that the user would set down the cap and forget about it or drop the cap and lose it.

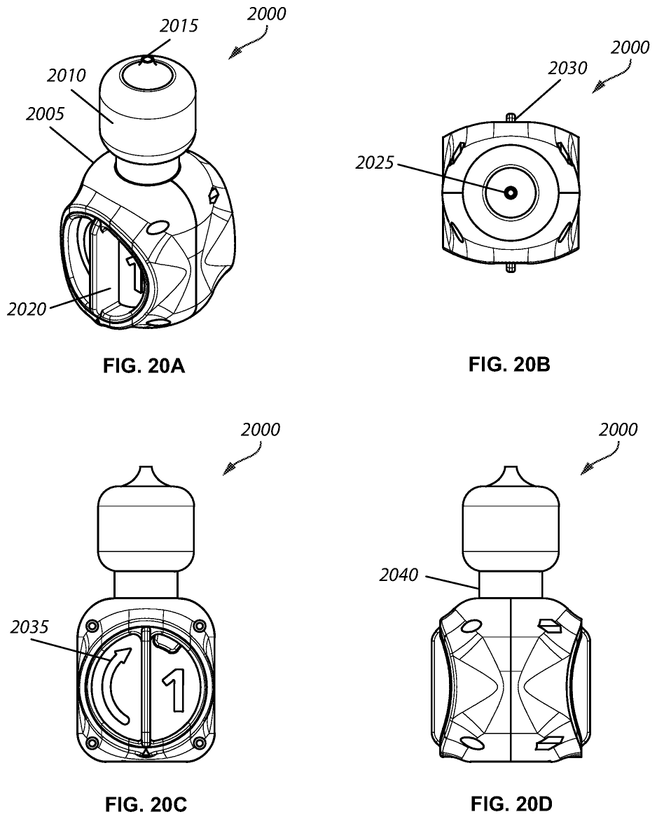

FIGS. 20(A)-20(D) illustrate the prep pod device configured with a flexible dropper bottle for dispensing liquid from the swab chamber into an assay device. In particular, FIG. 20(A) illustrates an isometric view of the prep pod device, FIG. 20(B) illustrates a top view of the prep pod device of FIG. 20(A), FIG. 20(C) illustrates a side view of the prep pod device of FIG. 20(A), and FIG. 20(D) illustrates another side view of the prep pod device of FIG. 20(A), according to certain embodiments. The prep pod device in FIGS. 20(A)-20(D) may include a dial design like the device illustrated in FIG. 3. For example, the prep pod device 2000 may include a main body 2005, and a dial 2020 that the user can turn to release reagent from the blisters into the swab chamber. In addition, the prep pod device 2000 may include a flexible dropper cap 2010. The flexible dropper cap can be configured to dispense small volumes of liquid dropwise, e.g., by applying a squeezing force to the dropper cap or by inverting or tilting the prep pod device. In some embodiments, the dropper cap dispenses drops of about 25, 50, or 75 μL in volume, or from about 10 μL to no more than about 75 μL. According to certain embodiments, the cap 2010 may be connected or disconnected to the main swab chamber by the end user as needed so that the user may insert a swab into the chamber. The dropper cap 2010 may have a narrow outlet 2015 out of which liquid flows, when the device is inverted or tilted at an angle. In certain embodiments, the dropper cap 2010 may be of a similar design to an eye dropper for dispensing small volumes of liquid dropwise.

After the user extracts a liquid sample from the swab, the user may invert the entire prep pod device such that liquid flows into the dropper cap 2010. The liquid will not flow out of the tip of the dropper cap until the user squeezes the dropper cap 2010, in a similar manner to a conventional dropper bottle such as an eyedropper bottle. As illustrated in FIG. 20(B), the dropper cap 2010 may include an outlet 2025, and rib feature 2030 of one of the dials that enables the user to turn the dial for blister puncturing. According to certain embodiments, the dial may have visual features that aid the user in correctly extracting a sample from the swab. In other embodiments, the dials may be numbered, as illustrated in FIGS. 20(A) and 20(B), according to the order in which dials must be turned, and the dials may have a curved arrow 2035 to show which direction the user must turn the dial (i.e. either clockwise or counterclockwise). As illustrated in FIG. 20(D), the neck 2040 of the dropper cap may be configured to connect firmly with a leak-proof seal to the swab chamber. In addition, the dropper cap 2010 may be pushed, plugged, twisted or snapped onto the swab chamber directly, or screwed onto the swab chamber by use of threaded features.

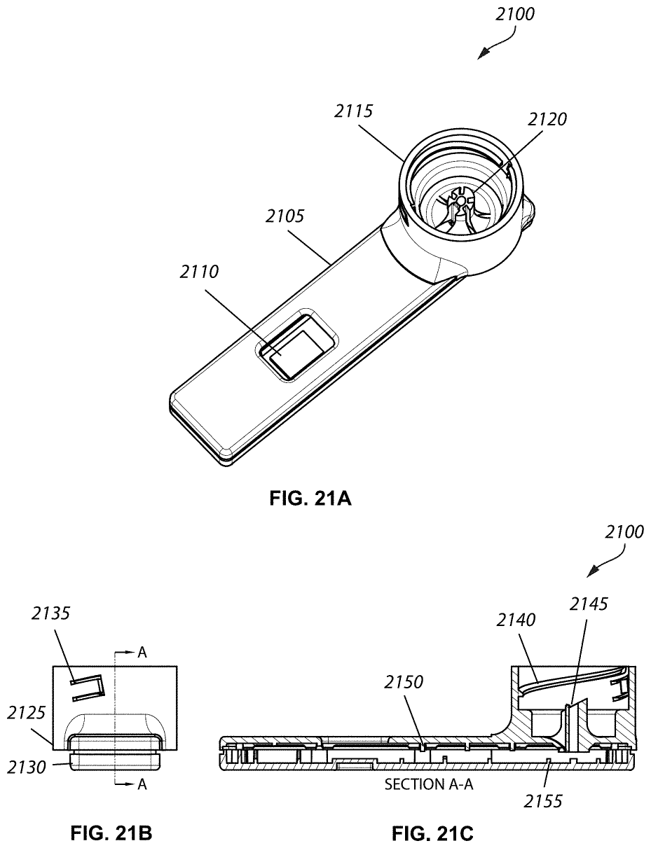

FIGS. 21(A)-21(C) illustrate various views of a lateral flow assay cartridge, according to certain embodiments. In particular, FIG. 21(A) illustrates an isometric view of a lateral flow assay cartridge, FIG. 21(B) illustrates a front view of the lateral flow assay cartridge, and FIG. 21(C) illustrates a cross-sectional view of the lateral flow assay cartridge along line A-A of FIG. 21(B), according to certain embodiments. As illustrated in FIGS. 21(A)-21(C), the lateral flow assay cartridge 2100 may be paired with a prep pod that has a metering cap designed like the cap on the prep pod device illustrated in FIGS. 3-5. In the isometric view, the main body 2105 may be of the lateral flow assay cartridge. However, in other embodiments, 2105 may be of a cassette or housing. According to certain embodiments, a lateral flow test strip may sit inside the cartridge 2100, sandwiched between the top and bottom parts of the cartridge 2100. The result window 2110 result window of the cartridge 2100 may be where the analyte detection zone or sensing region of the lateral flow test is located.

In certain embodiments, the detection zone of the strip may be a nitrocellulose membrane that has immobilized affinity reagents that give a signal that indicates the presence or absence of one or more analytes, and in some embodiments the signal can give quantitative information about the concentration of the analyte in the sample. In other embodiments, the cartridge 2100 may be injection molded as two parts. The top part of the cartridge 2100 may include a sample well 2115 or sample port that has threading that allows a prep pod with a metering cap to be screwed into the cartridge sample well. According to certain embodiments, the metering cap may have a frangible film that prevents liquid from leaking out of the swab chamber when the prep pod device is inverted. When the user inverts the prep pod such that the metering cap is pointing down, and the user aligns the external “male” threading of the metering cap with the internal “female” threading of the cartridge, the frangible film in the metering cap may be punctured when the prep pod device is screwed all the way into the sample well of the cartridge.

As illustrated in FIG. 21(A), the cartridge 2100 may include a release prong 2120 that punctures the frangible film or seal on the metering cap, allowing liquid to flow down into the cartridge and onto the sample pad of the lateral flow test strip. In some embodiments the release prong 2120 may have capillary features that aid in wicking the liquid downward by capillary action to improve the flow consistency of liquid from the metering cap into the cartridge. As illustrated in FIG. 21(B), cartridge 2100 may include a top part 2125 and bottom part 2130. In some embodiments a mechanism may be included to provide feedback to the user that the prep pod device has been properly inserted into the cartridge.

The cartridge 2100 may also include a snapping feedback feature 2135 that makes an audible click that the user can hear or feel when the prep pod device has been screwed in properly and is fully engaged into the sample well of the cartridge. The snap feature may prevent the user from turning the prep pod device excessively, and prevent the user from turning the prep pod device in the reverse direction to remove the prep pod device from the cartridge. By preventing the user from excessively turning the prep pod device or reversing the turning direction and removing the prep pod from the cartridge once the snapping feedback feature is engaged, the metering cap may be maintained at the optimal position relative to the strip to allow consistent release of liquid from the metering cap without unwanted leaking or spilling of the liquid sample. Suitable snapping feedback features are further described with reference to feature 420.

According to certain embodiments, the lateral flow strip may be suspended off the bottom of the cartridge floor by the rib features 2155, to minimize leaking or spilling of liquid off the strip by wicking or capillary action, and to allow the strip to flex slightly when the top of the cartridge is pressed onto the bottom part. As the liquid flows into the strip, small rib features in the top part 2150 of the cartridge may apply pressure at key points on the strip to ensure consistent liquid flow in the strip, and to minimize overflow of excess liquid onto the membrane. Further, as illustrates in FIG. 21(C), the sample well 2115 may include threading 2140 configured to attach the lateral flow assay cartridge to the prep pod, and may include prong 2145, which corresponds to prong 2120 in FIG. 21(A).

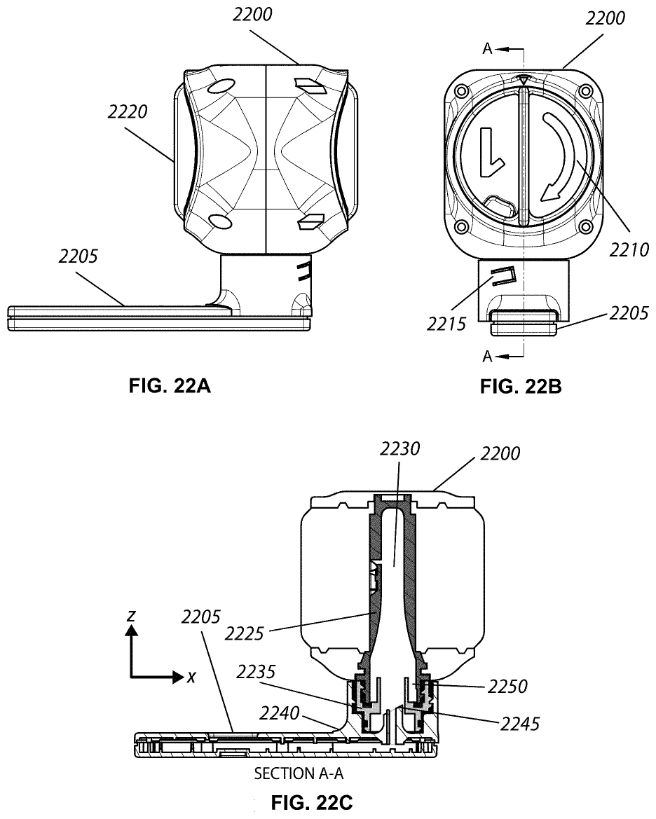

FIGS. 22(A)-22(C) illustrate various views of a metering prep pod mated with a lateral flow assay cartridge, according to certain embodiments. In particular, FIG. 22(A) illustrates a side of the prep pod mated with the lateral flow assay cartridge, FIG. 22(B) illustrates front view of the prep pod mated with the lateral flow assay cartridge, and FIG. 22(C) illustrates a cross-sectional view of the prep pod mated with the lateral flow assay cartridge along line A-A of FIG. 22(B), according to certain embodiments. As illustrated in FIG. 22(B), the mated assembly may include an inverted prep pod device 2200. According to certain embodiments, that the number one and the arrow 2210 on the dial used to release reagent from the blister into the swab chamber are inverted. In addition, a snapping feedback feature 2215 may be engaged when the prep pod device 2200 is fully inserted into the cartridge 2205. Suitable snapping feedback features are further described herein with reference to feature 420.

As illustrated in FIG. 22(A), the prep pod device 2200 may include a rib feature 2220 on the dial that the user grabs and turns to release reagent from the blister. In addition, FIG. 22(C) illustrates a cross-section of FIG. 22(A) to help illustrate how the volume metering mechanism works. For instance, FIG. 22(C) illustrates a dark gray area 2225 as the exterior wall of the main swab chamber, and an internal cavity 2230 of the swab chamber. According to certain embodiments, the swab may be inserted into the internal swab chamber cavity. However, in other embodiments, the swab may be excluded from this drawing for simplicity. The light gray area 2235 corresponds illustrates the metering cap, which has internal “female” threading that enables the cap to screw onto the external “male” threading of the swab chamber. The metering cap may also have external “male” threading that allows it to screw into the internal “female” threading on the sample port of the lateral flow test cartridge 2240.

As further illustrated in FIG. 22(C), the cartridge 2205 may include a release prong 2245, which punctures a frangible seal on the metering cap, allowing liquid to flow down along the z-axis into the cartridge and onto the test strip. The metering mechanism may work by partitioning some of the excess liquid into the annular space, indicated by 2250, that is created between the metering cap and the wall of the swab chamber when the cap is screwed onto the swab chamber and the prep pod device is inverted. According to certain embodiments, liquid that is partitioned into the center of the metering cap may be released into the cartridge when the cartridge prong punctures the frangible seal of the cap, while liquid in the annular space is retained within the cap. In certain embodiments, the volume of liquid that is released onto the strip may be decreased by increasing the volume of the annular space, and decreasing the volume in the center region of the cap. Likewise, the volume of liquid that is released from the swab chamber into the cartridge may be increased by decreasing the volume of the annular space and increasing the volume of the center region of the metering cap.

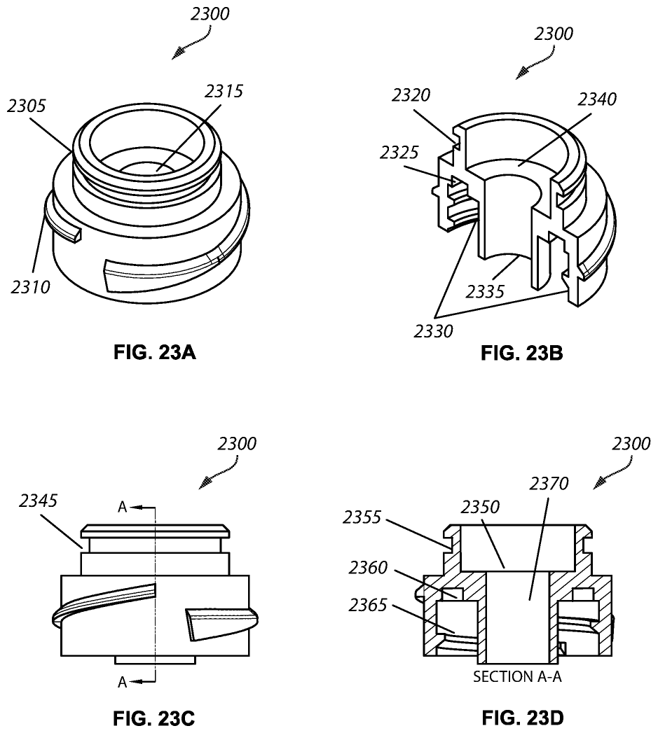

FIGS. 23(A)-23(D) illustrate different views of the metering cap, according to certain embodiments. In particular, FIG. 23(A) illustrates an isometric view of the metering cap, FIG. 23(B) illustrates a cutout of the metering cap of FIG. 23(A), FIG. 23(C) illustrates a side view of the metering cap of FIG. 23(A), and FIG. 23(D) illustrates a cross-sectional view of the metering cap along line A-A of FIG. 23(C), according to certain embodiments. All four views illustrate the metering cap 2300 oriented in the upward direction (i.e. not inverted). In some embodiments the metering cap 2300 may include a slot 2305, 2320, 2345, and 2355 for an external O-ring to ensure a tight seal when the prep pod and metering cap assembly is inverted and inserted into the cartridge sample well. This O-ring seal prevents undesirable leaking of the liquid sample off the test strip or into other unintended regions of the cartridge. In some embodiments the O-ring may be replaced with plastic-on-plastic seals to prevent leaking. In certain embodiments, the metering cap 2300 may have a frangible seal, such as a plastic film, that contains liquid sample when the prep pod device with a connected metering cap is inverted. The frangible seal may sit on the region indicated by 2315, 2340, and 2350, and may include liquid in the central chamber of the metering cap as indicated by 2335 and 2370.

According to certain embodiments, the metering cap 2300 may include internal threading 2365 that allows the cap to be screwed onto the swab chamber. The metering cap 2300 may also include a groove 2325 and 2360 for an internal O-ring that ensures a tight seal between the cap and the swab chamber to prevent undesired leaking. According to certain embodiments, the annular space 2330 between the central chamber 2335 and the outer wall of the cap 2300 may be partially occupied by the swab chamber wall when the cap is screwed onto the swab chamber. In other embodiments, the cap 2300 may be designed such that when the cap is screwed onto the swab chamber, some additional annular space adjacent to the central chamber is available to contain excess liquid when the device is inverted.

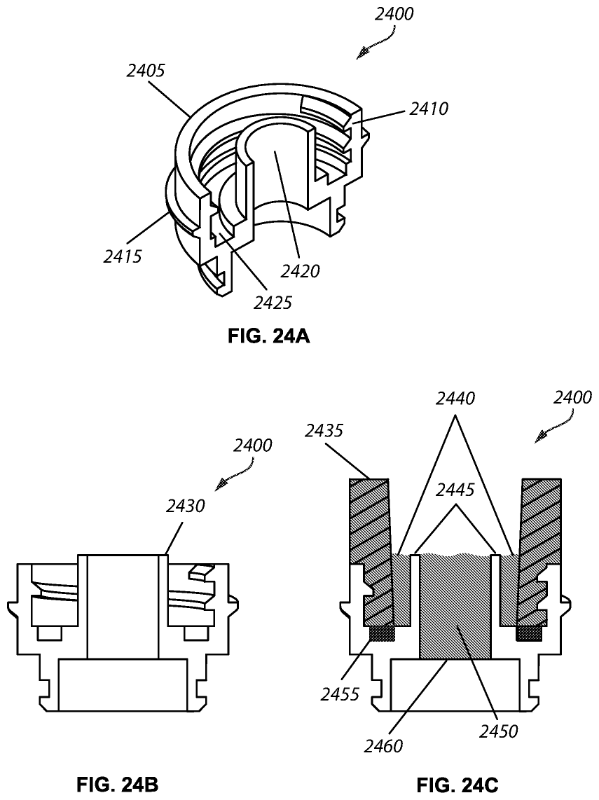

FIGS. 24(A)-24(C) illustrate different view of the metering cap in an inverted orientation, according to certain embodiments. In particular, FIG. 24(A) illustrates another cutout of the metering cap, FIG. 24(B) illustrates an inverted metering cap from a cross-section side view, and FIG. 24(C) illustrates the metering cap with an O-ring inserted, and the swab chamber module screwed into the metering cap, according to certain embodiments. As illustrated in FIGS. 24(A)-24(C), the metering cap 2400 may include an exterior wall 2405. The metering cap 2400 may also include an interior threading 2410 that enables the metering cap to be screwed onto the swab chamber. In addition, the metering cap 2400 may include an exterior threading 2415 that enables the cap and prep pod assembly to be screwed into the sample port or sample well of an assay device such as a lateral flow test cartridge. The metering cap 2400 may also include a slot or groove 2425 for an internal O-ring that helps maintain a good seal between the cap and the swab chamber when fully connected to prevent undesired leaking of liquid sample.

FIG. 24(B) illustrates the inverted 2430 metering cap 2400 from a cross-section side view. In addition, FIG. 24(C) illustrates the metering cap 2400 with the internal O-ring 2455 inserted, and the swab chamber 2435 screwed into the metering cap 2400. FIG. 24(C) does not illustrate the entire swab chamber, and instead is a cropped partial view of the device to better illustrate the key features of the interaction between the swab chamber and the metering cap. When the swab chamber and the metering cap are connected or assembled and the device is inverted, liquid sample flows down the walls of the swab chamber and partitions into two regions, a “central region” of the cap 2420, and an “annular space”. The central region of the metering cap may include the liquid sample 2450 that will be released onto the assay device when the frangible seal 2460 is punctured. When the swab chamber and metering cap are connected, an annular space is created between the swab chamber wall and the internal walls 2445 that enclose the central region of the metering cap. This annular space may be used to partition excess liquid sample 2440, and retain it inside the cap such that only a portion of the entire liquid sample is dispensed from the prep pod into an assay device. That is, the internal walls 2445 in the metering cap may act as a partition between liquid that will get dispensed onto the strip in the assay device, and the liquid that remains inside the metering cap and sample prep device. In certain embodiments, the design of the metering cap 2400 may be adjusted to alter the volumes of liquid that partition into the central region and the annular space, depending on the assay requirements and the desired sample volume to be dispensed onto an assay device.

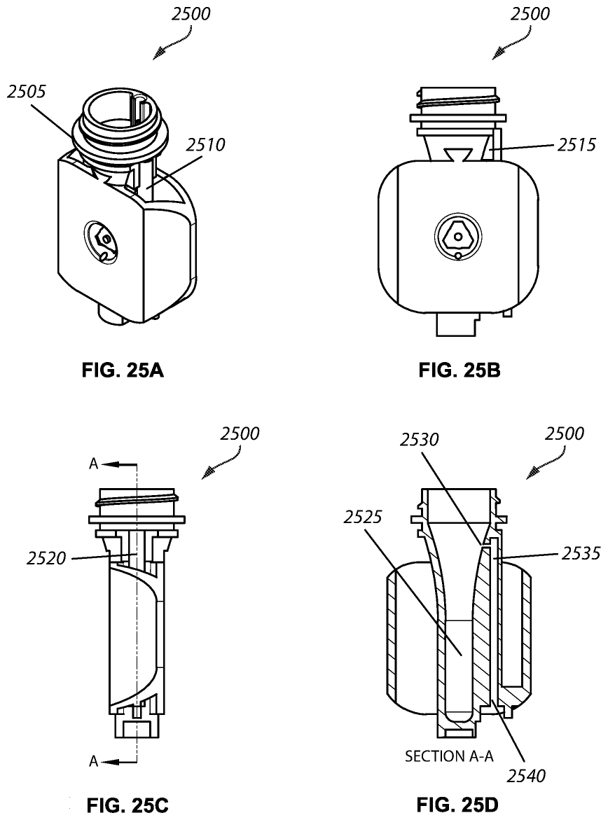

FIGS. 25(A)-25(D) illustrate different views of the swab chamber, according to certain embodiments. swab chamber module configured with a snorkel device or tube to relieve air pressure that may build up inside an enclosed swab chamber when reagents are released from the blisters into the swab chamber. As illustrated in FIG. 25(A), the swab chamber 2500 may include a neck 2505, and a pressure relief snorkel 2510. Further, FIG. 25(B) illustrates the exterior of the pressure relief snorkel 2515 near where it connects to the main swab chamber. In addition, FIG. 25(C) illustrates the exterior of the pressure relief snorkel 2520 from a side view, and FIG. 25(D) illustrates a cross-section of FIG. 25(B) to reveal the key internal features related to the pressure relief snorkel. For instance, the main swab chamber 2525 may have a small hole 2530 that connects to the main shaft of the pressure relief snorkel 2535. According to certain embodiments, excess air pressure built up in a swab chamber enclosed with a cap may flow through the small hole 2530 and the main shaft of the pressure relief snorkel and through the outlet of the pressure relief snorkel 2540 to equalize the internal swab chamber pressure with the external ambient air pressure. In certain embodiments, the pressure relief snorkel may provide an alternative to using valves and membranes to regulate internal air pressure and minimizes leaking of liquid outside of the swab chamber while maintaining an internal air pressure equal to the external ambient air pressure.

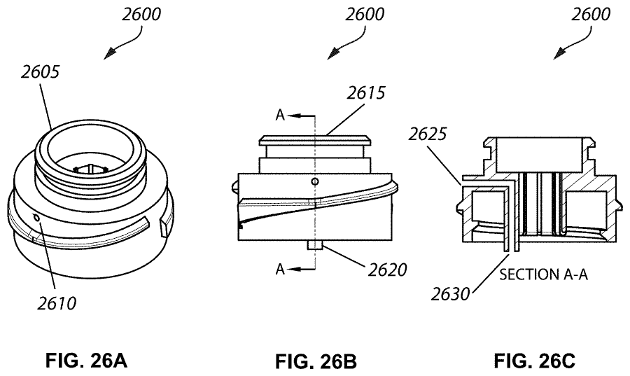

FIGS. 26(A)-26(C) illustrate a metering cap with a pressure relief snorkel or tube incorporated into the cap, according to certain embodiments. In particular, FIG. 26(A) illustrates the metering cap with a pressure relief snorkel or tube, FIG. 26(B) illustrates a side view of the metering cap with the pressure relief snorkel or tube, and FIG. 26(C) illustrates a cross-sectional view of the metering cap with the pressure relief snorkel or tube, according to certain embodiments. FIG. 26(A) illustrates an isometric view 2605 of the metering cap 2600. According to certain embodiments, the metering cap 2600 may include a snorkel that connects the inside of the swab chamber to the outside of the prep pod device, which allows the internal air pressure inside the swab chamber to equalize with the external ambient air pressure. The metering cap 2600 may also include outlet holes 2610 and 2625 of the pressure relief snorkel. Further, FIG. 26(B) illustrates a side view 3 of the metering cap 2600, where the snorkel 2620, and the inlet hole of the snorkel (2630 in the cross-section drawing) allows air to flow from inside the swab chamber to outside of the prep pod device. According to certain embodiments, the diameter of the snorkel hole may be small, including, for example, less than 1 millimeter to a few millimeters, to minimize the potential for liquid to flow out of the device through the snorkel unintentionally.

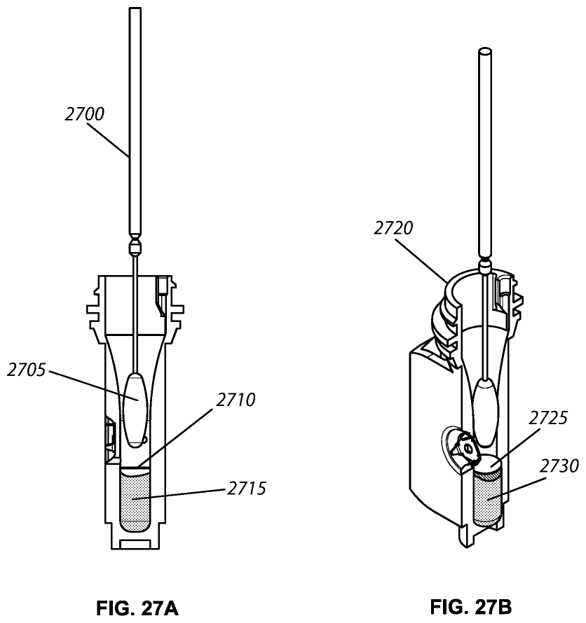

FIGS. 27(A) and 27(B) illustrate views of a cutaway of the swab chamber, according to certain embodiments. In particular, FIG. 27(A) illustrates a side view with a cutaway of the swab chamber module, and FIG. 27(B) illustrates an isometric view with a cutaway of the swab chamber module, according to certain embodiments. Both of these figures illustrate the swab chamber wherein a liquid reagent is stored inside the swab chamber and covered by a frangible seal. The swab 2700 may be inserted into the swab chamber 2720 and pressed all the way down to the bottom of the swab chamber to rupture the frangible seal 2710 and 2725, allowing the reagent 2715 and 2730 to cover the tip of the swab 2705. Storing reagent inside the swab chamber may be advantageous in various applications, for instance, if multiple reagents are needed to extract the analyte from the swab and storing one of the reagents inside the swab chamber allows the device to be more compact and require fewer blisters and buttons or dials.

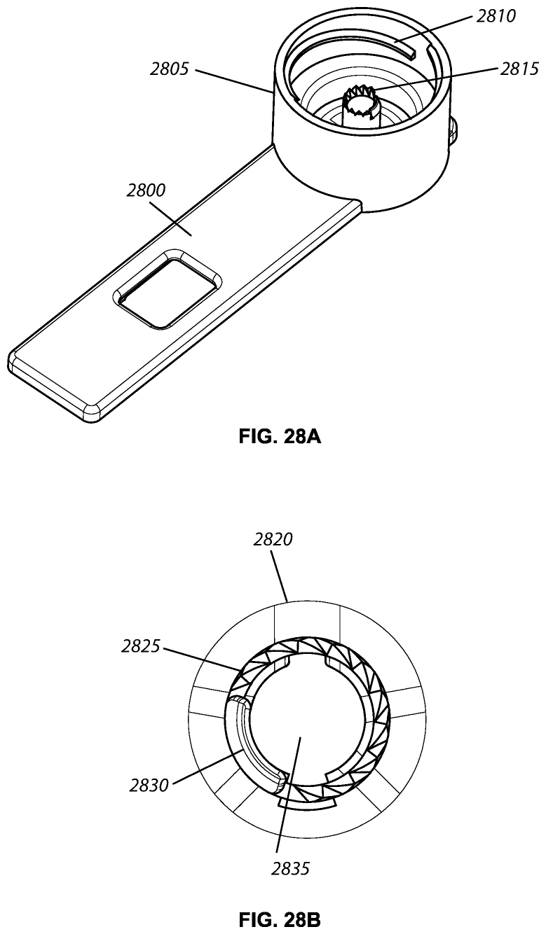

FIGS. 28(A) and 28(B) illustrate views of a lateral flow test cartridge, according to certain embodiments. In particular, FIG. 28(A) illustrates an isometric view of a lateral flow test cartridge, and FIG. 28(B) illustrates a zoomed in partial op view of a modified serrated sample release prong, according to certain embodiments. As illustrated in FIGS. 28(A) and 28(B), the lateral flow test cartridge may include a modified serrated sample release prong 2815. The lateral flow test cartridge may also include a top part 2800, and a sample well or sample port 2805. In certain embodiments, the sample well 2805 and cartridge may be used with a sample prep device that contains a metering cap that screws into the cartridge as illustrated in FIGS. 22-24 for controlled volume release of liquid sample from the sample prep device. As illustrated in FIG. 28(A), the lateral flow test cartridge may include threading 2810 in the sample well that allows the cap on the sample prep device to screw into the sample well. The lateral flow test cartridge may also include a serrated or saw-tooth sample release prong 2815 that cuts open the film on the cap of the sample prep device to allow the sample to flow out of the device onto the test strip in the lateral flow test cartridge.

According to certain embodiments, the release prong in FIGS. 28(A) and 28(B) differ from the release prong in FIG. 21 in that the saw-tooth or serrated features of the release prong in FIGS. 28(A) and 28(B) may cut or slice through the film in the cap of the sample prep device as the sample prep device is screwed into the sample well of the cartridge, rather than directly puncturing the film by pure force. FIG. 28(B) illustrates a partial top view 2820 of the sample well and serrated release prong. In certain embodiments, the lateral flow test cartridge may include the serrated saw-tooth blade-like features 2825 that cut through the film in the cap to allow the liquid sample to flow out of the sample prep device. According to certain embodiments, the serrated features may be designed to slice through the film in a circular pattern as the prep pod device is inserted into the cartridge in a rotational screwing motion. The serrated features may also be designed to have a gap in them 2830 such that the gap 2830 does not cut through the film. Without this gap 2830, the serrated features would cut a complete circle in the film in the cap, and this complete circular film cutout would tend block the flow of liquid through the channel 2835 in the cartridge and onto the sample pad of the test strip. By including the gap, the serrated features may cut a partial circle in the film, and this partial circular cutout of the film may get pushed up and out of the way when the sample prep device is fully inserted into the cartridge, thereby allowing unobstructed flow of liquid sample out of the sample chamber, through the channel 2835, and onto the test strip.

According to certain embodiments, the cutting mechanism may be analogous to a can opener cutting through the lid on a metal can, wherein cutting a complete circle causes the lid to fall down into the can, but leaving a small uncut point of attachment allows the lid to be opened up and out of the way, allowing the contents of the can to be poured out or easily accessed. The serrated prong of FIGS. 28(A) and 28(B) may be advantageous for sample prep devices that are inserted into a test cartridge by a rotational screwing motion, and in some embodiments where the material properties of the film in the cap of the sample prep device are more amenable to slicing through the film in a circular cutting motion rather than directly puncturing the film using a prong like the one shown in FIG. 21.

As described herein, certain embodiments lay out the design of a sample preparation device that allows a user to easily, accurately, and safely mix a collected sample with the required reagents for use in an analytical procedure or diagnostic test. The device does not require electrical power to function and does not need to pair with an external machine or controller device in order to work. All the necessary functions of sample preparation between insertion of a sample into the device, processing the sample, and addition of the processed sample to an assay, external device, or analytical procedure can be conducted by a lay user through use of this sample preparation device alone.

Extraction Chamber

According to certain embodiments, device may include several subsystems, the first of which is the sample preparation chamber or tube, which may also be called the sample chamber, sample tube, sample prep chamber, sample prep tube, or extraction chamber. In some embodiments where the sample prep device is intended to be used with swabs, the chamber may be called the swab chamber or swab tube. This chamber is the area in the device where the sample collected by the user will be inserted for processing and extraction of analytes. For swab samples, the chamber may be configured to accept a variety of swab types including, but not limited to, oral, buccal, nasal, mid-turbinate, perianal, pharyngeal, nasopharyngeal, lesional, genital, vaginal, urethral, meatal, penile, penile-meatal, throat, conjunctival, ocular, dermal, fecal, cutaneous, mucocutaneous, endocervical, anal, rectal, ear, or swabs of other biological or nonbiological surfaces. Non-swab-based samples may include liquid blood, venous blood, capillary blood, blood collected with a lancet, blood collected on a pad, urine, urine collected on a pad, feces, vomit, tears, puss, discharge, lesional discharge, hair, semen, mucus, sputum, saliva, interstitial fluid, bile, colloids, suspensions, solutions, gels, environmental samples, biological fluid, biological fluid collected on a pad, biological tissue, a biopsy sample, and others. In some embodiments, samples may be collected on various devices such as scoops, spoons, spatulas, probes, sticks, rods, swab-like devices, or other tools. Generally, the device may accept any sample type. The device can accept human samples, animal samples for veterinary use, and in some embodiments, the device may also accept environmental samples. According to certain embodiments, environmental samples may include swabs of surfaces, or solid or liquid environmental samples. For example, in some embodiments, an environmental sample may be motor oil from a vehicle or a small clump of soil. The device can be made compatible with all types of swabs including flocked swabs or flocked fiber swabs such as those sold by Puritan Medical Products (HydraFlock, PurFlock, and other product names) and COPAN Diagnostics (FLOQSwabs and other product names), polyurethane swabs, Rayon swabs, foam swabs, cotton swabs, cellulose fiber swabs, blended swab materials, polymer-based swabs, polyester swabs, nylon swabs, alginate polymer swabs and others. Swabs may be of various microstructures including flocked fiber, wound, tightly wound, knitted, reticulated, sprayed with strands of material or fibers, and others. The overall shape of the swab may be of varying geometries including round, narrow, oval, arrow shaped, pointed, beveled, tapered, cylindrical, or others.

Once the sample has been collected by the user, it may then be added to the sample preparation chamber. In some embodiments, this chamber may made to accept the tip of a swab, which may be broken off at a breakpoint on the swab stem during the sample preparation process. A notch feature such as the one shown in FIGS. 7(A), 7(B), and 8(A)-8(C) may be incorporated into the extraction chamber to aid in breaking off the stem of the swab, and to position the swab tip precisely within the extraction chamber. In other embodiments the swab may be inserted into the extraction chamber and the stem may be left intact so that the user may twirl, twist, rotate, or move the swab to aid in extraction of material from the swab tip.

For swab samples, the geometry of the sample chamber may be shaped like a cylindrical tube, with a diameter such that the annular distance between the swab tip and the sample chamber wall is no more than 10 mm, but preferably 0.1-5 mm, more preferably about 0.5 to about 1 mm. In some embodiments that use swab samples the swab tube may be designed so that its diameter is equal to the diameter of the swab tip, thereby allowing the swab tip to contact the walls of the sample chamber when the swab is inserted. In other embodiments the diameter of at least a portion of the swab tube can be designed to have a smaller diameter than the largest nominal diameter of the swab tip, thereby compressing or squeezing the swab tip when the swab is inserted into the chamber. This compression, squeezing, or rubbing of the swab on the walls of the swab chamber may aid in the release of material from the swab by mechanical or shear forces. In some embodiments the extraction chamber may have various features that aid in dispersing a sample or extracting material from a swab. Features that aid in extraction may include bristles, brushes, pins, needles, rigid fibers, flexible fibers, scrubbing features, textured patterns, bumps, spikes, spiral or corkscrew patterns, or other geometries that assist in scraping or removing material from the swab tip so that it disperses effectively and efficiently in the liquid reagent.

According to certain embodiments, exemplary sample chamber sizes can be configured to accept a volume of at least about 500 μL to no more than about 15 mL, preferably from about least about 500 μL to no more than about 10 mL, more preferably from at least about 500 μL to no more than about 5 mL.

In other embodiments, the chamber may be a large cup or bowl that can accept a relatively large volume of liquid sample such as urine or saliva in the range of 0.1 mL to 30 mL. This cup might also accept solid or semi-solid samples such as soil or feces. The exact geometry and internal volume of the sample chamber may depend on the sample type, the volume of the sample, and the volume of reagents that need to be used to process, extract, or prepare the sample.

In some embodiments, a buffer or reagent may be pre-loaded into the chamber, such that the sample is immediately immersed in the liquid reagent upon sample addition. In other embodiments the sample chamber may be pre-loaded with a solid powder, such as a mixture of salts and detergents or lyophilized proteins or biological compounds. Some assays may benefit from the use of enzymes during sample prep such as proteases, lipases, amylases, nucleases or others that can hydrolyze or break down peptides, proteins, lipids or fats, carbohydrates, nucleic acids, or other biological molecules. According to certain embodiments, enzymes may be lyophilized or freeze dried to remain stable in a dry formulation at room temperature for long periods of time from several weeks to multiple months. According to other embodiments, the sample prep device may be shelf-stable for at least 12-24 months at room temperature (e.g., 20-25° C.), but many enzymes would likely not remain stable for such long periods of time at room temperature when dispersed in a liquid, and must instead be lyophilized to meet this shelf-life requirement. According to certain embodiments, the sample prep device enables one to directly lyophilize enzymes and other biological compounds in the swab chamber. This configuration allows the lyophilized material to be reconstituted immediately before loading the sample into the chamber by first releasing a reconstitution buffer by turning a dial, pressing a button, or engaging a mechanical switch to dispense a controlled volume of the reconstitution buffer into the sample chamber to dissolve the lyophilized powder and reconstitute its components.

Cap and Sample Dispensing

According to certain embodiments, the sample prep chamber may be designed to allow a cap to be connected to the chamber to form a liquid-tight leak-proof seal. Sealing the sample inside the chamber may have several purposes including, for example, preventing contamination of the sample from the environment, preventing the sample from spilling, leaking, or falling out of the device, and to prevent the reagents that get dispensed into the sample chamber from leaking or splashing out of the device. Sealing the sample inside the chamber with the cap allows the user to manually shake or agitate the entire device to aid in sample extraction or processing without the risk of spilling the sample. The cap can also be connected onto the sample prep chamber by various mechanisms such as screwing, snapping, pressing, plugging, clicking, pushing, or otherwise fitting the cap onto the chamber.

In certain embodiments, the cap may perform several additional functions depending on the application of the sample prep device. In some embodiments after the sample is processed in the sample chamber, the cap may be removed allowing a user to collect a sample from the chamber with a pipette, dropper pipette, burette, disposable pipette, single-use pipette, or other liquid transferring mechanism. In some embodiments for solid samples or particularly viscous fluids, a portion of the sample in the chamber may be removed with a spatula or scoop. In some embodiments the cap can be removed from the chamber and the prepared or processed sample can be directly poured out of the chamber into an external device for analysis. Various cap designs can be incorporated to aid in the pouring of liquid or fluid samples out of the sample chamber such as the caps illustrated in FIGS. 18(A)-18(C) and FIG. 19. The cap can also contain air venting holes or tubes to facilitate the dispensing of liquid out of the device. In some embodiments the cap may include a dropper bottle similar to a bottle used to dispense eyedrops, as illustrated in FIGS. 20(A)-20(D). This “dropper cap” may include a flexible polymer-based material or rubber material that allows a user to squeeze the dropper cap to control the number of drops dispensed out of the cap. This type of “dropper cap” may be particularly useful when trying to dispense a processed sample into a lateral flow test cartridge or other point-of-care or over-the-counter at-home test. In some embodiments, a disposable fixed volume pipette may be included with the device to allow a user to collect a precise volume of processed sample from the sample chamber. In some embodiments, the pipette might be integrated into the cap itself, or provided separately.

According to certain embodiments, the cap may have a seal that can be removed or punctured to allow sample to flow out of the device. This seal may be an injection molded tab that is integral to the cap and that the user breaks off to allow liquid to flow out through the cap. In other embodiments, this seal may be a foil or plastic seal that the user removes. In further embodiments, this seal might be metal foil, metalized foil, or plastic film that is ruptured by an external feature such as a lancet or prong. In some embodiments, this external lancet may be part of a lateral flow cartridge or rapid diagnostic test cartridge or cassette that the sample preparation device mates with as the final step of the sample preparation process. In this case, the user would mate the sample prep device onto a lateral flow cartridge via the cap, and a lancet or prong contained in that cartridge would puncture the seal, allowing liquid to exit the sample preparation device and flow onto the lateral flow strip, as illustrated in FIGS. 22(A)-22(C).

According to certain embodiments, the cap may contain features or materials used for metering or controlling the sample volume that exits the device. This could be an absorbent material that traps a specific volume of prepared sample, so that a smaller volume of the prepared sample flows out of the device. This metering may be critical when the sample preparation process necessitates a large volume of sample, reagents, or both, but the final assay can only accept a significantly smaller volume of the prepared sample. In some embodiments the cap may contain features that allow the liquid sample to be metered when the entire sample prep device is inverted and the liquid flows down the chamber into the cap, as illustrated in FIGS. 22(A)-22(C) to FIGS. 24(A)-24(C). For example, the cap may partition some fraction of excess liquid into zones, regions, or features such that the excess liquid will remain inside the device and not flow onto the test strip or other assay device when the foil or film in the cap is punctured by a lancet or prong.

In some embodiments, the cap may include a rubber septum seal that may be punctured with a needle, such as part of a syringe or fluidics system, to allow removal of the processed sample through the needle or syringe without opening the cap. When the needle or syringe is withdrawn through the rubber septum, the flexible rubber may self-seal the hole, creating an air-tight leak-resistant barrier. A rubber septum seal may be particularly advantageous in applications where it is essential to minimize the risk of contaminating the local environment with the sample, such as when handling particularly infectious samples such as respiratory pathogens collected on nasal swabs or gastrointestinal pathogens collected on fecal swabs. In other embodiments a septum seal may be used to minimize the likelihood that the sample gets contaminated by the environment. For example, in applications where the sample prep device is used for mail-in diagnostics, genomics, or proteomics, it is imperative that the sample does not get contaminated with DNA, RNA, proteins, or other material from the local environment when extracting the sample from the device for analysis in some external instrument such as a DNA sequencer. The use of a rubber septum is particularly advantageous for improving workflow efficiency in a lab that processes mail-in samples that use the sample prep device. Instead of needing complex robotics that can remove the cap to gain access to the sample chamber, an automated or semi-automated machine can easily insert a syringe through the rubber septum to withdraw the sample for analysis.

In certain embodiments, such as for use with a lateral flow assay cartridge, a sample prep pod device can be configured to release a volume suitable for use in a lateral flow assay. Typical lateral flow assays work with a sample volume of from about 0.1 mL to about 5 mL, more preferably from about 0.15 mL to about 2 mL, yet more preferably from about 0.2 mL to about 1 mL, yet even more preferably from about 0.25 mL to about 0.75 mL, most preferably from about 0.25 mL to about 0.5 mL. In some cases, as described herein, the total volume of reagent buffers introduced into the sample chamber is significantly greater than the volume of reagent to be dispensed into lateral flow assay cartridge. In some, cases the excess volume is diverted and/or partitioned, e.g., using a metering cap as described herein. In other cases, the user can meter the released volume manually. For example, a user can squeeze a specified number of drops from a cap configured to introduce a suitable volume into an assay device (e.g., lateral flow cartridge). In some embodiments, sample and reagents may be between 100 microliters to 5 milliliters. In other embodiments, the total liquid volume in the sample chamber after addition of both the sample and reagents may be between 500 microliters (4) and 2 milliliters (mL). In some embodiments where a liquid sample is added to the sample chamber, the sample volume may be between 1 microliter (4) to 2 milliliters (mL). In embodiments that use a swab as the sample, at least 100 microliters of liquid may be used to extract an analyte from the swab or to produce a “sample extract solution.” In some embodiments where a small volume of a liquid sample is added to the sample chamber, that volume may be added with a pipette.

Reagent Storage Vessel

The reagents required by the assay may generally be stored surrounding the central sample preparation tube or sample chamber. This arrangement allows the reagents to be dispensed into the sample chamber consistently by use of simple mechanisms and helps ensure that the overall sample prep device is compact. In some embodiments, the reagents may be stored in some type of blister packaging, such as illustrated in FIGS. 1, 3, FIGS. 1, 3, 9, and 10(A)-10(D). For blister-based reagent storage vessels, the blister (excluding the liquid reagent) comprises two main materials, a cavity side and a lidding side, as illustrated in the cross-section schematic in FIG. 10(D). According to certain embodiments, the cavity side of the blister has been formed into a shape such that it can be filled with a liquid reagent. In certain embodiments, the lidding side may be completely flat and is sealed onto the cavity side of the blister, completely enclosing the liquid reagents in an air-tight hermetic seal. In other embodiments, the cavity side of the blister may be modified to produce a variety of different shapes and geometries for containing the liquid reagent.

Materials and Manufacturing Methods:

According to certain embodiments, the manufacturing technique used to prepare the cavity may depend on the type of material for the blister. Manufacturing methods may include cold forming, thermoforming, vacuum forming, and other mechanical forming methods. Foil-based laminates or films that contain a metal layer may be cold formed, a process used in the pharmaceutical industry for making blisters that contain pills or drugs. In certain embodiments, foil-based blisters may be used when a high moisture barrier or oxygen barrier is required, and there are no concerns related to chemical compatibility between the contained reagent and the metal foil. The structure of a foil laminate may combine a metal foil (e.g., aluminum) with a sealing layer. The sealing layer in foil-based laminates may contain one or more layers of a polymer-based film that enables the laminate structure to be heat sealed or ultrasonically sealed, thereby allowing the lidding to be sealed onto the cavity side of the blister.

In some embodiments with foil-laminates, it may be necessary for there to be two layers of different types of polymers, such as polyvinyl chloride (PVC) and nylon to promote good adhesion of the polymer film to the metal foil while also enabling good heat sealing properties of the whole laminate film structure. According to certain embodiments, a foil-based laminate may need some type of thermoplastic polymer layer so that it can be heat sealed or ultrasonically welded onto the cavity side of the blister. Polymer layers may include, but not limited to, acrylonitrile butadiene styrene (ABS), acrylic, polycarbonate, PVC, Aclar, polyester, polyethylene, polystyrene, polypropylene, polyvinylidene dichloride (PVDC), and heat sealable, thermoplastic, or thermoformable polymers. Some foil laminates completely embed the metal foil between two polymer layers such that the metal foil is not exposed to air. For applications where reagent is released from the blister by puncturing the blister with a lance, a foil laminate structure where the metal foil is completely embedded within multiple polymer layers may be advantageous to minimize contact between the metal foil and the liquid reagent as the liquid flows out of the punctured blister. This type of foil laminate may be particularly advantageous when the reagent is something that is highly reactive towards the metal foil, such as sodium hydroxide which reacts with aluminum foil. Blisters made from foil laminate materials may be manufactured in a form, fill, seal process where a blister cavity is first cold formed using either a die or positive air pressure, then the reagent is added to the cavity, then the lidding layer may be sealed to the cavity side using heat or ultrasonic welding.

In some embodiments the blister material may have no metal foil and may be purely polymer-based. Polymer-based blister materials may be necessary when using reagents that are highly reactive towards metal foils. Generally, any of the heat sealable, ultrasonically sealable, thermoformable polymer materials described previously that can be used in a foil-laminate structure can also be used as a purely polymer-based blister material or in a multi-layered polymer laminate material. In some embodiments, a polymer-based blister may combine a multi-layered laminate of different polymers to enable good sealing properties while also creating an optimum air and oxygen barrier to minimize losses of liquid from the blister over time from evaporation and diffusion through the polymer films. Specific examples of multilayer polymer-laminates that are usable for making blisters for the sample prep device may include the Tekni-Films™ series of products from Tekniplex®. For polymer-based blisters lacking a metal foil layer, the cavity for the blister is typically manufactured using thermoforming, sometimes with the aid of vacuum, positive pressure, or plug assist, although cold forming may also be used. The reagent may then be added into the cavity, and then the lidding side may be sealed either using heat, ultrasonic welding, or laser welding. The blister material choice and geometry may be critical to allow ease of manufacture, and high integrity of the seal.

According to certain embodiments, the sample prep device may not be limited to storing reagents in blisters, and a variety of other mechanisms may be available for reagent storage. Alternative reagent storage vessels may include glass ampoules that are crushed or broken when the user turns a dial, presses a button, or engages another mechanical switch to trigger reagent release. Glass ampoules are used in the pharmaceutical industry and are adaptable for use in the sample prep devices and methods of certain embodiments. Certain blisters may include a cavity and a lidding that have been sealed together enclosing the reagent, but other blister types can be used including frangible seal blisters. In certain embodiments, reagents can be stored in sealed pouches like those used for storing condiments like ketchup and mustard. Reagents may also be stored in injection molded plastic or polymer-based containers or vessels that can be triggered to release by the user engaging a mechanical release mechanism such as a blister, dial, or switch.

Fluid Release from Reagent Storage Vessel

For embodiments of the sample prep device that use blisters that include both a cavity and a flat lidding to contain the reagents, an approach for releasing reagent from the blister may be to incorporate a device such as a lance or lancet, such as the device illustrated in FIGS. 11(A)-11(C), that punctures the lidding layer allowing liquid to flow out through the punctured hole. As described herein, the term cavity may have two different definitions depending on the context. For example, the term cavity may refer to the “blister cavity” which is the indentation in a laminate material in a blister that is designed to hold liquid, and onto which the lidding layer is sealed to enclose the liquid (e.g., Feature 1010 in FIG. 10(D)). The term cavity may also refer to the “lance cavity” which is located in the external part of the sample chamber of the sample prep device and contains a lance or other features designed to puncture the lidding side of the blister and allow liquid to flow out of the blister and into the sample chamber, as illustrated in FIGS. 6(A)-6(D), 7(A), and 7(B). Generally, the standard design for puncturing the lidding side of a blister may require that the lance or other puncturing features sit in a small lance cavity in the sample prep device. When the blister is mounted onto the mounting face it may completely covers the lance cavity, as illustrated in FIGS. 6(A)-6(D), 14(A), and 14(B).

According to certain embodiments, the lance cavity may have a few important functions including positioning the prongs or tips of the lance (Feature 1110 in FIG. 11(A)) at an optimal position relative to the lidding side of the blister so that the blister is not unintentionally punctured when not in use, while also allowing the lance to puncture the lidding with relative ease when the user deliberately engages a mechanical feature such as a dial, button, or switch to release the reagent. The lance cavity may also have a small hole or channel (Feature 630 in FIG. 6(B)) that allows liquid to flow out of the blister into the sample preparation chamber when the blister is punctured. In certain embodiments, the lance may be stationary or at a fixed position in the lance cavity, and the blister may be punctured by the lance when a mechanical force applied to the blister causes the lidding to swell or expand towards the lance by a sufficient distance such that the lance punctures the lidding. Thus, according to certain embodiments, the prongs or tips of the lance may be close to the lidding side of the blister, generally within 1-2 mm, although in some embodiments, the lance and lidding may be in direct contact (0 mm gap) or less than 1 mm apart (e.g., 50 μm to 1000 μm or 0 μm to 50 μm).

According to certain embodiments, the width of the lance cavity may be sufficiently wide so that the lidding side of the blister can swell or expand a large enough distance to cause the lance to puncture the lidding. In certain embodiments, the lance cavity may be 10-30 mm wide depending on the application. According to certain embodiments, the device may be used by hand by a lay user, so the design of the lance, blisters, and lance cavity may allow the lance to be punctured easily using the forces generated by a user pressing a button, turning a dial, or engaging another mechanical feature with their hands. According to other embodiments, the geometry of the blister and lance cavity may also prevent the blister material from self-sealing over the lance itself after puncturing, which may then require a greater force to evacuate all the reagent from the blister.

The exact geometry and design of the features used for puncturing the blister may vary depending on the blister material being punctured. In some embodiments these puncturing features can be made from the same material as the sample preparation tube itself such as an injection moldable plastic. For plastic lances, the lance feature may be built into the mold used for injection molding the sample chamber component of the sample prep device. In other embodiments where a sharper puncturing feature is required, a metal lancet can be used. This lancet could be a cut or stamped sheet metal part, or it could be a solid piece of metal ground into a point. In certain embodiments, stainless steel may be used for sheet metal lances, and 304 and 316 stainless steel have both been demonstrated to have excellent performance as sheet metal lances in the sample prep device. For metal lances, the lancet may be co-molded with the device itself or assembled into the lance cavity afterwards. This assembly may involve either heat staking the lance onto the device or using an adhesive to fasten the lance to the device.

In some embodiments it may be advantageous for the blister to be as short and squat as possible, with the sides of the blister having considerable draft so that the blister does not fold in on itself when compressed, trapping reagent in the folds of the material. For example, the cross section of the blister in FIG. 10(D) illustrates that the blister is significantly wider than it is tall and the side walls of the cavity have significant draft such that the internal angle that the side wall of the cavity makes with respect to the lidding is less than 90°. This kind of blister design may ensure a small coefficient of variation or standard deviation of the volume released from multiple identical blisters.

According to certain embodiments, the blister may be held onto the mounting face of the sample chamber by a variety of mechanisms. In some embodiments the blister may be heat sealed, laser welded, thermally sealed, or ultrasonically sealed onto the mounting face. In other embodiments, a thin dual-sided adhesive film may be laminated onto the lidding of the blister and the mounting face of the swab chamber. If an adhesive is used for blister mounting, the adhesive film may have a cutout such that the lidding side of the blister that overlaps with the lance cavity is not covered with adhesive, and only the sides of the blister that overlap with the mounting face region may be covered with adhesive. Various dual-sided adhesive films or adhesive tapes are readily available for this application, and can be cut to a variety of geometries depending on the design of the blister and the mounting face of the sample chamber. In all embodiments it is important that the blister is firmly sealed onto the mounting face. If the seal quality is bad, when the lance punctures the lidding some of the liquid reagent may leak out through the seal area instead of flowing through the hole in the lance cavity into the swab chamber. For some applications where an adhesive is used for laminating the blister onto the mounting face of the swab chamber it is important to verify that the adhesive is chemically compatible with the reagents in the blister.

Modulation of Pressure

When the sample prep device requires the use of hazardous reagents for extracting material from the swab or sample such as sodium hydroxide for chemical lysis, it is preferable in some embodiments to dispense the reagents into the swab chamber in a manner that eliminates the possibility that the hazardous reagent could spill outside of the device and harm the user. For instance, according to certain embodiments, the user may first insert the swab into the swab chamber, break off the stem of the swab at a defined breakpoint in the swab stem, preferably with the assistance of a notch feature built into the sample prep device, and then enclose the sample collection end of the swab inside the swab chamber using a cap that provides a leak-proof liquid-tight seal. Once the swab tip or sample collection end of the swab is sealed inside the swab chamber, the user may turn a dial, press a button, or engage another mechanical switch or feature to release the hazardous reagent into the swab chamber for extraction of material from the swab or sample.

Dispensing liquid reagents into a sealed swab chamber can result in undesirable pressure buildup if the device is not designed to incorporate a feature or component to modulate or relieve the internal pressure. For example, a sample prep device may have an empty internal swab chamber volume ranging from 0.5 mL to about 5 mL. Dispensing hundreds of microliters to a few milliliters of liquid reagent into the swab chamber may compress the air inside the chamber if the chamber is tightly sealed and there is no mechanism to allow pressure relief.

According to certain embodiments, various mechanisms can be incorporated into the swab chamber to relieve air pressure that may build up when dispensing reagents into the swab chamber. For instance, in certain embodiments, a hydrophobic or oleophobic porous membrane that is air-permeable but has low permeability to liquids, particularly aqueous media, can be placed over an outlet hole that connects to the swab chamber, such as the holes shown in FIGS. 7(A), 7(B), and 15. Thus, as liquid flows into the swab chamber and displaces air, rather than compressing the air into a smaller volume thereby building up pressure, the excess pressure can equalize with the ambient air pressure by allowing air to flow out of the swab chamber through the porous membrane. The air-permeable liquid-impermeable membrane would also prevent undesirable leaking of liquid out of the swab chamber.

According to certain embodiments, various membranes may be suitable for this application including LTI Atlanta's polytetrafluoroethylene (PTFE) membranes and A-series acrylic copolymer membranes. These membranes can easily be placed over a venting outlet hole using adhesive that resists chemical degradation and does not interfere with the sample extraction or assay. In other embodiments, a snorkel feature such as the one illustrated in FIGS. 25(A)-(D) may be molded into the swab chamber such that air can easily escape from the chamber. However, in certain embodiments, the position of the snorkel may be designed such that it is unlikely for liquid to flow into the snorkel and out of the swab chamber. In other embodiments a small outlet hole from the swab chamber can be plugged or fitted with a filter, such as the filters used in disposable pipette tips or filter tips for an air cushion pipette, thereby allowing air to pass through the filter and relieve air pressure in the chamber while also preventing any liquids or aerosols from spilling through the venting hole of the swab chamber. In other embodiments the cap used to enclose the swab chamber may contain a pressure venting tube or pressure relief tube built into the cap, as is illustrated in FIGS. 26(A)-26(C). With a venting cap there is no need to include a venting outlet hole in the sample chamber as the cap itself will provide the needed pressure relief

Enclosure

According to certain embodiments, the enclosure of the sample prep device illustrated in FIGS. 1 and 3 essentially encloses all the critical internal components of the sample preparation device including the sample chamber and blisters. The enclosure helps protect the blisters from being physically damaged and helps ensure the blisters do not get accidentally punctured. According to certain embodiments, the enclosure may have features that aid in assembling all the components into a single easy-to-use device. The enclosure may also have openings for buttons as illustrated in FIG. 1 or dials as illustrated in FIG. 3. In embodiments where a dial mechanism is used for blister puncturing, the enclosure may have threading or screw features that allow the dial to be turned or rotated to apply a force on the blisters to puncture the blisters and release reagents into the swab chamber. The enclosure may further have features that provide feedback to the user that the dials have been completely turned or that the buttons have been fully pressed or engaged. The enclosure also may include an opening for the top of the sample chamber allowing a cap to be placed over the opening of the sample chamber. In addition, the enclosure may have features that aid the user in gripping the entire sample prep device in one hand, such as grooves, cutaways, ridges, or contours shaped to complement the grip of a human hand.

According to certain embodiments, the overall dimensions of the sample prep device may be designed such that the user can comfortably hold the device in one hand and operate the dials or buttons with the other hand. Various form factors for the enclosure and sample prep device are possible, but typically the overall sample prep device can fit in the palm of an average adult hand (e.g., about the size of a standard tennis ball (diameter of about 6-7 cm), baseball (diameter of about 70-80 mm), or smaller).

In an exemplary sample prep device shown in FIG. 3, the enclosure on a completely assembled device can be approximately 50 mm wide and 50 mm deep. In some embodiments, the device can be readily modified such that the width and depth of the enclosure are both within 40-60 mm. In an exemplary embodiment, the total height of the sample prep device of FIG. 3 can be about 75 mm including the metering cap and about 58 mm excluding the cap. The cap is preferably in the range of 20-30 mm in diameter. In an exemplary embodiment, the diameter for the dials used for puncturing the blisters is in the range of from about 35 mm to about 50 mm, and preferably about 42 mm. The ridge that runs down the center of the dial that is used as a gripping feature to better enable the user to turn the dial can be preferably about 3-3.5 mm thick, but can readily be about 2 mm to about 5 mm thick, or about 2 mm to about 7.5 mm thick, or more, depending on the application. In other embodiments where it is more desirable to have a small form factor the sample prep device and enclosure may be about the width of a wide highlighter, marker or pen (e.g., 1 inch in diameter). In certain embodiments, however, the width of the sample prep device may be in the range of about 2 inches to no more than 5 inches.

Ergonomics and Human Factors

According to certain embodiments, the sample prep device may be designed to make the user experience as straightforward, simple, intuitive, and pleasant as possible. As described herein, it is important to make users feel that they have executed each step properly so there are no concerns about inaccurate test results due to a lack of confidence in sample preparation. In certain embodiments, any kind of action required of the user such as turning a dial, pressing a button, engaging a switch, screwing on a cap, or mating or plugging the sample prep device into a secondary assay device may be designed to provide some form of feedback to the user. According to certain embodiments, feedback may include an audible click or snap sound, or a physical sensation that the user may feel such as the parts snapping or clicking in place at which point the parts or features are no longer capable of being pressed, turned, or moved further. In some embodiments feedback may be in the form of visual symbols, signs, or patterns. For example, a colored dot may appear after a user fully engages a button or dial.

In some embodiments, when multiple different reagents must be dispensed in a specific order, for example first adding lysis buffer, then adding neutralization buffer, the sample prep device may include features that prevent the user from pressing the buttons or turning the dials out of the correct order. For example, the device may incorporate a feature such as a mechanical switch or mechanism that blocks a secondary dial or button from being turned or pressed until the first dial or button is fully engaged by the user. In other embodiments a sticker may be placed over the second or third buttons or dials to make users more acutely aware that they must engage the first dial or button before engaging the other buttons or dials. When the user has completed the initial steps first and is ready to turn a subsequent dial or button, they must first peel away the sticker to gain access to the button or dial. In other embodiments each button or dial is numbered with the order in which the dials or buttons must be turned or pressed. For example, FIG. 15 illustrates a large number “one” to indicate to the user that this dial must be turned first.

According to certain embodiments, the sample prep device may be designed to have as few buttons as reasonably possible, so the user has fewer steps to think about and perform. In embodiments where multiple chemical species or reagents must be used for sample preparation but these components are unstable when mixed together in a single liquid solution and stored for several months at room temperature, the sample prep device can incorporate the reagents into several different blisters that can simultaneously release these reagents by the user pressing only one button. Considerable success has been achieved with this approach, and the sample prep device can easily dispense two liquids simultaneously by turning or pushing one dial or button.

Diagnostic Tests and Analytical Methods

Certain embodiments may provide analytical methods, diagnostic testing methods, or other methods that may be used with samples extracted from the sample preparation device may include, without limitation, the following: polymerase chain reaction (PCR), nucleic acid amplification test (NAAT), reverse transcriptase PCR (RT-PCR), real time PCR, quantitative PCR (qPCR), viability PCR, isothermal nucleic acid amplification, loop-mediated isothermal amplification (LAMP), recombinase polymerase amplification (RPA), helicase-dependent amplification (HDA), enzyme-linked immunosorbent assay (ELISA), direct ELISA, indirect ELISA, competitive ELISA, antigen immobilization ELISA, antigen immobilization assay, binding assays, ligand binding assay, receptor-ligand binding assay, cytometry, flow cytometry, microarrays, DNA microarrays, DNA chip, biochip, microfluidics, millifluidics, nanofluidics, electrochemical analysis, electrophoresis, gel electrophoresis, polyacrylamide gel electrophoresis (PAGE), sodium dodecyl sulfate polyacrylamide gel electrophoresis (SDS-PAGE), two-dimensional gel electrophoresis, dielectrophoresis, Bradford assay, bicinchoninic acid (BCA) assay, micro BCA assay, Smith assay, immunoblot, quantitative dot blot analysis, Western blot, Southern blot, Northern blot, Eastern blot, Far-Eastern blot, Southwestern blot, mass spectrometry, spectrophotometric assay, fluorescence spectroscopy, fluorescence detection, upconversion, upconversion fluorescence, upconversion luminescence, upconversion phosphorescence, cell culture or other culture techniques, antibiotic resistance culture or cultivation, antibiotic susceptibility testing, giant magnetoresistance (GMR), staining, silver staining, Gram staining, immunofluorescence, immunofluorescence staining, fluorescence microscopy, immunofluorescence microscopy, immunofixation electrophoresis, immunofixation, complement-fixation, urinalysis, mass spectrometry, sequencing, Sanger sequencing, nucleic acid sequencing, next generation sequencing, nanopore sequencing, protein sequencing, Edman sequencing, isoelectric focusing, imaged capillary isoelectric focusing, interferometry, bio-layer interferometry, lateral flow assay (LFA), competitive LFA, flow through assay, rapid diagnostic test (RDT), flotation assay, micro-bead assay, label-free assay, label-free detection, immunomagnetic assay, immunomagnetic separation, multiplex bead assay, competitive assay, competitive immunoassay, immunoassay, sandwich immunoassay, precipitation, immunoprecipitation, fluorescence in situ hybridization (FISH), hybridization, haplotype analysis, karyotype analysis, chromosome analysis, complementary strand detection, single molecule detection, single-molecule super-resolution imaging, super-resolution microscopy, optical microscopy, microscopic analysis, stochastic optical reconstruction microscopy (STORM), single molecule localization microscopy (SMLM), structured illumination microscopy (SIM) photoactivated localization microscopy (PALM), ground state depletion individual molecule return (GSDIM), stimulated emission depletion (STED) microscopy, ultra violet-visible (UV-Vis) spectroscopy, densitometry, absorbance, spectrophotometry, fluorescence anisotropy, time-resolved fluorescence, time-gated fluorescence, time-gated phosphorescence, time-gated luminescence, chemiluminescence, bioluminescence, Raman spectroscopy, surface enhanced Raman spectroscopy, surface enhanced Raman scattering, Coulter counter, cell counter, cell count, cell cycle phase analysis, complete blood count analysis, leukocyte differential count, hematology analysis, hemocytometer analysis, coagulation test, aggregation test, platelet aggregation test, agglutination test, serology, forensic serology, metabolic analysis, small molecule analysis, macromolecule analysis, serological methods, serological analysis, cell differentiation, cell morphology analysis, automated cell analysis, single cell analysis, single cell isolation, single cell genomics, single cell proteomics, single cell sequencing, therapeutic drug monitoring, fecal analysis, electrolyte analysis, elemental analysis, total protein analysis, microbiome proteomics, microbiome analysis, microbiome sequencing, titration, viral titration or viral titer, viral load, viral concentration analysis, cell concentration analysis, cell titration, optical density, scanning electron microscopy (SEM), transmission electron microscopy (TEM), atomic force microscopy (AFM), scanning tunneling microscopy, dynamic light scattering (DLS), phase analysis light scattering (PALS), electrophoretic light scattering (ELS), nanoparticle tracking analysis (NTA), resonant mass measurement (RMM), microchannel resonator size analysis, centrifuge particle size analysis, zeta potential analysis or determination, resistive pulse sensing, tunable resistive pulse sensing, single-particle size analysis, laser diffraction analysis, energy dispersive x-ray spectroscopy (EDS or EDX), inductively coupled plasma mass spectrometry (ICP-MS), inductively coupled plasma optical emission spectrometry (ICP-OES), inductively coupled plasma atomic emission spectroscopy (ICP-AES), electron microprobe analysis, wavelength dispersive x-ray spectroscopy, x-ray fluorescence (XRF), atomic absorption spectroscopy (AAS), thermal ionization mass spectrometry (TIMS), particle-induced x-ray emission, glow discharge mass spectrometry, Rutherford backscattering spectrometry (RBS), laser-induced breakdown spectroscopy (LIBS), infrared spectroscopy, Fourier transform infrared spectroscopy (FTIR), attenuated total reflectance (ATR), FTIR-ATR, evanescent wave sensor, x-ray photoelectron spectroscopy (XPS), Auger electron spectroscopy (AES), electron energy loss spectroscopy (EELS), atom probe tomography (ATM), secondary ion mass spectrometry (SIMS), total reflection x-ray fluorescence (TXRF), sum frequency generation (SFG) analysis, second harmonic generation (SHG) analysis, x-ray diffraction, thermogravimetric analysis (TGA), calorimetry, nuclear magnetic resonance (NMR), gel permeation chromatography (GPC), x-ray scattering, small angle x-ray scattering (SAXS), wide-angle x-ray scattering (WAXS), small angle neutron scattering (SANS), differential scanning calorimetry (DSC), absorption spectroscopy, fluorescence resonance energy transfer (FRET), gas chromatography (GC), mass spectrometry (MS), GC-MS, refractometry, low energy electron induced x-ray emission spectrometry, Mossbauer spectroscopy, thermoluminescence excitation spectroscopy, mid-infrared spectroscopy, thin-layer chromatography, tangential flow filtration (TFF), size exclusion chromatography (SEC), field flow fractionation, high-performance liquid chromatography (HPLC), fast protein liquid chromatography (FPLC), ion exchange chromatography, affinity chromatography matrix-assisted laser desorption ionization time of flight mass spectrometry (MALDI-TOF), surface plasmon resonance (SPR), SPR immunoassay, multi-parametric SPR, catalytic activity assay, chemical kinetics analysis, kinetic assay, enzyme assay, depletion assay, signal depletion assay, crystallography, x-ray crystallography, aqueous 2-phase separation, multiphase separation, liquid-liquid extraction, electrical impedance, optical trapping, optical tweezers, optical trapping virometry, sedimentation, ultracentrifugation, cell sorting, differential centrifugal sedimentation, centrifugation, filtration, viral plaque assay, immunoplaque assay, viral identification, infectivity assay, viral flow cytometry, hemagglutination assay, tissue culture, median tissue culture infectious dose, lysis, ultrasonication, shotgun proteomics, bottom-up proteomics, top-down proteomics, activity-based proteomics, protein purification, protein separation, nucleic acid purification, mRNA analysis, telomere length assay, label-free detection, electrospray ionization, reversed-phase chromatography, distillation, microscale distillation, gravimetric separation, evaporation, biosensor, electrochemical biosensor, electronic biosensor, field-effect transistor-based biosensor (Bio-FET), ADP assay, ATP assay, endotoxin assay, pyrogen assay, limulus amebocyte lysate (LAL) assay, chromogenic assay, colorimetric assay, optical biosensor, gravimetric biosensor, pyroelectric biosensor, piezoelectric biosensor, electrochemiluminescence, electroluminescence, cathodoluminescence, mechanoluminescence, radiometric assay, radiometric analysis, isotope analysis, isotope dilution assay, radiolabels, acoustic separation, acoustic impedance, acoustofluidic separation, acoustofluidic bacteria separation, microfluidic array cytometer, optical cell manipulation, bacterial growth kinetics analysis, time-resolved growth analysis, bacteriophage plaque assay, and other analytical methods, tests, assays, or techniques. In some embodiments analysis of the sample may include use of artificial intelligence, machine learning, neural networks, deep neural networks, convolution deep neural networks, principal component analysis, support vector machines, adversarial neural networks, recursive neural networks, recurrent neural networks, and others.

Buffer Composition and Reagents

According to certain embodiments, reagents that may be incorporated into the sample prep device, preferably within the blisters or comparable reagent storage vessels, may include a variety of components including, but not limited to, buffers, salts, blocking proteins, hydrophilic polymers, surfactants, and other additives that can help reduce assay interference, enhance analyte stability or detectability, or act as preservatives to promote a long shelf-life of the device and reagents or to stabilize the analyte or extract sample as it is moved, transported, or stored before analysis.

According to certain embodiments, any type of buffer used for controlling pH or performing a certain function such as lysis may be incorporated into the device. For example, buffers and reagent solutions may include, without limitation, phosphate buffer, phosphate buffered saline (PBS), sodium phosphate buffer, potassium phosphate buffer, MES hydrate, MES buffer, BIS-tris, ADA, PIPES, ACES, MOPSO, BIS-tris propane, BES, MOPS, TES, HEPES, DIPSO, trizma, tris, tris hydrochloride, tricine, gly-gly, EPPS, HEPPS, bicine, TAPS, AMPD, AMPSO, CHES, CAPSO, AMP, CAPS, ammonium acetate, sodium acetate, acetate buffer, citrate, citrate buffer, sodium citrate, sodium borate, borate, carbonate, sodium carbonate, ammonium acetate, ammonium bicarbonate, ammonium carbonate, lysis buffer, bacterial lysis buffer, viral lysis buffer, neutralization buffer, Good's buffers, Cary and Blair medium, Amies medium, Stuarts medium, Venkatraman Ramakrishnan (VR) medium, Sach's buffered glycerol saline, thioglycolate broth, viral transport medium (VTM), bacterial transport medium, universal transport medium (UTM), Hank's balanced salts, sodium dihydrogen phosphate and glycine buffer, SPG buffer, volatile buffers, formic acid, pyridine-formic acid buffer, trimethylamine-formic acid buffer, pyridine-acetic acid buffer, trimethylamine-acetic acid buffer, ammonia-formic acid buffer, ammonia-acetic acid buffer, trimethylamine-carbonate buffer, and others (see, for example, Chandra Mohan, “Buffers A guide for the preparation and use of buffers in biological systems” CALBIOCHEM (2003)).

According to certain embodiments, other additives may be incorporated into the device as reagents including without limitation sodium chloride, potassium chloride, calcium chloride, magnesium sulfate, magnesium chloride, potassium salts, magnesium salts, sulfate salts, phosphate salts, monobasic, dibasic, and tribasic potassium phosphate, monobasic, dibasic, and tribasic sodium phosphate, D-glucose, dextrose, sodium bicarbonate, ethylenediaminetetraacetic acid (EDTA), egtazic acid (EGTA), chelating agents, divalent cation chelating agents, L-cysteine, heparin, sodium hydroxide, potassium hydroxide, lye, hydrochloric acid, acetic acid, acids, bases, caustic solutions, caustic soda, hydrogen peroxide, alcohols, precipitating agents, oxidizing agents, reducing agents, viscosity reducing agents, anti-foaming agents, nucleic acid stabilizers, DNA stabilizers, RNA stabilizers, virus stabilizers, protein stabilizers, bacteria stabilizers, xantham gum, cell culture media, culture media, transport media, and preservatives such as sodium azide, thimerosal, microcide III, and others. Antibiotics and antifungal agents may be included such as vancomycin, amphotericin B, colistin, and others. The reagents may include compounds that reduce background autofluorescence such as Trypan Blue. Proteins that reduce nonspecific binding, adsorption losses of analyte, or generally act as blocking proteins or protein stabilizers may be incorporated including without limitation bovine serum albumin (BSA), albumin, casein, nonfat dry milk, gelatin, type A gelatin, type B gelatin, cold water fish skin gelatin, porcine gelatin, bovine gelatin, and others. In some embodiments the device may contain HAMA blockers that reduce assay interference from human anti-mouse antibodies. Various mucolytic agents may be incorporated into the device, which is particularly beneficial to reduce the interference of mucus in assays, such as from nasal swabs, nasopharyngeal swabs, vaginal swabs, and other swabs that may contain mucus. Mucolytic agents may include, without limitation, cysteamine, chondroitin sulfate, mercaptoethanol, cysteine compounds, N-acetyl-L-cysteine (NAC), acetylcysteine, S-benzyl-L-cysteine, S-methyl-L-cysteine, L-cysteine dimethyl ester dihydrochloride, (+)-S-trityl-L-cysteine, L-cysteine, dithiothreitol (DTT), DL-dithiothreitol, hydrogen peroxide, ambroxol, bromhexine, carbocisteine, erdosteine, mecysteine, L-cysteine methyl ester hydrochloride, Dornase alpha, enzymatic mucolytic agents, dithiol mucolytic agents, glycerol guaiacolate, bromelain, tris(hydroxypropyl)phosphine (THPP), hyaluronidase, mannitol, ambroxol, erdosteine, iodinated glycerol, methylcysteine, carbocysteine, guaifenesin, bromohexine, and others. In some embodiments, reagents may include various enzymes or biological additives that aid in breaking down biological materials. Enzymes may include, without limitation, proteases, lipases, amylases, nucleases, and others.

According to certain embodiments, reagents may include a variety of surfactants that may act as wetting agents, detergents, dispersants, emulsifiers, or foaming agents. Surfactants may be included in the device to aid in extraction of nucleic acids, proteins, biological molecules, macromolecules, lipopolysaccharides, or other analytes of interest from the sample. Surfactants or detergents may aid in lysis of cell walls, cell membranes, lipid bilayers, viral capsids, or other membranes, walls, or barriers of biological origin. Surfactants may be of nonionic, anionic, cationic, zwitterionic, or amphoteric nature. In addition, surfactants may include without limitation sodium cholate hydrate, n-Dodecyl β-D-maltoside, Brij L23, Tween, Tween 20, Tween 80, isotridecylpoly(ethyleneglycol ether), poly(ethylene glycol)-based surfactants, ethylphenolpoly(ethyleneglycolether), polyethyleneglycol-polypropylene glycol copolymer, dodecylpoly(ethyleneglycolether), 2,4,7,9-tetramethyl-5-decyne-4,7-diol ethoxylate, polyethylene glycol tert-octylphenyl ether, Triton X-100, Triton, 2,4,7,9-tetramethyl-5-decyne-4,7-diol ethoxylate(30), PEGylated sorbitan, sorbitan, 3-([3-Cholamidopropyl]dimethylammonio)-2-hydroxy-1-propanesulfonate (CHAPSO), 3-[(3-Cholamidopropyl)dimethylammonio]-1-propanesulfonate hydrate (CHAPS), sulfobetaines, myristyl sulfobetaine, Dioctyl sulfosuccinate sodium salt, aerosol OT (AOT), sodium dodecyl sulfate (SDS), sodium dodecylbenzenesulfonate (SDBS), sodium deoxycholate, sodium chenodeoxycholate, potassium oleate, Tergitol, Tergitol NP-9, Tergitol NP-10, Tergitol NP-40, Surfactant 10G, Sorbitan, Span 20, Span 60, Span 80, biological surfactants, and bile salts, and bile surfactants. In some embodiments hydrophilic polymers such as polyvinylpyrrolidone (PVP), polyvinyl alcohol (PVA), polyethylene glycol (PEG), and derivatives of PVP, PVA, and PEG of varying molecular weights may be incorporated into the device. Generally, surfactant concentrations in buffers may be close to the critical micelle concentration within plus or minus one to two orders of magnitude. For example, if a surfactant has a critical micelle concentration of 1 mM, the surfactant concentration in the buffer may range between 0.01 mM to 100 mM. Additionally, hydrophilic polymer concentrations can range from 0.01% w/v to 10% w/v.

In some embodiments, reagents may be lyophilized directly in the sample chamber in a dry powder. Various additives may aid in lyophilization including many of the buffers, proteins, polymers, and surfactants mentioned previously. Other additives for lyophilization may include without limitation sugars, polysaccharides, disaccharides, sucrose, trehalose, maltose, raffinose, dextrose, polyols, sugar polyols, mannitol, sorbitol, xylitol, erythritol, lactitol, maltitol, and others.

Reporters and Molecular Recognition Elements

According to some embodiments, reporters, labels, or molecular recognition elements that aid in analyte detection may be incorporated into the sample prep device in various formulations such as lyophilized, freeze dried, or air-dried powders or solids, or in liquids, gels, or other fluids. Reporters and labels may be of any type that can produce a signal for analyte detection such as, without limitation, fluorescent molecules, fluorescent particles, fluorescent nanoparticles, fluorescent beads, fluorescent submicron particles, submicron particles, microparticles, nanoparticles, particulate labels, phosphorescent particles, phosphorescent nanoparticles, persistent luminescent particles, particles that exhibit persistent luminescence, particles that exhibit long-lived or long-lifetime phosphorescence, quantum dots, phosphors, upconverting phosphors, downconverting phosphors, magnetic particles, labels for giant magnetoresistance (GMR) sensing, labels for surface enhanced Raman scattering or surface enhanced Raman spectroscopy, colored labels, visual labels, gold nanoparticles, latex particles, carbon black particles, cellulose nanobeads, nanodiamonds, fluorophores, organometallic fluorophores, organometallic phosphorescent molecules, europium chelates, fluorescent or phosphorescent europium molecules or particles, labels for time-resolved fluorescence, enzymes, carbon nanotubes, graphene, carbon nanowires, silica-encapsulated particles or nanoparticles, colloids, colloidal particles, colloidal gold, colloidal silver, core-shell nanoparticles, gold-silica core shell particles, silver nanowires, silver nanoparticles, chemiluminescent enzymes, luciferase, firefly luciferase, horseradish peroxidase (HRP), electrochemical enzyme reporters, enzymes or reporters for silver staining, radiolabels, radioactive isotopes, radioactive labels, and others.

In certain embodiments, labels or reporters may be paired, functionalized with, or conjugated to a variety of molecular recognition elements including, without limitation, proteins, peptides, antibodies, antigens, antibody fragments, antibody F(ab′)2, Fab, Fab′, and Fv fragments, antigen-binding antibody fragments, nucleic acids, DNA, RNA, DNA fragments, RNA fragments, primers, TaqMan probes, probes for quantitative PCR, probes for PCR, probes and reagents for reverse transcriptase PCR, probes and reagents for isothermal nucleic acid amplification, probes and reagents for nonisothermal nucleic acid amplification, aptamers, affinity reagents, molecularly imprinted polymers, DARPins, antibody mimetic proteins, affinity molecules, affinity macromolecules, biological molecules, biological macromolecules, avidin, streptavidin, Neutravidin, and others. In some embodiments, enzymes may be used as affinity reagents.

In certain embodiments, one or more of the foregoing reporters, labels, or molecular recognition elements, and/or other reagents can be included in the sample chamber. The sample chamber reagents can be freeze dried, spray dried, dry (e.g., powder), or liquid. In some case, the sample chamber reagents are freeze dried, spray dried, or dry (e.g., powder), and the sample prep pod is configured to release a first liquid reagent before a sampling device (e.g., swab) is inserted into the device to solubilize one or more sample chamber reagents. In some case, the sample chamber reagents are freeze dried, spray dried, or dry (e.g., powder), and the sample prep pod is configured to release a first liquid reagent before a sampling device (e.g., swab) is inserted into the device to dilute one or more sample chamber reagents. In some cases, the first liquid reagent is released to solubilize or dilute a sample chamber reagent after insertion of the sampling device (e.g., swab).

In some cases, the first liquid reagent is released by pressing an, e.g., first, button, turning an, e.g., first, dial, or the like as described herein. In some cases, the first liquid reagent is released by piercing or rupturing a reagent reservoir (e.g., a blister). In some cases, the piercing or rupturing is performed by applying a compressive force on the reagent reservoir and/or on a lance as described herein.

Applications and Advantages

Devices and methods of certain embodiments, compared to the state of the art for sample preparation in the fields of point-of-care diagnostics, at-home testing, forensics, and related applications, allow greater reproducibility and consistency between users for preparation of a wide variety of samples for use in numerous analytical tests, procedures, or assays. According to certain embodiments, the sample prep device may incorporate all liquid reagents needed for sample preparation into the device within blisters or comparable reagent storage vessels, and the reagents are easily released into the sample chamber during sample preparation by the push of a button or turn of a dial by the user. The sample prep device of certain embodiments may also eliminate the need for the user to manually count droplets of liquid reagents added to a sample, which can cause variability and is prone to error.

In applications where multiple reagent solutions are needed for sample preparation, the device ensures a small coefficient of variation in the volumes of each reagent dispensed into the sample chamber, which significantly improves the consistency of sample preparation between users compared to manual addition of the reagents with dropper bottles. The sample prep device of certain embodiments may provide mechanisms that ensure reagents are added in the correct order in embodiments where sample prep requires addition of more than one reagent. In embodiments that use swab samples, the sample prep device may provide features and mechanisms that enhance extraction efficiency and reproducibility compared to manually twirling, dipping, or agitating swabs in a solution. The sample prep device may also enable processing samples, including swabs, in an enclosed leak-proof container which minimizes the risk of contaminating the sample with undesirable environmental material, can eliminate the risk of exposing the user to hazardous reagents for sample preparation, and significantly decreases the risk of contaminating the environment with potentially infectious biological material from the sample.

According to certain embodiments, by enclosing the sample in a leak-proof chamber with a cap, the user can shake or rotate the sample prep device to aid in extraction of the analyte. According to other embodiments, the sample prep device can directly mate with an assay device, such as a lateral flow test cartridge, to automatically dispense an extracted or processed sample into the assay device for analysis. This feature eliminates the risk of user error from incorrect sample addition to the assay device, such as adding an insufficient volume or adding excess volume of sample. The sample prep device of certain embodiments may incorporate features that provide feedback to the user that inform the user that the various steps have been performed properly. These feedback features, when combined with the simplified mechanisms of sample preparation such as reagent addition by pressing a button or turning a dial, greatly reduce the stress and uncertainty a lay user would experience in home-testing applications, particularly when compared to the complex sample prep procedures and methods of the prior art. The sample prep device simplifies the workflow and improves reproducibility in assays that require reconstitution of dried or lyophilized material. In some embodiments the sample prep device can be configured to contain a processed sample in an enclosed stabilized and leak-proof state, allowing the sample to be easily transported for analysis at an offsite location, such as in mail-in diagnostics applications. In some embodiments the sample prep device contains self-sealing rubber septum caps that are highly amenable to automated analysis systems that can extract a sample through the seal via a needle with minimal risk of sample contamination or contaminating the local laboratory environment with the sample.

The sample preparation device and associated methods of sample preparation in certain embodiments can be widely used for diagnosis or screening for a wide range of conditions and detecting a variety of analytes including without limitation viruses, bacteria, proteins, peptides, prions, hormones, polysaccharides, lipopolysaccharides, lipooligosaccharides, endotoxins, lipids, membranes, membrane fragments, cell walls, cell membranes, spores, organic molecules, organic compounds, organic materials, organometallic compounds, inorganic materials, small molecules, macromolecules, biological molecules, supramolecular assemblies, inorganic compounds, carbohydrates, fungi, toxins, environmental contaminants, radioactive species, heavy metals, elements, chemical elements, ions, isotopes, biological molecules, enzymes, substrates, infectious diseases, bacterial infections, viral infections, protozoans, eukaryotes, archaea, organisms, fragments of organisms, nucleic acids, DNA, RNA, aptamers, cell fragments, viral fragments, cancer biomarkers, biomarkers, biomarkers of chronic disease, and others.

The devices and methods of certain embodiments may be advantageous when sample preparation requires use of hazardous reagents, such as lysis buffers that can cause chemical burns when in contact with skin, eyes, or other biological tissue. Sodium hydroxide at concentrations higher than 0.1 molar (0.1 M) is often used for chemical lysis of bacteria in diagnostic tests, and hydrochloric acid at concentrations around 0.1 molar (0.1 M) may be added to the lysate after lysis for neutralization of the caustic high-pH lysate solution. For example, Quidel Corporation is a manufacturer of rapid diagnostic tests, and the Quidel QuickVue Chlamydia Test comprises Reagent A, a 0.2 Normal (0.2 N) solution of sodium hydroxide, and Reagent B, a solution containing 0.1 Normal (0.1 N) hydrochloric acid. The QuickVue test provides the reagents in small dropper bottles, and the user must manually squeeze drops out of the bottles into a tube used for extraction of chlamydia from swabs. The test is intended to be used by highly skilled healthcare professionals in point-of-care clinical settings, but the design of the test and the risk of a lay user experiencing bodily harm from chemical exposure makes the test unsuitable for use by untrained users such as in at-home self-testing applications.

Devices and methods of certain embodiments described herein overcome these limitations, as the sample prep device is capable of storing concentrated sodium hydroxide in one blister pack and concentrated hydrochloric acid in a second blister pack, thereby allowing extraction of material from a swab using chemical lysis with concentrated sodium hydroxide and subsequent neutralization with a solution containing concentrated hydrochloric acid. In the sample prep device of certain embodiments, these hazardous reagents may be handled in a manner that eliminates the possibility of exposing the user to these chemicals. For example, the sodium hydroxide and hydrochloric acid may be dispensed into the sample preparation chamber with a closed leak-proof cap, such that no liquid can spill outside of the device. After the reagents from the two blisters have mixed within the sample chamber, the resulting mixture is in a neutralized state at a nonhazardous pH. In some embodiments, the user may then remove the cap to transfer sample into an assay cartridge using a pipette. In other embodiments, the sample prep device may include mechanisms that dispense the extracted solution into an assay device or test cartridge without ever exposing the user to the liquid sample or extract, such as with the methods and devices illustrated in FIGS. 22(A)-22(C).

Certain embodiments of the sample prep device overcome the major safety limitations of existing methods for sample preparation that require use of hazardous liquids or fluids, which opens the possibility of creating new diagnostic testing products for the general population. Furthermore, the Quidel QuickVue test requires that the user add the reagents in the correct order for the test to run properly, and that the user adds the correct amount of each reagent. Thus, if a user mistakenly adds Reagent B before Reagent A, or if the user adds too many drops of one reagent, the test may provide an inaccurate result. However, the sample prep device of certain embodiments overcome these issues by providing features that ensure the correct order of reagent addition and that the volume of reagents dispensed is tightly controlled with a low coefficient of variation between devices.

The devices and methods of certain embodiments are advantageous when sample preparation requires a lyophilized reagent that must be reconstituted into a buffer for an assay, analytical procedure, or diagnostic test to be performed. For instance, the device may be configured such that the sample chamber contains a lyophilized powder, which is reconstituted when the user turns a dial or presses a button, triggering release of a liquid into the sample chamber that reconstitutes the lyophilized powder. The advantages of the devices and methods of certain embodiments are clear when compared to the current standard for sample preparation for rapid diagnostic tests. Quidel Corporation is a manufacturer of rapid diagnostic tests and produces the Sofia test kit for detection of influenza A and B, which is a widely used test in point-of-care settings. The Sofia test is designed to work primarily with three sample types: nasopharyngeal swabs, liquid extract of a nasopharyngeal swab that was prepared by immersing the swab in viral transport media, and liquid from a nasal wash or nasal aspirate. For all sample types, the first few steps of running a Sofia test are the same. The Sofia kit provides a tube, called the “Reagent Tube”, that contains a lyophilized powder comprising various reagents necessary for the assay to function properly. The lyophilized powder in the Reagent Tube must be reconstituted (i.e. dissolved) in a liquid assay buffer, called the “Reagent Solution”, that is provided in the kit inside a plastic reagent packet. The reagent packet that contains the Reagent Solution is an injection molded plastic part that comprises a semi-spherical bulb connected to a tapered snout that gradually narrows for dispensing the liquid. The end of the snout contains a plastic tab that must first be twisted off by the user before reagent can be dispensed. The instructions in the Sofia kit require the user to orient the Reagent Solution packet upwards so that the liquid pools into the bulb, and then the user must break off the twistable tab, and then dispense all of the Reagent Solution into the Reagent Tube to dissolve the lyophilized material.

However, there are various issues with this design and procedure that are prone to error and introduce variability between users. A significant fraction of the Reagent Solution may be trapped in the tapered snout by capillary forces, even when oriented properly, and gravity may not pull all the Reagent Solution down into the bulb. If any liquid is in the tapered snout when the user twists off the tab, some liquid will flow out of the reagent packet and will be lost. Additionally, while the bulb is semi-flexible allowing the user to squeeze it to dispense reagent out of the packet into the Reagent Tube, the bulb is not so flexible that it can be sufficiently squeezed to completely dispense all of the Reagent Solution into the Reagent Tube, which introduces additional variability. An untrained user must make a judgement call about whether they should keep squeezing the bulb to try to get the last amount of Reagent Solution out of the packet and into the Reagent Tube. If the user experiences too much difficulty in dispensing the last few drops of Reagent Solution, the user may wonder whether their actions during this sample preparation step could have led to false test results. Other untrained users may not notice that they have failed to completely dispense all the Reagent Solution, potentially leading to false test results.

The methods and devices of certain embodiments overcome these issues with Quidel's Sofia kit. For instance, a lyophilized powder can be prepared directly in the sample tube or sample chamber. A reagent solution can be incorporated into a blister packet, which releases a controlled volume of fluid into the sample chamber to reconstitute or dissolve the lyophilized powder when the user presses a button, turns a dial, or engages a similar simple mechanical feature that triggers release of liquid into the sample chamber. Coefficients of variation in the volume dispensed into the sample chamber from the blister or similar reagent storage vessel can be as low as 1-5%, and generally 5-10% coefficients of variation in dispensed volume are easily achievable using blister volumes from 100 to 2000 μL. These advantages of the sample prep device and methods offer new ways for extracting material from nasal or nasopharyngeal swabs for detection of influenza antigens.

### EXAMPLES

### Example 1—Devices and Methods for Sample Preparation for Rapid Diagnostic Tests

Conventional lab-based IVDs suffer from several other issues in addition to often slow turnaround time for results. For some conditions such as sexually transmitted diseases (STDs), also called sexually transmitted infections (STIs), there can be a major stigma associated with visiting the doctor to get tested. At-risk individuals who should be screened regularly for STDs often do not get tested because of the psychological factors such as social stigma and embarrassment. Various STIs including Chlamydia trachomatis and Neisseria gonorrhea may be asymptomatic in a significant fraction of the infected population. Many people infected with chlamydia and gonorrhea may not know that they are infected, putting them at significant risk for severe health complications including infertility. Chlamydia and gonorrhea are both easily cured with the right treatment of antibiotics. The current gold standard of diagnostic tests for chlamydia and gonorrhea are nucleic acid amplification tests (NAATs). The conventional way for people to get tested is to visit a clinic or doctor and get a prescription for the test, after which a sample is collected and sent to a lab for testing. It can often take a few days to get the test results. Despite having simple antibiotic treatments, the prevalence of chlamydia and gonorrhea remain stubbornly high, in part because of the inconvenience of conventional testing.

Certain embodiments provide rapid immunoassays using the lateral flow assay format for detection of chlamydia and gonorrhea antigens from genital swabs. While the lateral flow format is highly usable by lay persons, there exist no solutions for sample prep of swab samples that are robust and facile enough for analyte extraction in over-the-counter testing applications by untrained lay users. The devices and methods of certain embodiments were inspired by this severe lack of adequate solutions for the swab sample preparation problem. Consider for example Quidel Corporation's QuickVue rapid test for chlamydia. The test kit comes with multiple dropper bottles, and the user must carefully add the correct amount of solution from each dropper bottle in the correct order into a tube. The user must also manually twirl the swab to extract material from the swab into the liquid phase. The user must then place a cap over the extraction tube and squeeze exactly three drops of the solution into a lateral flow test cartridge. All of these steps can cause considerable variability between users, resulting in potentially erroneous results, particularly for untrained lay users or in over-the-counter testing applications. With the devices and methods of certain embodiments, the reagents can be reproducibly added to the swab chamber by using dials, buttons, or other similar mechanisms to dispense a controlled volume of each reagent into the swab extraction tube or swab chamber from blisters or other reagent storage vessels. The device may be designed in such a way that twirling of the swab is unnecessary to effectively extract the analyte from the swab. The sample prep device also can be configured with a metering cap or similar device that controls the amount of volume dispensed into the strip. The user only needs to invert the sample prep device and plug it or screw it into the lateral flow test cartridge. A controlled volume of the sample will automatically flow out of the sample prep device onto the lateral flow strip.

The devices and methods of certain embodiments are highly usable for sample preparation for any rapid diagnostic test such as a lateral flow assay, a flow through assay, and others. In addition, the sample prep device is highly useful for extraction of analytes from nasal swabs, nasopharyngeal swabs, and mid-turbinate swabs for detection of infectious pathogens. For example, the device can be used for extraction of influenza antigens from nasal swabs, nasopharyngeal swabs, and mid-turbinate swabs for detection in a lateral flow test, and for distinction between influenza A and B infections. The sample prep device is also highly useful for analyte extraction from oral, throat, tonsil, or mouth swabs to detect infectious pathogens. The sample prep device can be combined with a rapid diagnostic test for detection of infectious pathogens such as influenza, strep throat, streptococci, Group A streptococcal infection, Streptococcal pharyngitis, Streptococcus pneumoniae, infectious pneumonia, mononucleosis, Epstein-Barr virus, respiratory viruses, coronaviruses, respiratory infections, rhinoviruses, adenoviruses, parainfluenza, respiratory syncytial virus (RSV), infectious bacteria, infectious viruses, Middle East Respiratory Syndrome (MERS), Severe Acute Respiratory Syndrome (SARS), COVID-19, SARS-Cov, SARS-Cov-2, and others.

### Example 2—Mail-in Devices for Lab-Based Analysis

Conventional in vitro diagnostics often have multiple associated logistical hassles for the patient. A patient must schedule an appointment at a clinic for a healthcare professional to decide if testing is warranted and to prescribe the test, the patient may need to return to the clinic on a different day or travel to a medical lab at a different location for a sample to be collected, then the patient may wait days to weeks to receive the test results. In many cases, the patient may be required to return to the original clinic to be informed by the healthcare professional about the test results. Medical tests that should be simple and routine can instead be a major inconvenience for the patient, requiring the patient to take time off from work, school, or other important activities to travel to a clinic to get tested. These inconvenient factors of conventional medical testing create significant “friction” that results in many people not getting tested or screened for health problems or conditions on a regular basis, potentially leading to negative health outcomes. Products and solutions that enable broader and easier access to medical testing can be broadly categorized as “convenience diagnostics.” Convenience diagnostics include products that allow self-testing by the user in a variety of settings such as at home or other convenient locations. In other applications convenience diagnostics may combine conventional lab-based diagnostics with sample collection by the user at home, and the user-collected sample is transported for analysis at an offsite location that has the essential equipment to process and analyze the sample.

Home-based over-the-counter (OTC) diagnostics are championed as a solution to the friction and hassle of conventional medical testing, by enabling people to collect samples and test themselves conveniently at home. While OTC diagnostics are a viable solution for many applications to enable more widespread and regular screening and testing, OTC diagnostics have some limitations. It is significantly more challenging to develop a diagnostic test for OTC use because of technological, economic, and human factors constraints. Untrained lay users are prone to making mistakes such as improperly processing the sample, failing to run the test correctly, or not interpreting the results properly. A developer of an OTC test must devote significant resources towards ensuring that a wide variety of users from different educational, professional, and cultural backgrounds can correctly use the test. To eliminate incorrect interpretation of results, a developer of an OTC test may design the product to pair with a reader device that incorporates one or more sensors and software to automatically analyze the test and deliver a result without interpretation by the end user. However, reader devices can be prohibitively expensive, which can limit their use in some applications.

Many technologies that are widely used in conventional lab-based clinical testing cannot be easily adapted for OTC testing. For instance, tests based on polymerase chain reaction (PCR) for detection of nucleic acids, also called nucleic acid amplification tests (NAATs), require expensive hardware to precisely control temperature during thermal cycling, and often use complex optical hardware for fluorescence-based readout of the signal for result determination. The enzyme-linked immunosorbent assay (ELISA) in its conventional format in a 96-well plate uses a reader that may be equipped to conduct absorbance, fluorescence, time-resolved fluorescence or phosphorescence, and chemiluminescence measurements. ELISAs are also usually coupled with automated plate washers to conduct multiple washing steps needed for sensitive and specific analyte detection. These instruments and systems used in conventional medical testing labs vastly exceed the cost that any general user of an OTC test could afford.

Despite the economic disadvantages of lab-based testing technologies, there are numerous technical advantages. There are significant regulatory barriers associated with bringing a new OTC test to market, with particular constraints on limit of detection, clinical sensitivity and specificity for qualitative binary yes/no diagnostics, and for quantitative tests additional requirements for limit of quantitation, dynamic range, linearity, coefficient of variation and precision. All new tests must undergo formal validation in clinical studies that compare the new test against one or more approved “gold standard” comparator tests. The performance requirements of the gold standard test may not be easily met with OTC devices without significant innovation and technological breakthroughs, especially given the economic constraints on the design of the OTC device. However, for a lab-based test the readout hardware is considerably less constrained by cost, making it significantly easier to develop a test that can meet all technical performance requirements. For example, NAATs are known for being able to very sensitively detect specific genes or sequences of nucleic acids (DNA or RNA) down to the single-cellular level. If clinicians and regulatory agencies are accustomed to the sensitivity of NAATs, for some applications such as bacteria or virus detection it may be infeasible to develop an OTC test using available technologies such as antibody/antigen-based immunoassays since the molar concentration of antigen at low bacterial or viral loads may be below the detection limit of the immunoassay. Therefore, although there may be a need for OTC testing in some applications, it is often likely that the performance of existing OTC technologies cannot easily meet the clinical and regulatory performance requirements.

If there are significant benefits in increasing accessibility to specific types of diagnostics and running screening tests on a wider population on a more frequent basis, but OTC technologies are inadequate for enabling accurate at-home self-testing, then what is the solution? A potential solution and an emerging area of “convenience diagnostics” that is often overlooked is mail-in or mail-order diagnostics. In a mail-in test, the patient does not need to travel to a clinic or medical lab for sample collection. Instead, the user collects a sample at home or another convenient location, and that sample is mailed, shipped, or delivered by a courier to a lab for testing. This approach significantly reduces the friction for patients, as they can collect a sample and have it sent to a lab for analysis at their convenience. It should be noted that the term “mail-in diagnostics” does not literally imply that only the conventional mail, postal, or parcel systems may be used for transporting the user-collected sample. Instead, the term “mail-in diagnostics” broadly encompasses any kind of diagnostic test wherein the user collects a sample at home or another convenient location, and the sample is transported, typically by a third party, to a laboratory or other facility for analysis.

Innovations in digital and consumer technology and the development of the gig economy including ridesharing services provided by companies such as Lyft® and Uber®, and on-demand food delivery services such as Uber Eats® and DoorDash® can be leveraged to provide rapid delivery of test kits to users, and rapid delivery of user-collected samples to laboratories or other facilities for analysis, thus enabling “on-demand diagnostics.” There is significant potential for mail-in diagnostics or on-demand diagnostics that incorporate user-collected samples to enable wider access to diagnostic testing and screening for medical conditions. However, in order for mail-in diagnostics to make significant headway into the healthcare system, new devices and methods for sample preparation that are highly useable by laypersons, and can ensure accurate and repeatable sample preparation for a wide variety of samples are needed.

The sample prep device of certain embodiments provide an ideal device for mail-in diagnostics and can offer significant advantages over devices and methods currently used. One example of a mail-in screening test is the Cologuard stool DNA test manufactured by Exact Sciences Corporation. The Cologuard test uses “stool DNA” technology to screen for markers of colon cancer in stool samples. The test kit provides several components to the user in a box including a large sample container, a small sample tube, a bottle of preservative liquid, a bracket for holding the sample container, labels, and instructional materials. The user must pass a bowel movement into the sample container. The cap of the sample tube contains a “probe” or swab, and the user is instructed to scrape the stool sample until feces completely covers the grooves on the tip of the probe. The probe is then inserted into the sample tube. A cap is tightly sealed over the large sample container enclosing the original stool sample, and the large sample container and small sample tube are packaged into the box and shipped out for analysis.

With the sample prep device of certain embodiments, one could potentially eliminate the need to ship an entire stool sample, and instead ship only a small fecal sample collected by a probe, swab, spoon, or similar mechanism or device. Furthermore, the ability to introduce precise volumes of different reagents into the sample or enabling the device to incorporate lyophilized reagents creates new opportunities for sample preparation of the user-collected stool sample. In some embodiments the lyophilized material incorporated into the sample prep device may contain cellulose-hydrolyzing enzymes or cellulases such as cellobiohydrolase, endoglucanase, β-glucosidase and others. The lyophilized material may also contain proteases that break down proteins in the fecal matter, or lipases that break down fats and lipids. Generally, lyophilization may be used to incorporate into the sample preparation device any kind of biological entity such as an enzyme that can degrade components in the fecal sample that can interfere with the assay or analytical procedure, or to help promote the stability of the analyte within the fecal sample during transit of the sample prep device to a laboratory for analysis.

Another significant advantage is that the sample prep device allows a multistep process for extraction of DNA or other analytes from the fecal matter including enzymatic digestion with various reconstituted enzymes, chemical lysis, neutralization, emulsification using surfactants such as AOT, and flocculation of certain components of the feces. Applications for analysis of fecal samples could include microbiome sequencing to provide actionable information to users about their gut microbial species, thereby enabling dietary changes or other interventions that can improve health. In other embodiments, fecal analysis can screen for signs of intestinal parasites. In other applications sample preparation of fecal samples can be used to aid in detection of blood or markers of blood such as in fecal occult blood testing, as blood in stool may be a marker of various types of disease. In further embodiments, sample preparation may be used to extract DNA or RNA that can then be amplified or sequenced using various NAAT-based or sequencing-based methods for detection of mutations that may be associated with cancer.

The sample prep device of certain embodiments may be broadly applicable to a range of mail-in testing applications. The mail-in diagnostics model is highly beneficial for a variety of screening tests. For example, the sample prep device can be used to process a saliva sample for extraction of genomic material from the user. The ability to introduce controlled volumes of multiple liquid reagents, and the capability to also incorporate lyophilized material such as enzymes that can aid in removing interfering components, can be particularly beneficial for preparation of saliva samples for a variety of applications such as genome sequencing and detection of biomarkers for infectious diseases, genetic diseases, cancer, and others.

The sample prep device and methods of sample processing using the device are well-suited for widespread testing during outbreaks of pandemic and epidemic infectious diseases. For example, the coronavirus disease that emerged in China in 2019, called COVID-19 or SARS-Cov-2, and spread to the rest of the world including Europe and the United States caused immense economic damage and significant loss of life. Testing for COVID-19 presents somewhat of a paradox to public health officials. When testing is not conducted on a relatively large scale, either due to unavailability of tests or other factors, the mortality rate of the disease tends to be overestimated as a higher percentage of tests are run on patients presenting with severe symptoms who are more likely to die from the infection, while those with milder symptoms are often untested, skewing the statistics. Additionally, it is more difficult to gauge the effectiveness of policies aimed to reduce the spread of the disease when testing is limited and there is greater uncertainty in the true prevalence of the disease and how rapidly it is spreading throughout the population. Thus, policy makers and healthcare providers are incentivized to test a larger fraction of the population to more effectively understand and combat the disease.

However, in an aim to curb the spread of disease policy makers in the United States and other nations imposed “shelter in place” policies, that can drive many people away from visiting the clinic to get tested. Furthermore, people at a particularly high risk of experiencing severe complications from infection, such as elderly people, in some cases would be better advised to stay away from conventional testing labs and stay at home to avoid contracting the infection. Concentrating multiple people in crowded waiting rooms to get tested for an airborne respiratory virus could unintendedly promote the spread of the virus. Thus, COVID-19 is a clear example of why tools that enable accurate at-home diagnostics, mail-in diagnostics, or on-demand diagnostics are needed. The sample prep device of certain embodiments allows robust sample preparation with high consistency between end users, and is highly usable by lay persons. Public health officials in high population density areas or other locations at great risk of widespread infection could distribute sample collection devices on a vast scale and enact a program whereby people can collect a nasal swab or nasopharyngeal swab at home, extract the sample with the sample prep device, and have the device delivered to a lab for analysis whenever people are concerned they might be infected. The sample prep device is highly flexible in terms of the kinds of reagents it may incorporate, and could easily incorporate a variety of additives that extract viral genetic material or antigens, and stabilize the analyte so that it can be transported to a lab for analysis without degradation, and then can be analyzed with a variety of conventional assays and methods such as NAATs or ELISAs.

### Example 3—Extraction And Analysis of Sample

Certain devices and methods described herein have been extensively tested for extracting Chlamydia trachomatis antigens from vaginal swabs for detection in a lateral flow immunoassay. The chlamydia assay uses a 3-buffer system for extraction of material from the swab for analysis. First, the swab is exposed to 500 μL of a lysis buffer containing 0.2 M sodium hydroxide, which is at a high enough pH to lyse human epithelial cells and chlamydia to release antigens from the chlamydia for detection in a sandwich immunoassay. After a 2-minute period in which the swab tip is immersed in lysis buffer, two different neutralization buffers, each 500 μL in volume, are added to the lysate immediately to bring the total buffer volume to approximately 1,500 μL. The expected ratio of total neutralization buffer to lysis buffer is 2, which was optimized to bring the pH of the final solution to a range that is best suited for detection of chlamydia antigens.

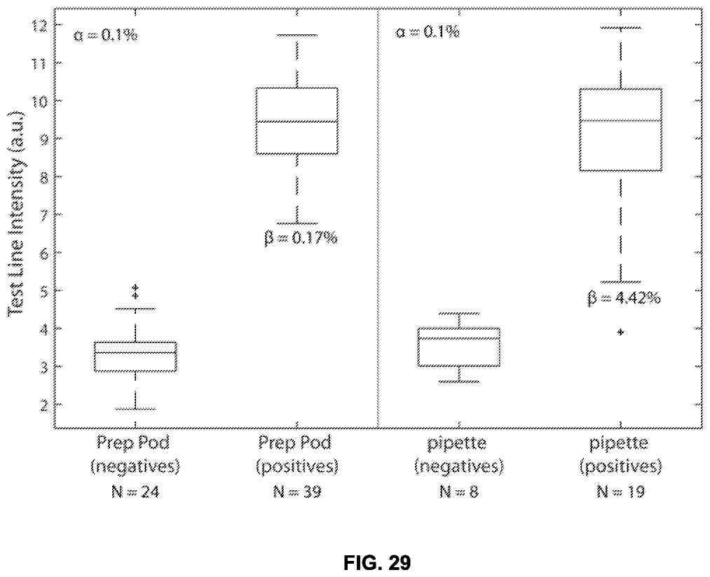

In one experiment the extraction performance of the prep pod device was compared to an ideal extraction protocol that used a microcentrifuge tube as the extraction chamber and Eppendorf air-cushion pipettes for highly precise addition of the lysis buffer and two neutralization buffers. A prep pod device like the one shown in FIG. 1 was provided with one button controlling the release of lysis buffer into the swab chamber, and a second button controlling the simultaneous release of the two neutralization buffers into the swab chamber. The samples tested were either vaginal swabs known to be negative for chlamydia (i.e. negatives) or vaginal swabs spiked with a constant amount of chlamydia (i.e. positives). After lysis and neutralization, a fixed 285 μL volume of the extract was added to a lateral flow test cartridge configured with luminescent strontium aluminate phosphors as reporters for analyte detection. The signal was analyzed using time-gated imaging on a smartphone (iPhone 7 Plus) and the test line signal for each lateral flow strip was calculated. A box plot of the results showing extraction with the prep pod versus the pipette-based method is shown in FIG. 29. The mean and standard deviations for the negatives were calculated separately for the samples run with the prep pod and the samples extracted with the pipette method. The mean and standard deviations of the positives were then calculated, and assuming a normal distribution and an alpha value of 0.1% (i.e. a 0.1% false positive rate), the beta values were calculated to estimate the false negative rate for the positive samples with both the prep pod and pipette method. Note that for a constant value of alpha, a lower value of beta closer to zero is indicative of better performance. The results in FIG. 29 show that the prep pod is roughly equivalent to, if not slightly better than, the pipette-based method. The results show that the prep pod has significant potential for sample preparation with swab-based samples and multi-buffer extraction systems, especially considering that in an over-the-counter test kit a general user would not have access to a highly precise air-cushion pipette that can deliver precise quantities of reagents at 0.5% coefficients of variation or lower. In a conventional IVD kit that uses dropper bottles and manual counting of added droplets to control the amount of lysis buffer and neutralization buffer added to the swab for extraction, there would almost certainly be more variability between samples than both the prep pod and the pipette-based method shown in FIG. 29, leading to worse assay performance. Thus, the sample prep device can introduce three reagents into a swab extraction chamber by the push of two buttons to enable comparable performance to extraction with highly controlled volumes of reagents added with precise pipettes.

In another experiment, the variability in the ratio of lysis buffer to neutralization buffer dispensed from reagent blisters into the swab chamber with the prep pod was analyzed. Ten prep pods of the same design shown in FIG. 3 were used in the experiment. Lysis buffer blisters were prepared with a blue-green dye and neutralization buffers were prepared without dye. A dilution series of lysis buffer with dye diluted into neutralization buffer at different dilutions factors was prepared to generate a calibration curve that enables one to back-calculate the ratio of neutralization buffer to lysis buffer (i.e. NB/LB ratio) from absorbance readings taken with a Thermo Scientific Varioskan plate reader. The buttons on the prep pod were pressed to release the lysis buffer and two neutralization buffers into the swab chamber. Three samples of the resulting solution from each prep pod device were collected, and absorbance measurements were taken with the plate reader. The absorbance readings and calibration curve were used to calculate the NB/LB ratio. For the ten different sample prep devices, the coefficient of variation (CV) for the NB/LB ratio was around 7.2%. The average CV for repeated absorbance measurements of a given sample was about 2%, so part of the 7.2% CV for the NB/LB ratio is due to fundamental measurement variability. The prep pods used in this experiment were prototypes built from 3D-printed parts. With manufactured, e.g., injection molded, parts with tighter tolerances and improvements in tooling for blister production (i.e. more precise vacuum forming tools), a CV for the NB/LB ratio of about 3-5% is obtained. A person skilled in the art would recognize that this performance would be very difficult to achieve using conventional dropper bottles for dispensing reagents into the swab chamber.

In other experiments the metering cap like the one shown in FIG. 3 has was evaluated using lateral flow assays with smartphone readout as shown in FIG. 5. For the chlamydia assay the optimal buffer volume to add to the strip is in the range of 280 μL to 450 μL. The metering cap was determined to be able to reliably meter off 1-1.2 mL of the extracted solution and only dispense the amount needed for the assay to run properly.

In other experiments the effect of diameter of the swab chamber on extraction performance was analyzed. It was observed that a swab chamber diameter of 6 mm or less was too tight to allow liquid to flow freely around PURITAN FLOCKED SWABs Reference Number 25-3806-U BT, and tended to result in worse extraction performance and analyte detectability than slightly larger swab chamber diameters of 6.5 mm and 7.0 mm. The swab chamber's diameter may have a tapered geometry where the top of the swab chamber is relatively wide (e.g., 16 mm), and the bottom of the chamber is narrower (e.g., 7 mm). It is this bottom region of the swab chamber where the diameter can have a significant effect on extraction efficiency. The preferable diameter for a sample chamber optimized for a PURITAN FLOCK SWAB having a tip diameter of about 5 to 5.5 mm is about 7 mm at the bottom of the swab chamber.

Blister material compatibility with the buffers is critical to ensure that components from the blister material do not leach into or contaminate the buffers, as contaminants could lead to false positives, false negatives or more variability in the assay results. We found that several polymer-based multilayered laminates from Tekni-Plex such as PTA360 and PTA6200 worked well with the chlamydia assay 3-buffer system. The Tekni-Plex materials worked particularly well with the lysis buffer. J-Pac medical is a known producer of blisters for pharmaceutical packaging and diagnostic reagent blisters. The J-Pac blisters are generally made from films that contain an aluminum layer sandwiched between two or more polymer layers. These blisters were shown to work in the sample prep device. However, aluminum-based blisters can be problematic with solutions that contain sodium hydroxide, as concentrated solutions of sodium hydroxide (e.g., 0.2 M) will immediately react with aluminum foil. It is difficult to ensure that there are no discontinuities or voids in the polymer layer that separates the blister reagent from the aluminum foil, and any small voids in the polymer film would allow the sodium hydroxide to contact the aluminum foil and react. Furthermore, J-Pac blisters are often intended to work by puncturing the blister with a needle or syringe and withdrawing a controlled volume of reagent from the blister through the needle with microfluidics. In the prep pod, however, a lance punctures a hole through the blister and the reagent flows through that hole. In this embodiment the sodium hydroxide comes into contact with the aluminum layer as the reagent flows through the punctured hole. Slight variability in puncturing between devices can result in differences in the amount of aluminum exposed to the lysis buffer and sodium hydroxide. Thus, while aluminum-based blisters are useable in some embodiments, it is preferable to use a completely polymer-based blister for lysis buffers that contain sodium hydroxide. Experiments with blisters containing lysis buffers and neutralization buffers have generally shown consistent performance to buffers stored in standard polypropylene tubes or glass bottles.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

A first embodiment may be directed to a sample extraction device for extracting a biological analyte from a biological sampling device. The sample extraction device may include a sample chamber configured to accept the biological sampling device. The sample extraction device may also include a reagent storage vessel, optionally wherein the reagent storage vessel is mounted onto the sample chamber. The sample extraction device may further include a mechanism configured to apply compressive mechanical or piercing force on the reagent storage vessel to release a reagent contained in the reagent storage vessel into the sample chamber.

Another embodiment may be directed to a sample extraction device for extracting a biological analyte from a biological sampling device. The sample extraction device may include a sample chamber configured to accept a biological sampling device. The sample extraction device may also include a reagent storage vessel, optionally mounted onto an exterior of the sample chamber. The sample extraction device may further include a lance mounted inside a lance cavity of the sample extraction device. In addition, the sample extraction device may include a mechanism configured to apply compressive or piercing mechanical force on the reagent storage vessel, the lance or the lance cavity, and thereby push the reagent storage vessel against the lance. The sample extraction device may also include a housing component enclosing the sample chamber, the reagent storage vessel, the mechanism, and the lance. Further, the sample extraction device may include a cap covering at least a portion of an opening of the sample chamber.

In a variant, the sample chamber may include a frangible seal configured to cover a liquid stored therein. In a variant, the biological sampling device may be a swab, scoop, spoon, spatula, probe, stick, or rod. In another variant, the biological sampling device may be a swab. In a further variant, the swab may include a breakpoint configured to break when mechanical force is applied to the breakpoint.

In a variant, the sample chamber may include a notch configured to hold the swab and aid in breaking the swab at the breakpoint. In another variant, the breakpoint may be a point of the stem that is aligned with the notch. In a further variant, the sample extraction device may include a cap, and the cap may include threading configured to connect the sample extraction device to a sample port of an analysis device, which includes complementary threading to the threading of the cap. In a variant, the sample extraction device may include a cap, and wherein the cap may include8 a frangible film covering an opening of the cap.

In a variant, the threading may be located on an external surface of the cap. In another variant, the analysis device may be a lateral flow assay cartridge. In a further variant, the lateral flow assay cartridge may be configured to be inserted into a cartridge port of an adaptor connected to a processing device. In another variant, the sample port may include a puncture mechanism configured to puncture the frangible film of the cap, and the sample port may include a channel configured to receive the reagent dispensed from the sample extraction device. In a variant, the puncture mechanism may include one or a plurality of prongs.

In a variant, the plurality of prongs may be a series of serrated prongs, and the series of serrated prongs may include a gap separating one end of the series of serrated prongs from another end of the series of serrated prongs. In another variant, the lateral flow assay cartridge may include a feedback indicator configured to provide an indication that the cap of the sample extraction device is fully attached to the lateral flow assay cartridge. In another variant, the indication may include an audible sound. In a further variant, the sample extraction device may include a cap, and wherein the cap may include a film covering an opening of the cap.

In a variant, the sample extraction device may include a cap, and the cap may include a spigot, which defines an opening of the cap, and a vent tube disposed within the opening. In another variant, the sample extraction device may include a cap, and wherein the cap may include a tab extending from an exterior surface of the cap, a flexible neck attached to the exterior surface of the cap, and an anchor knob fixed to an end of the flexible neck.

In a variant, the sample extraction device may include a cap, and wherein the cap is a flexible dropper cap. In another variant, the sample extraction device may include a cap, and wherein the cap may include a plurality of slots configured to accommodate one or more O-rings. In another variant, the sample extraction device may include a cap, and wherein the cap may include a pressure-release snorkel. In a further variant, the pressure-release snorkel may define an outlet hole configured to release air pressure within the sample chamber. In another variant, the mechanism may include a button or a dial.

In a variant, the mechanism may include a button. In another variant, the mechanism may include a dial. In a further variant, the button may include a hinge region allowing the button to rotate, and a latch configured to attach the button to the sample chamber.

In a variant, the sample extraction device may include the lance and lance cavity as defined above. In another variant, the reagent storage vessel may be mounted over the lance cavity creating a sealed enclosure, and the lance may be in communication with a frangible surface of the reagent storage vessel.

In a variant, the reagent storage vessel may include a sealing agent that mounts the reagent storage vessel onto the exterior of the sample chamber. In another variant, the sealing agent may include an adhesive film or an adhesive tape. In a further variant, the sealing agent comprises an adhesive film. In another variant, the sealing agent comprises an adhesive tape. In a further variant, the sample extraction device may include the lance cavity as defined above, and wherein the lance cavity may be fluidly connected to the sample chamber.

In a variant, the sample extraction device may include a lance cavity as defined above, and may also include a sample channel fluidly connected to the lance cavity and the sample chamber. In another variant, the sample chamber may include a pressure release mechanism configured to release excess internal air pressure in the sample chamber. In a further variant, the pressure release mechanism may include a hydrophobic porous membrane or an oleophobic porous membrane.

In a variant, the pressure release mechanism may include a hydrophobic porous membrane. In another variant, the pressure release mechanism may include an oleophobic porous membrane. In a further variant, the hydrophobic porous membrane may include a polytetrafluoroethylene membrane.

In a variant, the oleophobic porous membrane may include an acrylic copolymer membrane. In another variant, the sample chamber may include a chamber volume of 0.5 mL to 5 mL. In a further variant, the sample chamber may include a diameter such that an annular distance between a tip of the biological sampling device and a sample chamber wall is at most 10 mm. In another variant, the reagent storage vessel may include one blister with the reagent stored therein.

In a variant, the reagent storage vessel may include a plurality of blisters with the reagent stored in each of the plurality of blisters, or a plurality of blisters wherein the plurality of blisters stores at least two different reagents. In another variant, the reagent storage vessel may include at least three blisters, wherein three of the at least three blisters may each include a different reagent. In a further variant, subsequent to at least partially turning a first dial or pressing a first button, the device may be configured to release a first buffer reagent from a first blister or reagent storage sub-compartment, preferably wherein the first buffer reagent is a lysis buffer comprising a pH of greater than about 10 and/or a denaturing, non-denaturing, ionic, non-ionic, or zwitterionic surfactant.

In a variant, the device may be configured to release a second buffer reagent from a second blister or second reagent storage sub-compartment and optionally a third buffer reagent from a third blister or third reagent storage sub-compartment after the release of the first buffer reagent. In another variant, the device may be configured to release the second and/or third buffer reagent after at least a further turn of the first dial or additional pressing of the first button, or wherein the device may be configured to release the second and/or third buffer reagent after at least partially turning a second dial or pressing a second button.

In a variant, the device may include first second and third blisters or reagent storage sub-compartments, including respectively a first second and third buffer reagent, wherein the first buffer reagent may be a lysis buffer and the second and third buffer reagents combine to form a neutralization buffer. In another variant, the reagent storage vessel may include a foil material or a polymer-based material. In a further variant, the sample extraction device comprises a width of 2 to 5 inches.

In a variant, the reagent may include a buffer, a salt, a blocking protein, a hydrophilic polymer, a surfactant, or additive. In another variant, the reagent may include a buffer and at least one ingredient selected from the group consisting of a salt, a blocking protein, a hydrophilic polymer, a surfactant, and an additive. In a further variant, the reagent may include a buffer. In another variant, the reagent may include a buffer and a salt.

In a variant, the salt may be selected from the group consisting of sodium chloride, potassium chloride, calcium chloride, magnesium sulfate, magnesium chloride, a potassium salt, a magnesium salt, a sulfate salt, a phosphate salt, monobasic, dibasic, and tribasic potassium phosphate, and monobasic, dibasic, and tribasic sodium phosphate. In another variant, the reagent may include a buffer and an additive. In a further variant, the reagent comprises the additive. In a variant, the reagent may include the surfactant.

Another embodiment may be directed to a method for extracting a biological analyte with a sample extraction device according to any of the above-described variants. The method may include collecting a sample on a biological sampling device. The method may also include inserting the biological sampling device into a sample chamber of the sample extraction device. The method may further include sealing an opening of the sample chamber with a cap. In addition, the method may include puncturing a reagent storage vessel, wherein the reagent storage vessel is optionally mounted onto an exterior of the sample chamber, to release a reagent into the sample chamber. Further, the method may include dispensing the reagent and a sample collected in the reagent from the biological sampling device, optionally, wherein the dispensing comprises dispensing into an analysis device.

In a variant, the analysis device may be an assay or an analyte detection device, such as a lateral flow assay cartridge. In another variant, the method may also include pre-loading the sample chamber with the reagent. In a further variant, the method may include breaking off a tip of the swab at a breakpoint on the biological sampling device. In another variant, puncturing the reagent storage vessel may include pressing a button or turning a dial to apply compressive mechanical force on the reagent storage vessel against a lance.

In a variant, the dispensing may include attaching the sample extraction device to the analysis device, and puncturing a film material on the cap to release the reagent and the sample collected in the reagent, optionally wherein the puncturing releases the reagent into the analysis device. In another variant, the method may also include controlling a volume of the dispensed reagent and sample collected in the reagent with a coefficient of variation of 5 to 10%. In a further variant, the volume of the dispensed reagent may be controlled by squeezing the cap to release the reagent and the sample collected in the reagent.

In a variant, the method may also include receiving feedback indicating that all or a portion of, or a sufficient portion of, the reagent has been released. In another variant, the feedback may include an audible click. In another variant, the method may include releasing internal air pressure in the sample chamber via an air pressure release mechanism. In a further variant, the cap may be attached by snapping a tab on the cap, and anchoring the cap with an anchor knob attached to the cap.

Another embodiment may be directed to a sample analysis kit for analyzing an extracted biological analyte. The sample analysis kit may include the sample extraction device according to any of the above-described variants, and a biological sampling device. In a variant, the biological sampling device may be adapted and configured to provide a biological analyte into the sample extraction device.

In a variant, the sample analysis kit may also include an adapter configured to connect a lateral flow cartridge to a processing device. In another variant, the processing device may be an imaging device or a smartphone. In another variant, the processing device may be an imaging device. In a further variant, the processing device may be a smartphone.

Another embodiment may be directed to a method for analyzing a biological analyte from a biological sampling device according to any of the above variants. The method may include extracting a biological analyte by a method according to any of the above variants. The method may also include dispensing the biological analyte onto an analysis device. The method may further include connecting the analysis device to a processing device before or after the dispensing. The method may also include, with the processing device, performing signal acquisition and readout of the biological analyte.

Another embodiment may be directed to a biological sampling device configured to provide a biological sample to a biological extraction device as defined in any of the above variants. The biological sampling device may include a main stem. The biological sampling device may also include a breakpoint attached to the main stem. The biological sampling device may further include a sampling stem attached to the breakpoint. In addition, the biological sampling device may include a tip attached to the sampling stem.

In a variant, the breakpoint of the swab may be narrower than the main stem, and may be configured to break when mechanical force or cutting tool is applied to the breakpoint. In another variant, the biological sampling device may be a swab, scoop, spoon, spatula, probe, stick, or rod. In a further variant, the biological sampling device may be a swab. In a further variant, the biological sampling device may be a scoop. In another variant, the biological sampling device may be a spoon. In a variant, the biological sampling device may be a spatula. In a further variant, the biological sampling device may be a probe. In another variant, the biological sampling device may be a stick. In a further variant, the biological sampling device may be a rod.

In a variant, the tip may correspond to a flocked swab, polyurethane swab, Rayon swab, foam swab, cotton swab, cellulose fiber swab, blended material swab, polymer-based swab, polyester swab, nylon swab, or alginate polymer swab. In another variant, the biological sampling device may also include a flocked fiber microstructure, wound microstructure, knitted microstructure, reticulated microstructure, or sprayed microstructure. In a further variant, the biological sampling device may include a round shape, narrow shape, oval shape, arrow shape, pointed shape, beveled shape, tapered shape, or cylindrical shape. In a variant, a diameter of the tip may be equal to a diameter of the sample chamber. In another variant, the diameter of the tip may be larger than the diameter of the sample chamber.

Another embodiment may be directed to an analysis device configured to link with a sample extraction device according to any of the above variants. The analysis device may include, a sample port configured to receive the sample extraction device. The analysis device may also include a result window.

In a variant, the analysis device may be a lateral flow assay cartridge. In another variant, the lateral flow assay cartridge may be configured to be inserted into a cartridge port of an adaptor connected to a processing device. In a further variant, the sample port may include a puncture mechanism configured to puncture the frangible film of the cap. Further, the sample port may include a channel configured to receive the reagent dispensed from the sample extraction device.

In a variant, the puncture mechanism may include one or a plurality of prongs. In another variant, the plurality of prongs may be a series of serrated prongs, preferably, the series of serrated prongs may include a gap separating one end of the series of serrated prongs from another end of the series of serrated prongs. In a further variant, the analysis device may include a plurality of internal (e.g., upper and/or lower) rib structures for suspending a lateral flow membrane and/or applying pressure on the lateral flow membrane. In another variant, the sample port may include threading configured to attach the analysis device to the sample extraction device.

Another embodiment may be directed to an interface element configured to attach a sample extraction device according to any of the above variants to a lateral flow cartridge or an analysis device according to any of the above variants. The interface element may include threading configured to mate with complementary threading of a cap of the sample extraction device, and optionally a mechanism configured to puncture the cap to release a liquid stored within the sample extraction device into the analysis device. In a variant, the interface element may be a sample well. In another variant, the interface element may include a feedback indicator configured to provide an indication of successful attachment of the sample extraction device. In a further variant, the indication may be an audible indication. In another variant, the sample port may include a channel configured to transfer the liquid dispensed from the sample extraction device into the analysis device or lateral flow cartridge.

In a variant, the mechanism may include one or a plurality of prongs. In another variant, the plurality of prongs may be a series of serrated prongs, and optionally the series of serrated prongs may include a gap separating one end of the series of serrated prongs from another end of the series of serrated prongs. In a further variant, the interface element may be configured to slideably attach onto a lateral flow cartridge.

1. A sample extraction device for extracting a biological analyte from a biological sampling device, comprising:
a sample chamber configured to accept a biological sampling device;
a reagent storage vessel, optionally mounted onto an exterior of the sample chamber;
a lance mounted inside a lance cavity of the sample extraction device;
a mechanism configured to apply compressive or piercing mechanical force on the reagent storage vessel, the lance or the lance cavity, and thereby push the reagent storage vessel against the lance;
a housing component enclosing the sample chamber, the reagent storage vessel, the mechanism, and the lance; and
a cap covering at least a portion of an opening of the sample chamber, the cap configured to provide controlled release of a liquid sample from the sample chamber.

2. The sample extraction device according to claim 1, wherein the cap comprises one or more partition walls configured to partition between an amount of the liquid sample that will be dispensed from the cap, and an amount of the liquid sample that will remain inside the cap and sample extraction device.

3. The sample extraction device according to claim 1, wherein the cap is configured to be adjustable to alter a volume of liquid in the cap depending on a desired liquid sample volume to be dispensed.

4. The sample extraction device according to claim 1, wherein the sample chamber comprises a frangible seal configured to cover a liquid stored therein.

5. The sample extraction device according to claim 1, wherein the biological sampling device is a swab, scoop, spoon, spatula, probe, stick, or rod.

6. The sample extraction device according to claim 1, wherein the cap comprises threading configured to connect the sample extraction device to a sample port of an analysis device, which comprises complementary threading to the threading of the cap.

7. The sample extraction device according to claim 6, wherein the cap comprises a frangible film covering an opening of the cap, wherein the frangible film is configured to hold the liquid sample inside the cap, and wherein the frangible film is configured to release the amount of liquid sample that is to be dispensed from the cap when punctured while preventing the amount of liquid sample that is to remain inside the cap from being dispensed.

8. The sample extraction device according to claim 6, wherein the analysis device is configured to be inserted into a cartridge port of an adapter connected to a processing device.

9. The sample extraction device according to claim 7,
wherein the sample port comprises a puncture mechanism configured to puncture the frangible film of the cap, and
wherein the sample port comprises a channel configured to receive the reagent dispensed from the sample extraction device.

10. The sample extraction device according to claim 6, wherein the analysis device comprises a feedback indicator configured to provide an indication that the cap of the sample extraction device is fully attached to the lateral flow assay cartridge.

11. The sample extraction device according to claim 1, wherein the cap comprises:
a spigot, which defines an opening of the cap; and
a vent tube disposed within the opening.

12. The sample extraction device according to claim 1, wherein the cap comprises:
a tab extending from an exterior surface of the cap;
a flexible neck attached to the exterior surface of the cap; and
an anchor knob fixed to an end of the flexible neck.

13. The sample extraction device according to claim 12, wherein the cap is a flexible dropper cap.

14. The sample extraction device according to claim 12, wherein the cap comprises a plurality of slots configured to accommodate one or more O-rings.

15. The sample extraction device according to claim 12, wherein the cap comprises a pressure-release mechanism.

16. The sample extraction device according to claim 15, wherein the pressure-release mechanism comprises a snorkel configured to release excess air pressure built up in the sample chamber enclosed with the cap to equalize an internal pressure of the sample chamber with an external ambient air pressure.

17. The sample extraction device according to claim 15, wherein the pressure-release snorkel defines an outlet hole configured to release air pressure within the sample chamber.

18. The sample extraction device according to claim 15, wherein the mechanism comprises a button or a dial.

19. The sample extraction device according to claim 1, wherein the reagent storage vessel is mounted over the lance cavity creating a sealed enclosure, and
wherein the lance is in communication with a frangible surface of the reagent storage vessel.

20. The sample extraction device according to claim 1, wherein the reagent storage vessel comprises a sealing agent that mounts the reagent storage vessel onto the exterior of the sample chamber.

21. The sample extraction device according to claim 20, wherein the sealing agent comprises an adhesive film or an adhesive tape.

22. The sample extraction device according to claim 1, further comprising a sample channel fluidly connected to the lance cavity and the sample chamber.

23. The sample extraction device according to claim 15, wherein the pressure release mechanism comprises a hydrophobic porous membrane or an oleophobic porous membrane.

24. The sample extraction device according to claim 1, wherein the sample chamber comprises a chamber volume of 0.5 mL to 5 mL.

25. The sample extraction device according to claim 1, wherein the sample chamber comprises a diameter such that an annular distance between a tip of the biological sampling device and a sample chamber wall is at most 10 mm.

26. The sample extraction device according to claim 1, wherein the reagent storage vessel comprises one blister with the reagent stored therein.

27. The sample extraction device according to claim 26, wherein the reagent storage vessel comprises a plurality of blisters with the reagent stored in each of the plurality of blisters, or a plurality of blisters wherein the plurality of blisters stores at least two different reagents.

28. The sample extraction device according to claim 1, wherein, subsequent to at least partially turning a first dial or pressing a first button, the sample extraction device is configured to release a first buffer reagent from a first blister or reagent storage sub-compartment, preferably wherein the first buffer reagent is a lysis buffer comprising a pH of greater than about 10 or a denaturing, non-denaturing, ionic, non-ionic, or zwitterionic surfactant.

29. The sample extraction device according to claim 28, wherein the device is configured to release a second buffer reagent from a second blister or second reagent storage sub-compartment and optionally a third buffer reagent from a third blister or third reagent storage sub-compartment after the release of the first buffer reagent.

30. The sample extraction device according to claim 29, wherein the device is configured to release the second and/or third buffer reagent after at least a further turn of the first dial or additional pressing of the first button, or wherein the device is configured to release the second and/or third buffer reagent after at least partially turning a second dial or pressing a second button.

31. The sample extraction device according to claim 30, wherein the device comprises first second and third blisters or reagent storage sub-compartments, comprising respectively a first second and third buffer reagent, wherein the first buffer reagent is a lysis buffer and the second and third buffer reagents combine to form a neutralization buffer.

32. The sample extraction device according to claim 1, wherein the reagent storage vessel comprises a foil material or a polymer-based material.

33. The sample extraction device according to claim 1,
wherein the reagent comprises a buffer, a salt, a blocking protein, a hydrophilic polymer, a surfactant, or additive; or
wherein the reagent comprises a buffer and at least one ingredient selected from the group consisting of a salt, a blocking protein, a hydrophilic polymer, a surfactant, and an additive.

34. A method for extracting a biological analyte with a sample extraction device according to claim 1, comprising:
collecting a sample on a biological sampling device;
inserting the biological sampling device into a sample chamber of the sample extraction device;
sealing an opening of the sample chamber with a cap;
puncturing a reagent storage vessel, wherein the reagent storage vessel is optionally mounted onto an exterior of the sample chamber, to release a reagent into the sample chamber; and
dispensing the reagent and a sample collected in the reagent from the biological sampling device, optionally, wherein the dispensing comprises dispensing into an analysis device.

35. The method for sample extraction according to claim 34, wherein the analysis device is an assay or an analyte detection device, such as a lateral flow assay cartridge.

36. The method for sample extraction according to claim 34, further comprising pre-loading the sample chamber with the reagent.

37. The method for sample extraction according to claim 34, wherein puncturing the reagent storage vessel comprises pressing a button or turning a dial to apply compressive mechanical force on the reagent storage vessel against a lance.

38. The method for sample extraction according to claim 34, wherein the dispensing comprises:
attaching the sample extraction device to the analysis device; and
puncturing a film material on the cap to release the reagent and the sample collected in the reagent, optionally wherein the puncturing releases the reagent into the analysis device.

39. The method for sample extraction according to claim 34, further comprising controlling a volume of the dispensed reagent and sample collected in the reagent with a coefficient of variation of 5 to 30% or less than 5%.

40. The method for sample extraction according to claim 34, wherein the volume of the dispensed reagent is controlled by squeezing the cap to release the reagent and the sample collected in the reagent.

41. The method for sample extraction according to claim 34, further comprising receiving feedback indicating that all or a portion of, or a sufficient portion of, the reagent has been released.

42. The method for sample extraction according to claim 34, further comprising releasing internal air pressure in the sample chamber via an air pressure release mechanism.

43. The method for sample extraction according to claim 34, wherein the cap is attached by snapping a tab on the cap, and anchoring the cap with an anchor knob attached to the cap.

44. A sample analysis kit for analyzing an extracted biological analyte, comprising:
a sample extraction device according to claim 1; and
a biological sampling device,
wherein the biological sampling device is adapted and configured to provide a biological analyte into the sample extraction device.

45. The sample analysis kit according to claim 44, further comprising an adapter configured to connect a lateral flow cartridge to a processing device.

46. A method for analyzing a biological analyte from a sample extraction device according to claim 1, comprising:
extracting a biological analyte by a method according to claim 34;
dispensing the biological analyte onto an analysis device;
connecting the analysis device to a processing device before or after the dispensing; and
with the processing device, performing signal acquisition and readout of the biological analyte.

47. An analysis device configured to link with a sample extraction device according to claim 1, comprising:
a sample port configured to receive the sample extraction device; and
a result window.

48. The analysis device according to claim 47, wherein the analysis device is a lateral flow assay cartridge.

49. The analysis device according to claim 47, wherein the lateral flow assay cartridge is configured to be inserted into a cartridge port of an adaptor connected to a processing device.

50. The analysis device according to claim 47,
wherein the sample port comprises a puncture mechanism configured to puncture the frangible film of the cap, and
wherein the sample port comprises a channel configured to receive the reagent dispensed from the sample extraction device.

51. The analysis device according to claim 50, wherein the puncture mechanism comprises one or a plurality of prongs.

52. The analysis device according to claim 47, further comprising a plurality of internal rib structures for suspending a lateral flow membrane and/or applying pressure on the lateral flow membrane.

53. An interface element configured to attach a sample extraction device according to claim 1 to a lateral flow cartridge or an analysis device according to claim 47, comprising:
threading configured to mate with complementary threading of a cap of the sample extraction device; and optionally
a mechanism configured to puncture the cap to release a liquid stored within the sample extraction device into the analysis device.

54. The interface element according to claim 53, wherein the interface element is a sample well.

55. The interface element according to claim 53, further comprising a feedback indicator configured to provide an indication of successful attachment of the sample extraction device.

56. The interface element according to claim 53, wherein the sample port comprises a channel configured to transfer the liquid dispensed from the sample extraction device into the analysis device or lateral flow cartridge.

57. The interface element according to claim 53, wherein the mechanism comprises one or a plurality of prongs.
